(19) United States
(12) Patent Application Publication
(10) Pub. No.: US 2004/0070616 A1
(43) Pub. Date: Apr. 15, 2004

(54) Electronic whiteboard

(76) Inventors: Peter W. Hildebrandt, Duluth, GA (US); Scott Paul Gillespie, Portland, OR (US); Lynda Alison Deakin, San Francisco, CA (US); Scott E. Wilson, Kailua-Kona, HI (US); Ian G. Hutchinson, Suwanee, GA (US); Timothy J. Prachar, Palo Alto, CA (US); James D. Watson, Duluth, GA (US); Michael H. Dunn, Dunwoody, GA (US); Guy L. Williams, Yamhill, OR (US); Ari T. Adler, San Francisco, CA (US); Tony P. Patron, Burlingame, CA (US); Stephen J. Senatore, South San Francisco, CA (US); Peter S. MacDonald, Palo Alto, CA (US); Matthew A. Desmond, Redwood City, CA (US); Graham MacDonald Hicks, San Francisco, CA (US); David Gilmore, San Francisco, CA (US); Katrin Wegener, San Francisco, CA (US); Jeanne M. Ragan, San Jose, CA (US); Thomas Franz Enders, Mountain View, CA (US); Douglas R. Bourn, Santa Clara, CA (US); Eric Allan MacIntosh, Menlo Park, CA (US); Mark A. Zeh, Mountain View, CA (US)

Correspondence Address: QUARLES & BRADY LLP, 411 E. WISCONSIN AVENUE, SUITE 2040, MILWAUKEE, WI, 53202-4497, US

(21) Appl. No.: 10/452,178

(22) Filed: Jun. 2, 2003

Related U.S. Application Data
(60) Provisional application No. 60/384,982, filed on Jun. 2, 2002.
(60) Provisional application No. 60/385,139, filed on Jun. 2, 2002.
(60) Provisional application No. 60/384,984, filed on Jun. 2, 2002.
(60) Provisional application No. 60/384,977, filed on Jun. 2, 2002.

(51) Int. Cl. G09G 5/00

(52) U.S. Cl. 345/764

(57) ABSTRACT

A method and apparatus for use with a whiteboard and an archive memory, the whiteboard having a surface for displaying images, the method for grouping presented images together for storage in the archive memory and password protecting the image groups in separate session files where a password is subsequently required to access the session file images.

### CROSS-REFERENCE TO RELATED APPLICATIONS

This patent application is a continuation-in-part of provisional U.S. patent application Serial No. 60/384,982 which was filed on Jun. 2, 2002 and which is titled “Plural-Source Image Merging For Electronic Whiteboard”, is a continuation-in-part of provisional U.S. patent application Serial No. 60/385,139 which was filed on Jun. 2, 2002 and which is titled “Trackable Differentiable, Surface-Mark-Related Devices For Electronic Whiteboard”, is a continuation-in-part of provisional U.S. patent application Serial No. 60/384,984 which was filed on Jun. 2, 2002 and which is titled “Electronic Whiteboard Mouse-Cursor-Control Structure And Methodology” and is also a continuation-in-part of provisional U.S. patent application Serial No. 60/384,977 which was filed on Jun. 2, 2002 and which is titled “Electronic Whiteboard System and Methodology”.

### STATEMENT REGARDING FEDERALLY SPONSORED RESEARCH OR DEVELOPMENT

Not applicable.

### BACKGROUND OF THE INVENTION

The field of the invention is electronic whiteboards and various new and advantageous structural and functional characteristics that enhance whiteboard simplicity, accuracy and versatility and more specifically to whiteboard mounting concepts, ways of determining if an instrument is being used with a whiteboard, ways of interacting with a whiteboard, instruments for use with a whiteboard and ways of grouping together and protecting whiteboard images.

As the label implies, a whiteboard is a rigid or flexible member that forms at least one white, flat and rigid surface. One type of whiteboard includes a surface constructed of a material that accepts ink from markers so that a user can present information thereon (e.g., words, symbols, drawings, etc.). Most whiteboard writing surfaces are large (e.g., having length and width dimensions of several feet each) and the whiteboards are either mounted (e.g., to a wall) or supported (e.g., via an easel) in an upright fashion so that information on the board surface can be viewed from a distance and the board can therefore be used to present information to many people at the same time. Markers used with a whiteboard typically include ink that, while applicable to the board, is easily erasable using a cloth, a felt eraser, or the like, so that presented information is modifiable and so that the board is reusable.

In addition to being used as writing instruments, many whiteboards are useable as projection display screens. Here, a projector on either the viewing side or a backside (e.g., a rear-projection on a translucent surface) of a board directs its image onto the board surface for viewing. Where an image is projected onto a whiteboard surface, a user may use markers to add additional information (e.g., add an arrow, circle an area, etc.) to the projected image. The projection source may be an on-board or remote computer, a personal digital assistant linked to a projector unit, a video machine, or any appropriate image source connected for communication over a network (e.g., the Internet). Projected information may include words, symbols, drawings, pictorial images, movies, computer screen shots, and other visually readable material employed in day-to-day business activities.

Whiteboards have many advantages (e.g., no mess, reusable, portability in some cases, high contrast of ink to white surface, familiarity and ease of use, etc.) over other presentation tools and therefore, not surprisingly, have become widely accepted in offices, conference rooms, manufacturing facilities, classrooms, etc. Despite their wide acceptance, the whiteboard industry has recognized that strictly mechanical whiteboards comprising a simple erasable surface have several shortcomings. First, mechanical whiteboards provide no way to capture or store information presented on the whiteboard surface. Here, while persons observing board information may be able to take notes regarding presented information, such a requirement is distracting and, in many cases, notes may not accurately reflect presented information or may only capture a portion of presented information.

Second, mechanical whiteboards provide no way to share presented information remotely. For instance, a person at her desk in San Francisco may attend a meeting in Grand Rapids, Mich. via teleconference where a mechanical whiteboard located in Grand Rapids is used to facilitate discussion. Here, as information is added to and deleted from the whiteboard, the person teleconferencing form San Francisco has no way of receiving the information and hence cannot fully participate in the meeting.

One solution to the problems described above has been to configure electronically enhanced whiteboard systems capable of both storing presented information and of transmitting presented information to remote locations for examination. For instance, one type of electronically enhanced whiteboard system includes two optical laser scanners (visible or infrared) mounted proximate the whiteboard surface that scan within a sensing plane parallel to and proximate the whiteboard surface. Here, a bar code or similar optically recognizable code may be provided on an instrument at a location that resides within the sensing plane when the instrument is used with the whiteboard. For example, in the case of a pen, a bar code may be provided near the writing end of the tip so that the code resides within the sensing plane when the pen tip contacts the board surface.

The optical scanners sense signals that reflect from a code within the sensing plane and provide corresponding real-time electronic data streams to a system processor. The processor uses the received signals to determine the type of instrument (e.g., a pen, eraser, etc.) associated with the code and to determine the location of the instrument with respect to the board surface. Once instrument type and location have been determined, the processor accesses an electronically stored image associated with the whiteboard surface and, when appropriate, alters the image to reflect and record changes being made to the information presented on the board. For instance, when a pen is used to form a red circle around a word on the board, the processor alters the electronically stored image to form a similar red circle around the same word. As another instance, when the processor recognizes a bar code as corresponding to an eraser and that the bar code moves across the board, the processor alters the electronically stored image to erase any information within the swath of the eraser associated with the bar code.

Generally, in the case of optical scanning systems, it is considered important to configure scanning systems wherein the sensing plane is as close as possible to the whiteboard surface so that the position of the code on an instrument sensed within the sensing plane is as close as possible to the position of the sensed code. For instance, in the case of a coded pen, a user may write with the pen on an angle. Here, if the space between the sensing plane and the board surface is large, the sensed position of the code on the pen will be offset from the actual position of the pen tip on the board surface to a degree related to the pen angle and the space between the sensing plane and the board. By reducing the space between the sensing plane and the board, the offset is substantially reduced and fidelity between the intended information and the sensed information is increased appreciably.

In addition to optical scanning systems, other electronically enhanced whiteboard systems have been developed that work with varying degrees of success. For instance, other electronic whiteboard technologies include writing-surface touch sensitivity tracking, ultra-sound tracking, audible acoustic tracking, infra-red tracking, electromagnetic tracking, etc. While other technologies have been applied to electronically capture whiteboard information, in the interest of simplifying this explanation, unless indicated otherwise, hereinafter the inventions will generally be described in the context of the system above having two optical scanners and bar coded instruments. Nevertheless, it should be recognized that many of the concepts and inventive aspects described herein are applicable to other data capturing technologies.

In addition to the type of instrument and the location of the instrument relative to the board surface (e.g., the “what and where” information), in some cases the information tracked and developed by the processor can include additional information such as, for example, information regarding ink color, pen tip width, speed of marking, inclination of pen tip (to compensate for the offset described above), pen-tip pressure and eraser swath.

Electronic whiteboards generally come in two different types including real ink and virtual ink types. As its label implied, a real ink system includes pens and erasers that apply real ink to and remove real ink from the board surface when employed, respectively. In the case of a virtual ink system, a projector is linked to the system processor and, as the processor updates the electronically stored image to reflect instrument activities, the processor projects the changes to the electronically stored image onto the whiteboard surface. Thus, with a virtual ink system, a pen does not actually deposit ink on the board surface and instead virtual marks reflecting pen movements within the sensing plane are projected onto the screen—hence the label “virtual ink”.

Because the information presented on an electronic whiteboard is electronically captured, the information can be transmitted to and presented for examination by remote viewing stations (e.g., a network linked computer, projector system, etc.). In addition, when desired, because the information is electronically captured, the information can be stored (e.g., on a floppy disk, a recordable CD ROM, a flash memory structure, a USB-based memory key or stick, etc.) for subsequent access and use.

Some electronic whiteboard processors are linked to both a temporary or working memory and a long-term archive memory. The temporary memory is generally used to temporarily record and both locally (e.g., in the case of a virtual ink system) and remotely present displayed images as those images are created and modified during a whiteboard session. The archive memory is generally used to archive specific images identified by a system user during a board session. Thus, for instance, during a session, if a displayed image is particularly important, a user may activate a save command thereby causing the system processor to store the displayed image data in the long-term memory. Where the displayed image includes only information in the temporary memory, the save function copies the temporary memory information to the long-term memory. Where the displayed image includes both information in the temporary memory and information from another source (e.g., a computer screen shot projected onto the board), the save function may include merging the two information sets into a single set and then storing the merged set to long term memory. While electronically enhanced whiteboards like those described above have many advantages, such boards also have several shortcomings. First, in the case of systems that rely on optical scanners to determine instrument bar code locations, it is important that the bar code be located within the sensing plane associated with the scanner whenever an instrument contacts the whiteboard surface. Where a bar code resides either between the sensing plane and the whiteboard surface or on a side of the sensing plane opposite the whiteboard surface, the scanners cannot sense the code, cannot recognize that an instrument is present, and hence cannot capture any changes to the information facilitated by movement of the instrument.

Many wall surfaces that whiteboards are mounted to are not completely flat. Despite manufacturing whiteboards that are relatively rigid, often, when mounted to an uneven wall, it has been found that the whiteboard may bend (e.g., be wavy) and hence be convex or concave at certain locations along the whiteboard surface (e.g., between lateral board edges or between top and bottom edges). Where a board is convex between lateral edges and the sensing plane is very close to the board surface at the board edges, the spacing between the sensing plane and the board surface at some locations between the lateral edges may be such that bar codes on instruments are outside the sensing plane when used. Where convexity is excessive, sections of the board surface may actually break the sensing plane and have a similar adverse effect on code sensing capabilities. In either of these two cases, because the optical scanners cannot sense instrument activity at the convex areas of the surface, intended changes at the convex areas cannot be captured. Similar problems occur where a board is convex or concave between top and bottom edges.

One solution to the wavy board problem is to increase the space between the whiteboard surface and the sensing plane and to provide a taller bar code (e.g., code height being the dimension generally perpendicular to the board surface when the interacting part of the instrument contacts the surface) so that the sensing plane so that instrument bar codes reside within the sensing plane at virtually every location along the board surface when the instruments contact the board surface. Unfortunately, greater spacing and taller codes lead to a second problem with optical sensing systems. Specifically, if the space between the sensing plane and the board surface is large and the bar code width dimension is increased, there will be instances wherein an instrument does not touch the board surface but the code nevertheless still resides within the sensing plane. For instance, where a coded pen is used to place a line on a board surface, where the surface-sensing plane spacing is large and the code is wide, the system often senses the pen movement before and after contact with the surface and leading and following “tails” are added to the electronically stored line. As another instance, a system user may use a pen as a simple mechanical pointing device placing the coded pen tip near a displayed figure on the surface without touching the surface but with the code breaking the sensing plane. Here, the system senses the code and any pen movement and erroneously records a pen activity.

Third, while many systems only electronically sense specially coded instruments (e.g., bar coded instruments), often, other instruments that are not recognizable by the system can also be used to alter whiteboard information. For instance, in a system including optical scanners that employs bar coded real ink pen and eraser instruments, when a non-coded ink pen is used to apply ink to the board surface, the optical scanners cannot sense the non-coded pen and hence cannot capture the changes made to the displayed image. Similarly, in the same system, after a coded pen has been used to apply real ink to a board surface and the scanners capture the information presented, if a non-coded eraser or cloth is used to erase some or all of the ink form the board, the scanners cannot capture the erasing activity and the electronically stored image data no longer reflects the displayed image. Thus, in some cases, a system user may unknowingly be working with an image that does not match the electronically stored image and/or a remote participant may be observing images that are different from the images displayed on the display board.

Fourth, when images are projected onto a whiteboard surface for presentation, often it is desirable for a user to stand in a commanding position adjacent the board surface and point out various information on the projected images. For instance, a user may want to identify a particular number in a complex projected spreadsheet image. As another instance, when a whiteboard surface is used as a large computer display screen with selectable icons associated with specific functions, the presenter may want to select one of the image icons thereby causing an associated surface function to be performed. As yet another instance, a presenter may want to add a mark (e.g., circle a figure, place a box around a number, etc.) to a projected image.

One way to point out a number on a projected spreadsheet image is for the user to walk in front of the projected image and point to the number. One way to select a projected functional icon is to walk in front of the projected image and use a coded instrument (e.g., a stylus) to select the icon. Similarly, one way to add a mark to a projected image is to walk in front of the projected image and use a coded instrument to add the mark. While each of these interactive methods may work, each of these methods is distracting, as the user must be positioned between the board surface and an audience. In addition, where the projecting system is front projecting and the user is positioned between the projector and the board surface, the user casts a shadow on the board surface by eclipsing part of the projected image which often includes the item being pointed to or marked upon.

Other solutions to the pointing and selecting problems described above also include shortcomings. For instance, in some cases a separate computer display screen may be provided for a user to use where image modifications on the computer display screen are projected onto the board surface. While these dual-display systems are good for working with computer programs and the like, these systems alone cannot be used to add information (e.g., circle a figure, etc.) to projected images. In addition, these systems are relatively more expensive as an additional display is required. Moreover, these systems require that the user remain near the computer screen to select functional icons, point out information on the projected image, etc., and hence, these system reduce the interactivity of an overall presentation.

Fifth, known whiteboard systems do not, during long-term storage of information, allow a system user to easily restrict access to stored images when images are identified as sensitive. Thus, generally, existing systems either store all images without restriction or rely on other systems to restrict access. For instance, in some cases images may be stored on a network database where network access is password protected and hence the images are only accessible once a user logs onto the network and are accessible to all network users after completing a successful log on process. As well known, in many cases relying on network security does not offer much protection as many networks have hundreds and even thousands of users. In other cases, after an image session is stored to a network for general access, a network computer may be used to assign a password to the session images. Unfortunately, protection schemes of this ilk rely on a user remembering to revisit a previously stored image session and provide protection. In addition, during the period between initial storage to the network and subsequent password assignment, image session information is accessible without restriction.

Sixth, as additional features are added to electronic whiteboards, despite efforts to intuitively implement the features, inevitably, the way in which a user selects and uses the features becomes complicated and causes confusion. For instance, in the case of virtual ink systems, some systems provide complicated user interfaces that allow a user to select instrument type and then use a single instrument to simulate functions of the selected type. For example, a system may contemplate ten different pen thicknesses, fifteen different pen colors, three different eraser thicknesses, and so on. Here, selection buttons for instrument thickness, color, instrument type, etc. may all be provided, how to select different functions is typically confusing and incorrect selection results in unintended effects (e.g., a blue mark as opposed to a red mark).

As another instance, some systems may allow selection of a subset of images from a previously and recently stored session for storage as a new single file. In this case various whiteboard tools are typically required to access a network memory at which session images are stored, identify a specific session and obtain electronic copies of the images, display the images, identify the images to be regrouped into the subset and to then restore the grouped subset. While system complexity typically results in added functionality, unfortunately, complexity and associated confusion often deter people from using richly functional electronic whiteboard systems.

One solution to reduce confusion related to complex whiteboard systems is to provide a detailed instruction manual. As in other industries, however, whiteboard users typically experience at least some consternation when having to use a manual to operate a tool that, at least before all the bells and whistles were added, was completely intuitive.

Another solution to reduce confusion related to complex systems, at least in cases where computer screen shots are projected onto a whiteboard surface, is to provide pull down menus or the like having options selectable via an optically recognizable instrument where, upon selection, the computer provides text to describe a specific system function. While useable with projected computer images, pull down menus do not work with systems that do not include a projector. In addition, this solution makes users uncomfortable as, at times, they are forced to read and attempt to comprehend functions in front of an audience.

Seventh, in some systems the number of different instruments usable with an electronic whiteboard may be excessive. For instance, in some cases there may be several different blue pen instruments where each of the pen instruments corresponds to a different pen tip width. Similarly, in some cases there may be many different red, green, yellow instruments corresponding to different widths. In addition, there may be several different eraser instruments where each instrument corresponds to a different erasing swath. Organizing and using a large number of instruments can be cumbersome, especially in front of a large audience.

Eighth, in systems that employ floating virtual-ink toolbars, (e.g., projected toolbars) the virtual toolbars take up valuable screen/board space and often cover items being clicked on or viewed.

### BRIEF SUMMARY OF THE INVENTION

According to one aspect, the invention includes a method for use with a whiteboard and an archive memory, the whiteboard having a surface for displaying images, the method for grouping presented images together for storage in the archive memory and comprising the steps of a) providing an interface for receiving commands from a whiteboard user, b) monitoring for a begin subset command indicating that subsequently archived images are to be grouped together in an image subset, c) after a begin subset command is received i) monitoring for each of an archive command indicating that a presented image is to be archived and an end subset command indicating that no additional images are to be added to the image subset, ii) when an archive command is received, archiving the presented image as part of the image subset, iii) when an end subset command is received, skipping to step (b) and iv) repeating steps (i) through (iii).

Thus, one object of the present invention is to provide a system wherein sets of images can be easily grouped together for subsequent correlation. Here, a single action can begin a grouping session and a single action can be used to end a grouping session and the overall function of grouping for storage is rendered extremely easy and intuitive.

According to another aspect the method may also be for restricting access to image subsets and may further comprise the steps of, when a begin subset command is received, assigning a subset password for the image subset subsequently archived and restricting access to the subset images to users that provide the subset password. In some embodiments the subset password will be automatically and randomly generated by the system processor to further facilitate easy use.

Thus, another object of the invention is to provide a method and system that enables easy protection of displayed images for subsequent access. In this regard the present invention automatically provides a password for an image session file after a user indicates via a single action (e.g., selection of a button) that access to subsequently stored images is to be restricted. Thereafter, until the user indicates that access to subsequently stored images is not to be restricted, any images stored are password protected (e.g., a password is required to access the images.

The invention also includes a method for use with a whiteboard and an archive memory, the whiteboard having a surface for displaying images, the method for grouping at least some presented images together in subsets for storage in the archive memory and for restricting access to at least some of the image subsets, the method comprising the steps of a) providing an interface for receiving commands from a whiteboard user, b) monitoring for a begin restrict command indicating that subsequently archived images are to be grouped together in an image subset and that access to the subset images is to be restricted, c) after a begin restrict command is received i) assigning a subset password for the image subset to be subsequently archived, ii) monitoring for each of an archive command indicating that a presented image is to be archived and an end restrict command indicating that no additional images are to be added to the image subset, iii) when an archive command is received, archiving the presented image as part of the image subset, iv) when an end restrict command is received, restricting access to the subset images to users that provide the subset password and skipping to step (b) and v) repeating steps i through iv.

In addition, the invention includes an apparatus for grouping images together for storage in an archive memory, the apparatus comprising a whiteboard having a surface for presenting images a memory device, an interface, a processor linked to the interface and the memory device, the processor performing the steps of a) monitoring the interface for a begin subset command indicating that subsequently archived images are to be grouped together in an image subset; b) after a begin subset command is received i) monitoring the interface for each of an archive command indicating that a presented image is to be archived and an end subset command indicating that no additional images are to be added to the image subset, ii) when an archive command is received, archiving the presented image as part of the image subset, iii) when an end subset command is received, skipping to step (a); and iv) repeating steps i through iii.

Moreover, the invention includes an apparatus for grouping at least some presented images together in subsets for storage in an archive memory and for restricting access to at least some of the image subsets, the apparatus comprising a whiteboard having a surface for presenting images, a memory device, an interface, a processor linked to the interface and the memory device, the processor performing the steps of a) monitoring for a begin restrict command indicating that subsequently archived images are to be grouped together in an image subset and that access to the subset images is to be restricted, b) after a begin restrict command is received i) assigning a subset password for the image subset to be subsequently archived, ii) monitoring for each of an archive command indicating that a presented image is to be archived and an end restrict command indicating that no additional images are to be added to the image subset, iii) when an archive command is received, archiving the presented image as part of the image subset in the memory device, iv) when an end restrict command is received, restricting access to the subset images to users that provide the subset password and skipping to step (a), and v) repeating steps i through iv.

According to another aspect the invention includes a method for use with a whiteboard and at least one instrument for interacting with the whiteboard, the whiteboard having a whiteboard surface, at least one instrument useable to at least one of identify a location on the surface and alter an image on the surface via contact therewith, the method for determining when and where the instrument contacts the whiteboard surface, the method comprising the steps of using a first sensor to determine the location of the instrument within a sensing plane proximate and spaced apart from the surface, using a second sensor to determine when the instrument contacts the surface and when an instrument is located within the sensing plane and contacts the surface, identifying that the instrument contacts the surface and the location of the instrument relative to the surface. Here, in at least some embodiments the second sensor is an acoustic sensor and the first sensor includes at least one laser position sensor unit.

Accordingly, another aspect of the invention is to confirm that an instrument is being used with a whiteboard when an instrument coded tag (e.g., a bar code) is sensed within a sensing plane. Here, the combination of determining instrument location via one type of sensor particularly suitable for that purpose and determining if the instrument touches the surface via another sensor most suitable for that purpose provides a particularly accurate system.

The invention also includes an apparatus for creating and storing images, the apparatus for use with at least one instrument, the apparatus comprising a whiteboard having a whiteboard surface, a first sensor for determining the location of the instrument within a sensing plane proximate and spaced apart from the surface, a second sensor for determine when the instrument contacts the surface and a processor linked to each of the first and second sensors and running a program to, when an instrument is located within the sensing plane and contacts the surface, identifying that the instrument contacts the surface and the location of the instrument relative to the surface.

The invention further includes a method for use with an electronic whiteboard and an instrument for interacting with the whiteboard, the whiteboard having a display surface having a display area, the method for moving a cursor icon about at least a portion of the display area and comprising the steps of identifying first and second areas within the display area having first and second area surfaces, respectively, placing the instrument in contact with a location on the first area surface, sensing the instrument location on the first area surface and projecting a cursor icon on the second area surface as a function of the instrument location on the first area surface.

The invention further includes a method for use with an electronic whiteboard and an instrument for interacting with the whiteboard, the whiteboard having a display surface having a display area, the method for moving a cursor icon about at least a portion of the display area and comprising the steps of identifying first and second areas within the display area having first and second area surfaces, respectively, when the instrument is placed in contact with a location on the first area surface a) sensing the instrument location on the first area surface, b) projecting a cursor icon on the second area surface as a function of the instrument location on the first area surface and when the instrument is placed in contact with a location on the second area surface a) sensing the instrument location on the second area surface and b) projecting a cursor icon on the second area surface at the location of the instrument on the second area surface.

Thus, another object of the invention is to enable a stylus type device to be used in several different and useful ways to move a projected cursor about a projection area on a whiteboard surface. Here, the invention enables either absolute positioning of a cursor via contact of the stylus to the whiteboard surface or relative positioning of the stylus via contact of the stylus to the surface.

According to yet another aspect, the invention includes a method for providing information regarding a feature on an electronic whiteboard, the whiteboard including several function buttons, the method comprising the steps of a) providing an information button, b) monitoring the information button for activation, c) after the information button has been activated, monitoring the feature buttons for activation, and d) when one of the feature buttons is activated after the information button is activated, providing information regarding the feature corresponding to the activated feature button. Here, in at least some embodiments, when the help or information button is selected the system may provide instructions about how the information/help feature operates and how to select another button

One additional object of the invention is to provide a help function that is particularly easy to use and that is intuitive. In this regard, by providing feature information whenever a help or information button is selected followed by selection of a button associated with a specific feature that a user wants to obtain information on, the help feature is rendered particularly useful. In at least some embodiments the help information is provided in an audible fashion further enabling the user to comprehend the information presented. In addition, by providing the help audibly, in cases where a projector is not employed, help can still be rendered in a simple fashion without requiring some type of display.

The invention includes an apparatus for use with an electronic whiteboard, the whiteboard including a display surface and a sensor assembly for sensing the location of, and type of, tag within a sensing plane proximate the display surface, the apparatus including an instrument having first and second ends, a first tag disposed at the first end such that, when the first end contacts the display surface, at least a portion of the first tag is within the sensing plane and a cap member having first and second cap ends and forming an external surface there between, the second cap end forming an opening for receiving the first instrument end such that the cap covers the instrument tag when the first instrument end is received within the opening, a first cap tag disposed at the first end of the cap member such that, when the first end of the cap member contacts the display surface, the first cap tag is within the sensing plane.

The invention includes an apparatus for use with an electronic whiteboard, the apparatus for identifying a visual effect to be generated via an instrument on the whiteboard, the apparatus comprising a sensor assembly for sensing the location of and type of tag within a sensing plane proximate the display surface, an instrument comprising a handle member having first and second handle ends, at least first and second optically readable handle tags disposed at the first handle end and a cap member having first and second cap ends, an external surface between the first and second cap ends and forming an opening at the second cap end for receiving the first handle end, the cap member also forming a window proximate the first end of the cap member between the external surface and a channel formed by the opening, the window formed relative to the first end of the cap member such that at least a portion of the window is within the sensing plane when the first end of the cap member contacts the surface, when the first handle end is received in the opening, the handle tags are within the opening and each is separately alignable with the window such that the tag is sensible through the opening, the cap member rotatable about the first handle end to separately expose each of the first and second handle tags within the sensing plane, each of the handle tags indicating different instrument characteristics.

In addition to the concepts above, the invention further includes an assembly for use with a whiteboard having a display surface, the assembly comprising a sensor assembly for sensing the location of, and type of, tag within a sensing plane proximate the display surface, a pen instrument including an ink dispenser at a first end and a pen tag disposed proximate the first end such that the pen tag resides in the sensing plane when the first end contacts the display surface, a memory device, a processor linked to the sensor assembly and the memory device, the processor receiving information from the sensor assembly regarding instrument type and position with respect to the display surface and generating image data as a function thereof, the processor storing the image data as an image in the memory device as the image is created on the display surface and a “clear” or “start” button linked to the processor, the “clear” button for clearing the image data stored in the memory device.

Consistent with the comments above, one other object of the invention is to provide a feature whereby an electronic memory can be cleared in a simple fashion so that a user can, in effect, reset the memory and start afresh to provide written information on a surface that will be captured via the system for storage. Also, here, the system may include a memory related LED or the like to indicate when at least some information is stored in the memory.

The invention also includes an assembly for use with a whiteboard having a display surface, the assembly comprising a sensor assembly for sensing presence of any object within a sensing plane proximate the display surface and for sensing the location of, and type of, any tag within the sensing plane, a pen instrument including an ink dispenser at a first end and a pen tag disposed proximate the first end such that the pen tag resides in the sensing plane when the first end contacts the display surface, a memory device, a warning indicator and a processor linked to the sensor assembly and the memory device, the processor receiving information from the sensor assembly regarding objects present within the sensing plane and regarding instrument type and position with respect to the display surface, the processor generating image data as a function of instrument type and position information, the processor storing the image data as an image in the memory device as information is altered on the display surface, when an un-tagged object is sensed within the sensing plane, the processor activating the warning indicator.

The invention also includes a method for use with a whiteboard and an optical laser position unit, the whiteboard forming a display surface having a display edge, the unit generating a laser beam that emanates from an emanating point within a sensing plane and sensing objects within the sensing plane, the method for aligning the unit so that the sensing plane is parallel to the display surface, the method comprising the steps of mounting the laser position unit proximate the display surface such that the emanating point is spaced from the display surface a known distance and so that a beam generated by the laser position unit is directed generally parallel to the display surface, causing the laser position unit to generate a visible light beam, providing a measuring surface at different locations along the display surface where the measuring surface is substantially perpendicular to the display surface, rotating the beam through an arc about the source point and within the sensing plane such that the beam forms a light line on the measuring surface, measuring the distance between the light line and the display surface along the measuring surface and where the measured distance and the known distance are different, adjusting the laser position unit to minimize the difference.

The invention further includes an apparatus for use with a whiteboard including a display surface having a circumferential edge, the apparatus for determining the locations of instruments within a sensing plane proximate the display surface and also for determining if the whiteboard is flat, the apparatus comprising a first laser source positioned proximate a first edge of the display surface, the first source generating a first laser beam, directing the first beam across the display surface and rotating the first beam such that the first beam periodically traverses across at least a portion of the display surface, the first source capable of operating in first or second states, in the first state the first source generating an invisible laser beam and in the second state, the first source generating a visible laser beam, a second laser source positioned proximate a second edge of the display surface, the second edge opposite the first edge, the second source generating a second laser beam, directing the second beam across the display surface and rotating the second beam such that the second beam periodically traverses across at least a portion of the display surface, the second source capable of operating in first or second states, in the first state the second source generating an invisible laser beam and in the second state, the second source generating a visible laser beam, at least a first sensor mounted relative an instrument used with the display surface for sensing the invisible laser beams from the first and second sources that reflect from objects within the sensing plane and a selector for selecting one of the first and second states of source operation.

Furthermore, the invention includes an apparatus for providing a flat surface adjacent an uneven surface, the apparatus comprising a rectilinear board having upper, lower and first and second lateral edges and forming a flat surface there between, first and second bracket assemblies, the second bracket assembly rigidly coupled to at least one of the board edges and mountable to the uneven surface to rigidly secure the board to the uneven surface such that a first location on one of the board edges is a first distance from the uneven surface, the first bracket assembly including a base member and an adjustment member, the base member forming a mounting surface for mounting to the uneven surface, the adjustment member including an edge engaging member, the adjustment member slidably coupled to the base member for movement generally perpendicular to the mounting surface so that an extend dimension between the mounting surface and the engaging member is adjustable, the first bracket engaging member coupled to the board edge at the first location, wherein, the first bracket base member and adjustment member are adjustable so that the mounting surface and the engaging member form an extended dimension that is identical to the first distance and the mounting surface contacts the uneven surface.

Moreover, the invention includes a method for use with a rectilinear board and an uneven surface, the board having upper, lower and first and second lateral edges and forming a flat surface therebetween, the method for mounting the board to the uneven surface so that the flat surface remains substantially flat, the method comprising the steps of providing at least first and second bracket assemblies, the first assembly including a base member forming a mounting surface and an adjustment member forming an edge engaging member, attaching the first bracket assembly via the edge engaging member at a first location along the board edge, securing the board via the second bracket assembly to the uneven surface so that a first location along the board edge is a first distance from the uneven surface, adjusting the first bracket assembly so that the mounting surface contacts an adjacent section of the uneven surface and securing the mounting surface to the uneven surface.

Thus, one additional object of the invention is to provide a method and apparatus for mounting a whiteboard to an uneven surface in a manner that ensures that the whiteboard surface remains essentially completely flat.

The invention also includes an electronic board assembly for archiving images, the board assembly comprising a display surface, a web server dedicated to the board system, the server including an archive memory device for storing board images accessible via the server and an interface device linkable to the web server to access images stored therein. Here, the interface may also provide a store component useable to indicate that information on the display surface should be stored by the web server in the archive memory device.

In some embodiments the interface also provides an archive source component useable to indicate intent to access an archived image. In this case the interface may further include a projector for projecting archived images onto the display surface and, wherein, the processor provides video output of an accessed image to the projector. The interface device may also be a computer linkable to the server via a network.

The invention also includes an electronic board assembly comprising a display surface, a system processor including an archive memory device for storing board images and an external computer linkage for linking to a computer, a projector linked to the processor and positioned to project images onto the display surface, and an interface linked to the processor for identifying the source of images to project onto the display surface, the interface including an archive source component for indicating that an archived image is to be projected and a computer source component for indicating that an image generated by a computer linked to the linkage is to be projected, wherein, when the archive source component is selected, the processor projects an archived image onto the display surface and when the computer source component is selected, the processor projects an image generated by a computer linked to the linkage on the display surface.

Moreover, the invention includes a method for capturing both projected and applied information displayed on a board surface, the method comprising the steps of dividing the surface into first and second areas wherein the second area is smaller than the first area, projecting an image onto the second area, sensing information applied via an instrument to either of the first and second areas and when a save command is received, storing the projected and applied information in an archive memory device.

Here, in some embodiments the step of storing includes storing the projected and applied information as a single merged image for subsequent access. In other embodiments the step of storing includes storing the projected and applied information as separate correlated images for subsequent access. In still other embodiments the processor includes an interface that enables a system user to select one of a merged and a separate mode of operation and, wherein, the step of storing the projected and applied information includes identifying which of the merged and separate modes is selected and, where the merged mode is selected, storing the projected and applied information as a single merged image and, where the separate mode is selected, storing the projected and applied information as separate and correlated images.

Furthermore, the invention includes a method for calibrating an electronic display board system wherein the system includes a processor, a display surface and a display driver linked to the processor and that provides images onto a portion of the display surface, the method comprising the steps of providing marks onto the display surface that indicate an image location, sensing mark locations on the surface, identifying the area associated with the marks as a second area and other area on the surface as a first area and causing the driver to provide a cursor within the second area as a function of instrument activity that occurs in the first area.

Here, the step of causing may include moving the cursor within the second area in a relative fashion with respect to movement of the cursor within the first area. In addition the method may include the step of causing the driver to provide a cursor within the second area as a function of instrument activity within the first area. Moreover, the step of causing the driver to provide a cursor within the second area as a function of instrument activity within the second area may include providing a cursor at the absolute position of the instrument activity in the second area.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a perspective view of a whiteboard system according to the present invention;

FIG. 2 is an exploded perspective view of the whiteboard assembly of FIG. 1;

FIG. 3 is a front plan view of the whiteboard assembly of FIG. 1, albeit with upper header and lower header doors open;

FIG. 3A is a schematic plan view of one of the laser units of FIG. 3;

FIG. 4 is a perspective view of one of the lower bracket assemblies of FIG. 2;

FIG. 5 is a cross-sectional view of the assembly of FIG. 4;

FIG. 6 is a perspective view of one of the upper bracket assemblies of FIG. 2;

FIG. 7 is a cross-sectional view of the assembly of FIG. 6;

FIG. 8 is a partial plan view of some of the components including one of the upper bracket assemblies of FIG. 2;

FIG. 9 is a schematic diagram illustrating various components of the processor/interface module of FIG. 3;

FIG. 10 is a perspective view of a pen and cap instrument according to one aspect of the present invention;

FIG. 11 is a perspective view of an eraser instrument according to one aspect of the present invention;

FIG. 12 is a side elevational view of an inventive versatile instrument according to the present invention;

FIG. 13 is an enlarged view of a portion of the instrument illustrated in FIG. 12;

FIG. 14 is similar to FIG. 13, albeit with a cap member installed on one end of another member;

FIG. 15 is a plan view of the control panel of the processor/interface module of FIG. 2;

FIG. 16 is a flow chart illustrating a whiteboard assembly mounting method according to one aspect of the present invention;

FIG. 17 is a flow chart illustrating a method for aligning laser sensor units with a whiteboard surface during a commissioning process;

FIG. 18 is a flow chart illustrating a method for identifying when an instrument contacts a whiteboard surface and for identifying instrument activity;

FIG. 19 is a flow chart illustrating a method to facilitate clearing of one of the electronic memories illustrated in FIG. 9;

FIG. 20 is a flow chart illustrating a method for identifying and indicating potential discrepancies between one of the memories illustrated in FIG. 9 and an associated whiteboard surface;

FIG. 21 is a plan view of an additional interface button that may be added to the panel of FIG. 15 in at least some inventive embodiments;

FIG. 22 is a flow chart illustrating a password protect method according to one aspect of the present invention;

FIG. 23 is a schematic diagram illustrating a whiteboard surface divided to form a projection area and a control area according to at least one aspect of the present invention;

FIG. 24 is a flow chart according to one aspect of the present invention illustrating relative and absolute control of instruments in the context of divided boards like the board illustrated in FIG. 23;

FIG. 25 is similar to FIG. 23, albeit illustrating a divided whiteboard surface where a computer display screen is projected within the projection area;

FIG. 26 is a flow chart illustrating one method for accessing previously archived display images;

FIG. 27 is a flow chart illustrating another method of accessing archived images;

FIG. 28 is a partial perspective view illustrating a laser light line on a tray surface that is used during a commissioning procedure to align system laser units with a whiteboard surface;

FIG. 29 is a flow chart illustrating a help method according to one aspect of the present invention;

FIG. 30 is a schematic illustrating an exemplary screen shot according to one aspect of the present invention;

FIG. 31 is similar to FIG. 23, albeit illustrating a display including marks used to calibrate an inventive system and including a buffer zone between a projection area and a control area; and

FIG. 32 is a flow chart illustrating a calibration process.

### DETAILED DESCRIPTION OF THE INVENTION

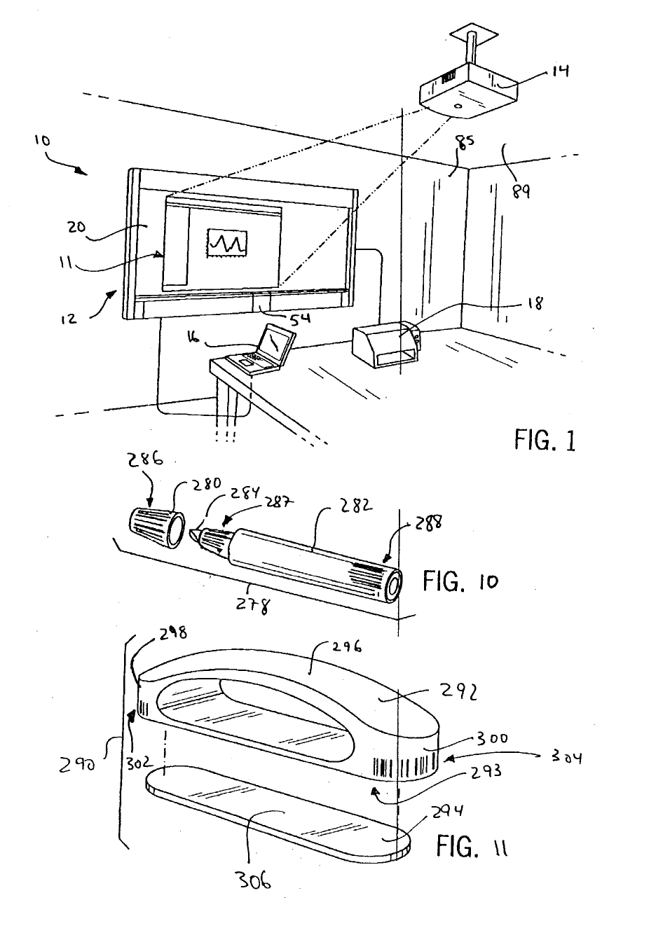

As an initial matter, it should be appreciated that several related inventive concepts are described in this document where many concepts have features necessary for that particular concept to function but that are not necessary to facilitate other concepts. In these cases, it should be understood that features that are not necessary to facilitate concepts should not be read into the limitations in the claims. For example, while the inventive concepts are described below in the context of a system 10 (see FIG. 1) including a whiteboard assembly, a computer and a printer, several of the concepts can be facilitated with just a whiteboard assembly as described below and without the other components. As another example, while some concepts require a projector, other concepts do not. For instance, in embodiments where “virtual ink” (described in greater detail below) is contemplated, a projector unit is required while in other embodiments where real ink pens are employed, the projector unit may be optional. As one other example, an inventive whiteboard mounting structure is described below that, while advantageous, is not required to facilitate other inventive concepts.

A. Hardware

Referring now to the drawings wherein like reference numerals correspond to similar elements throughout the figures and, more specifically, referring to FIG. 1, the present invention will be described in the context of an exemplary electronic whiteboard system 10 including an electronic whiteboard 12, a projector unit 14, a computer 16 and a printer 18. In general, board 12 includes a processor/interface module 54 which is linked to each of projector 14, computer 16 and printer 18 so that various synergies can be realized between system components. The linkages in FIG. 1 are shown as hard wire links, nevertheless, it should be understood that the present invention should not be so limited and that other linking technologies may be employed such as, for example, wireless communication via any of several well-known protocols (e.g., Bluetooth, 802.11b communication, etc.).

Referring still to FIG. 1, board 12 is generally mounted to a vertical wall support surface 85 such that a whiteboard surface 20 formed by board 12 faces in a direction opposite wall surface 85. Projector unit 14 is positioned with respect to whiteboard surface 20 such that images projected by unit 14 are directed toward surface 20 and appear thereon. To this end, as illustrated, projector 14 may be mounted to a horizontal ceiling surface 89 within a room that includes whiteboard 12. In the alternative, unit 14 may be positioned on a table or cart in front of surface 20. Although not illustrated, in some embodiments projector 14 may be positioned behind surface 20 to back project images thereon. Computer 16 and printer 18 are generally located within the same room as, or at least proximate, whiteboard 20 so that each of those components is easily employed during whiteboard use and so that each can be interfaced with whiteboard 20. Note that in some embodiments computer 16 and printer 18 need not be proximate board 20.

In at least some embodiments, computer 16 can be used to provide a display image projector 14 to display images on surface 20. Thus, for instance, a spreadsheet image, graphical image (e.g., 11) displayed on the screen of computer 16 may also be projected onto surface 20. Here, in some embodiments, computer 16 communicates with projector 20 via module 54 as described in greater detail below.

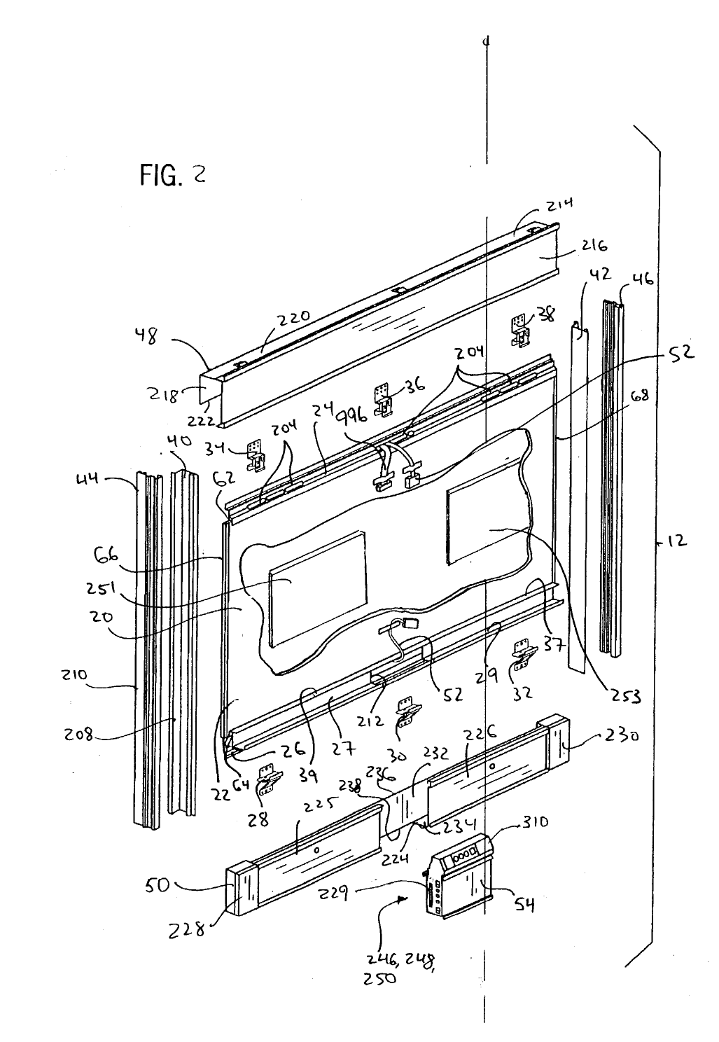

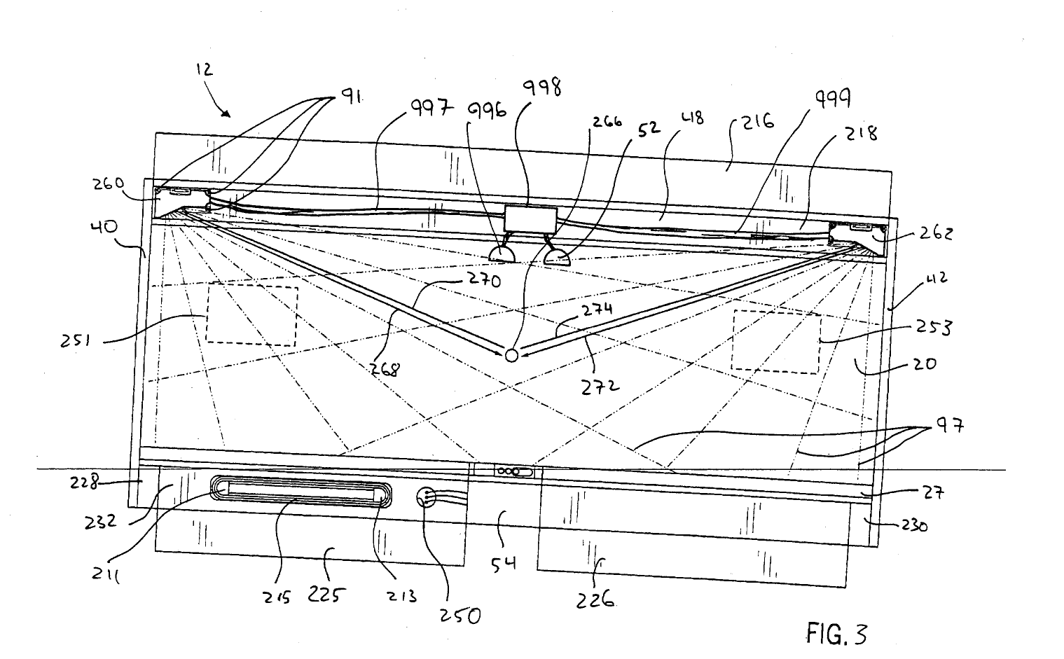

Referring still to FIG. 1 and also to FIGS. 2 and 3, whiteboard 12 includes a plurality of components that, when assembled, provide a precisely functioning electronic whiteboard system that is particularly aesthetically pleasing. To this end, board 12 includes a whiteboard member 22, upper and lower board edge members 24 and 26, respectively, first, second and third lower bracket assemblies 28, 30, and 32, respectively, first, second and third upper bracket assemblies 34, 36 and 38, respectively, first and second inside edge panels 40 and 42, respectively, first and second lateral finishing members or end caps 44 and 46, respectively, an upper header 48, a lower header 50, communication cables 52, processor/interface module 54, an instrument tray 27, two acoustic sensors 251 and 253 shown in phantom and first and second laser sensor units 260 and 262.

Board member 22 is generally a rigid lightweight member that, as its label implies, forms a white writing surface 20. Surface 20 is typically formed by a plastic white substrate applied over some lightweight rigid base material such as particleboard, Styrofoam or the like. Board member 22 is typically rectilinear having an upper edge 62, a lower edge 64 and first and second lateral edges 66 and 68, respectively, that traverse between upper and lower edges 62 and 64.

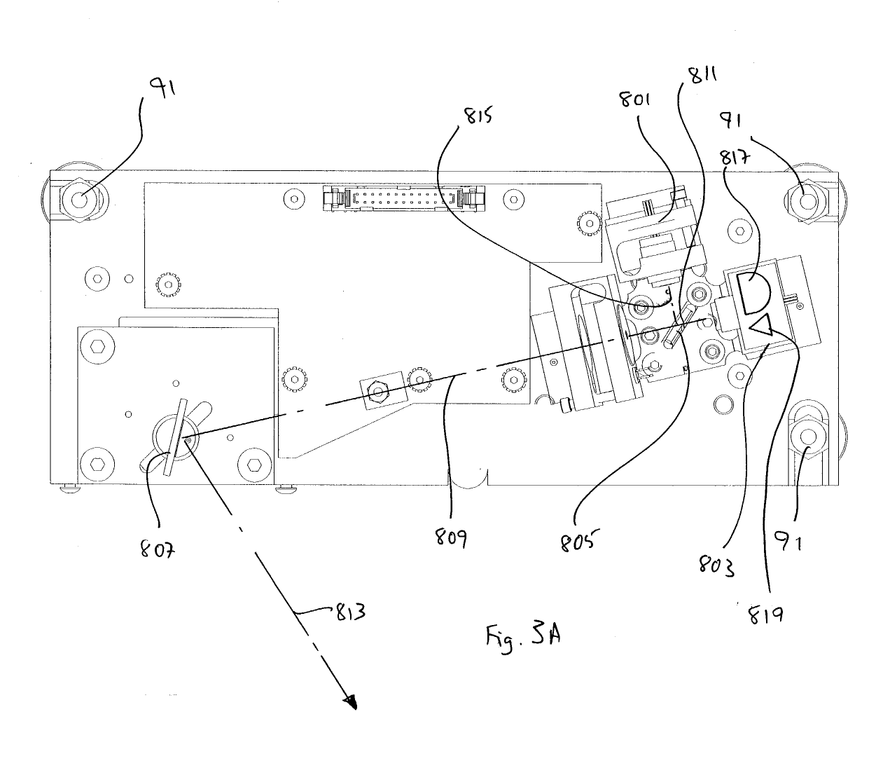

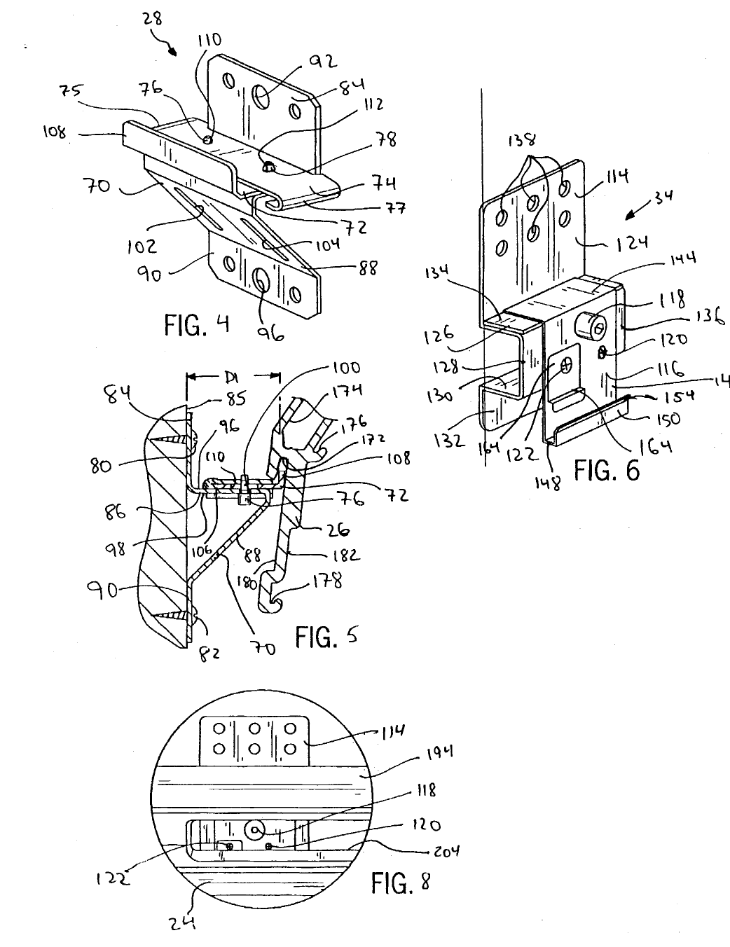

Referring still to FIG. 2, each of lower bracket assemblies 28, 30 and 32 is essentially identical and therefore, in the interests of simplifying this explanation, unless indicated otherwise, only assembly 28 will be described in detail. Referring also to FIGS. 4 and 5, assembly 28 includes a base member 70, an adjustment member 72, a clamping assembly including first and second clamp screws 76 and 78, and first and second mounting screws 80 and 82. Each of base member 70 and adjustment member 72 is formed of sheet metal which is bent into the illustrated forms and, after bending, is generally rigid.

As best illustrated in FIG. 5, in cross-section, base member 70 includes first, second, third, and fourth members 84, 86, 88 and 90, respectively, where first and second members 84 and 90 form co-planer surface and are separated by second and third members 86 and 88. Second member 86 is integrally linked to one long edge of first member 84 and forms a right angle with first member 84. Third member 88 is integrally linked to the edge of second member 86 opposite first member 84, forms a forty-five degree angle therewith. Fourth member 90 is integrally linked to the edge of third member 88 opposite second member 86 and forms an approximately one hundred and thirty-five degree angle therewith so that first member 84 and fourth member 90 extend in opposite directions. Each of first and fourth members 84 and 90 form at least one mounting aperture suitable to pass the shaft of one of screws 80 or 82 while stopping their respective screw heads. When base member 70 is mounted to vertical surface 85 with screws 80 and 82 securely holding first and fourth members 84 and 90 there against and with first member 84 above fourth member 90, second member 86 is horizontally juxtaposed and forms upward and downward facing surfaces 96 and 98, respectively. Second member 86 also forms two holes 100 (only one illustrated in FIG. 5) equi-spaced between lateral edges.

Third member 88 forms first and second slots 102 and 104 that are generally laterally aligned with the holes (e.g. 100) formed by second member 86. Slots 102 and 104 are provided to allow a person mounting or adjusting bracket assembly 34 to access a screw 76 or 78 there above.

Referring still to FIGS. 4 and 5, adjustment member 72 is generally L-shaped in cross section including first, second and third members 106, 108 and 74. Third and second members 74 and 108, respectively, are integrally linked to opposite edges of first member 106 with second member 108 forming a right angle with first member 106 and third member 74 parallel to first member 106 and extending back toward second member 108. First member 106 is longer than second member 108 in cross section and forms two enlarged apertures 110 (only one illustrated in FIG. 5). Third member 74 forms two threaded apertures 110 and 112 that align with the apertures in first member 106. When adjustment member 72 is placed on upper surface 96 of second member 86, the first member apertures generally align with the holes (e.g., 100) formed by second member 86. In the illustrated embodiment, second member 108 extends upward from first member 106 when adjustment member 72 is mounted to base member 70. Second member 108 is also referred to herein as an edge-engaging member 108. The lateral edges of third member 74 form curled ends 75 and 77 such that ends thereof face each other.

To assemble bracket assembly 28, third member 74, first member 106 and second member 86 are positioned such that first member 106 is sandwiched between second member 86 and third member 74 with the holes formed by each of members 74, 86 and 106 aligned and such that edge engaging member 108 extends in the same direction as first member 84. Thereafter, screws 76 and 78 are fed up through the holes formed by second member 86 and first member 106 and the distal ends of screws 76 and 78 are threadably received within holes 110 and 112. With screws 76 and 78 in a loose state, while screws 76 and 78 hold the base member and adjustment member together, adjustment member 72 can be moved with respect to base member 70. More specifically, with screws 76 and 78 in a loose state, the relative juxtaposition of edge engaging member 108 with respect to the plane defined by first and fourth members 84 and 90 can be modified to either increase or decrease the dimension D1 there between or to form an angle between members 84 and 108 such that those members are slightly askew from parallel (e.g., in FIG. 4, the left end of member 108 may be closer to member 84 than the right end of member 108). When screws 76 and 78 are tightened, members 78 and 86 squeeze member 106 there between and lock the relative juxtapositions of edge engaging member 108 and first member 84. Thus, extend dimension or distance D1 between surface 85 to which assembly 28 is mounted and edge-engaging member 108 can be modified and locked.

Referring again to FIG. 2, each of upper bracket assemblies 34, 36 and 38 has an identical construction and therefore, in the interest of simplifying this explanation, unless indicated otherwise hereinafter, the upper bracket assemblies will be described in the context of assembly 34. Referring also to FIGS. 6 and 7, bracket assembly 34, like assembly 28, is generally constructed of rigid sheet metal that is bent the rigid components illustrated. Assembly 34 includes a base member 114, an adjustment member 116, mounting screws 140, 142 and a clamping assembly including an adjustment screw 118 and screws 120 and 122.

Base member 114 includes first through fifth members 124, 126, 128, 130 and 132, respectively. First and fifth members 124 and 132 form a co-planer surface and are linked together by second, third and fourth members 126, 128 and 130. Second member 126 is integrally linked along one edge of first member 124 and forms a right angle with first member 124. Third member 128 is integrally linked to second member 126 along an edge opposite first member 124, forms a right angle with second member 126 and extends in a direction opposite the direction in which first member 124 extends from second member 126. Fourth member 130 is integrally linked to an edge of third member 128 opposite second member 126, is parallel to member 126 and extends in the same direction from third member 128 as does second member 126. Fifth member 132 is integrally attached to an edge of fourth member 130 opposite the edge to which third member 128 is attached, forms a right angle with fourth member 130 and extends in a direction opposite first member 124. Thus, as illustrated best in FIGS. 6 and 7, second, third and fourth members 126, 128 and 130 together form a structure akin to a rail. When base member 114 is mounted to a wall surface 85 (see FIG. 7), second member 126 forms an upward facing surface 134 and third member 128 forms a generally vertical surface 136 that faces away from wall surface 85. First member 124 forms a plurality of mounting holes collectively identified by numeral 138. In addition, third member 128 forms an adjusting hole 152 that is threaded to receive adjustment screw 118.

Adjustment member 116, like base member 114, is formed out of sheet metal bent to form four integrally connected members including first through fourth members 144, 146, 148 and 150, respectively. Second member 146 is integrally linked to first member 144 and forms a right angle with first member 144. Third member 148 is integrally linked to an edge of second member 146 opposite the edge to which first member 144 is linked, forms a right angle with second member 146 and extends in a direction from second member 146 opposite the direction in which first member 144 extends. Fourth member 150 is integrally linked to an edge of third member 148 opposite the edge to which second member 146 is linked, forms a right angle with third member 148 and is generally parallel to second member 146 and forms a channel 155 with second and third members 146 and 148. First member 144 forms an upper surface 145.

A distal edge of fourth member 150 forms a lip member 154 that angles outwardly in a direction generally away from second member 146. Lip member 154 is provided to help guide upper board edge member 24 (see again FIG. 4) onto fourth member 150 in a manner to be described in greater detail below.

Second member 146 forms three holes. A first hole 156 is sized to pass the shank of adjustment screw 118 while the other two holes 160 (only one shown in FIG. 7) are sized to receive screws 120 and 122. Each of the smaller holes 160 is threaded so as to threadably receive the corresponding screw.

Adjustment screw 118 includes a head member, a threaded shaft and a rib or washer member 158 that extends outwardly from a portion of the screw shaft which is separated from the head member such that, as illustrated best in FIG. 7, when the screw shaft extends through hole 156 in second member 146, rib member 158 and the head of screw 118 sandwich second member 146 there between.

To assemble assembly 34, with rib member 158 and the head of screw 118 holding screw 118 to adjustment member 116, adjustment member 116 is juxtaposed with respect to base member 114 such that first member 144 rests on upper surface 134 of base member 114 and so that the shaft end of screw 118 is aligned with threaded hold 152 formed by base member 114. Next, screw 118 is rotated to thread the shaft end thereof into hole 152.

To mount bracket assembly 34 to a wall surface 85, base member 114 is juxtaposed such that the co-planer surfaces formed by first and fifth members 124 and 132 rest against surface 85. Next, mounting screws 140 and 142 are fed through holes 138 and screwed into surface 85. Importantly, it should be appreciated that, by adjusting the degree to which screw 118 is threaded into hole 152, the relative positions of adjustment member 116 and base member 114 can be modified such that a distance between the co-planer surfaces defined by first and fifth members 124 and 132 and the edge engaging member 150 can be modified (i.e., extend dimension or distance D2 in FIG. 7 can be altered).

Referring again to FIG. 7, the distal end 162 of tightening screw 120 when tightened within associated hole 160, abuts against surface 136 causing pressure between the threads of screw 118 and the threads of aperture 152 and thereby, generally, locking components of bracket assembly 34 in a specific juxtaposition.

Referring still to FIG. 7 and once again to FIG. 6, assembly 138 also includes a clamp arm 164 formed out of thin sheet metal having first, second and third integrally connected members 166, 168 and 170, respectively. First member 164 forms a hole (not labeled) through which screws 122 extends so that screw 122 holds clamp arm 164 to second member 146 of adjustment member 116. Second member 168 is integrally linked to one edge of first member 166 and forms a right angle therewith while third member 170 is integrally linked to an edge of second member 168 opposite the edge to which first member 166 is linked, forms a right angle with second member 168 and extends in a direction from second member 168 opposite the direction in which first member 166 extends. When clamp arm 164 is mounted to adjustment member 116, second member 146 and third member 170 form a recess there between.

Referring once again to FIG. 2 and also FIG. 5, lower board edge member 26 is generally an extruded member having a length similar to the length of bottom edge 64 of board member 22 and, generally, is defined by first and second oppositely facing surfaces 180 and 182, respectively. Surfaces 180 and 182 form first through fourth channels 172, 174, 176 and 178, respectively, that generally extend along the entire length of member 26. First surface 180 forms first channel 172 that, when member 26 is juxtaposed as illustrated in FIG. 5, opens downwardly. Second surface 182 forms each of third and fourth channels 176 and 178, respectively, that both open upwardly when channel 172 opens downwardly. When channel 178 is positioned below channel 176, second channel 174 generally opens upwardly. Channel 172 is sized such that channel 172 snugly receives edge-engaging member 108 as illustrated in FIG. 5. Similarly, each of channels of 176 and 178 are sized so as to receive other assembly components described below to facilitate mounting. Second channel 174 is sized to receive the lower edge 64 of board member 22. In at least some embodiments edge member 26 is glued to lower edge 64.

Referring again to FIG. 2, instrument tray 27 is not illustrated or described here in great detail. Here, it should suffice to say that tray 27 is generally provided to, as its label implies, provide a convenient receptacle for instruments being used with board 20 such as, for instance, pens, erasers, stylus instruments, etc. Referring also to FIG. 5, in at least some embodiments tray 27 includes an extruded member (see FIG. 2, not illustrated in FIG. 5) that forms a downwardly extending member receivable within upper channel 176 formed by lower edge member 26. Screws or other mechanical fasteners can be used to secure an upper edge of tray 27 to the lower edge of board 20. When so mounted tray 27 forms an upward facing shelf or receptacle surface 29. In the illustrated embodiment an opening 212 is formed in a central portion of tray 27 which is sized to receive processor/interface module 54. Although not illustrated, an opening is also formed in lower edge member 26 that aligns with opening 212 upon assembly.

In addition, tray 27 also includes a lip member 37 that forms a surface 39 that generally faces upward when tray 27 is mounted to the lower edge member 26. Lip member 37 gives a finished appearance to the internal boarder of the lower edge components of assembly 12. In addition, surface 39 is used to perform a laser aligning method described below. In at least some embodiments lip member 37 is constructed to perform several additional functions. In this regard, in at least some embodiments member 37 is angled downward away from surface 20 as illustrated in FIG. 28. Here, lip member 37 blocks laser beams from reaching bar coded tools in the tool tray therebelow that are not being used, (a function that is also facilitated if lip 37 is perpendicular to surface 20). In addition, the angled lip 37 ensures that bar coded instruments cannot be supported thereon and sensed. Moreover, the angled lip surface 39 reflects laser beams (e.g., 569 in FIG. 28) that subtend surface 39 away from the laser unit sensors along other trajectories (e.g., 571 in FIG. 28) to ensure that beams bouncing off surface 37 do not interfere with unit sensors.

Referring to FIGS. 2 and 7, upper edge member 24 is generally an extruded member having a length dimension similar to the length of upper edge 62 of board member 22 and is generally L-shaped having first and second primary members that form a right angle. First primary member 186 forms upper and lower surfaces 190 and 192, respectively, and first and second extension members extend upward from a distal edge of upper surface 190 along the entire length of member 186 thereby forming an elongated channel 198 for receiving a portion of header 48 as described below.

Second primary member 188 extends from an edge of first member 186 opposite extension members 194 and 196 and in a direction opposite members 184 and 196 and includes three important characteristics. First, member 188 forms an extension 200 having a T-shaped cross section sized to be received between clamp arm 164 and the recess 155 formed by adjustment member 116. T-shaped extension 200 extends generally perpendicular to member 188 and in the same direction as member 186.

Second, at a distal edge opposite the edge linked to first member 186, second member 188 forms a channel 202 for receiving the upper edge 62 of board member 22. In at least some embodiments upper edge 62 is glued within channel 202. When edges 62 and 64 are glued within associated channels of edge members 24 and 26, the three components 24, 20 and 26 (e.g., the upper edge member, board and lower edge member) form a single component for mounting purposes.

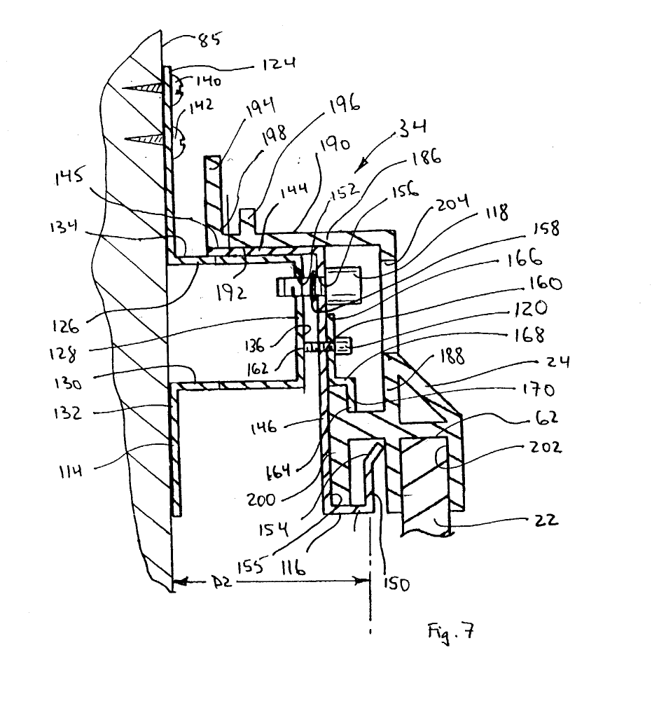

Third, second member 188 forms a number of slots collectively identified by numeral 204. Slots 204 are spaced apart along the length of member 24 (see FIG. 4) and are formed near the joint between members 186 and 188 (see FIG. 7). Each slot 204 is sized so that, when lower surface 192 is supported on upper surface 145 and one of the upper bracket assemblies (e.g., 34) is aligned with the slot 204, the heads of each of screws 118, 120 and 122 are accessible through the aligned slot 204 (see also FIG. 8 in this regard). As illustrated in FIG. 2, one end of cable harness 52 is fed through opening 212 and the second end is fed through a central one of slots 204.

Referring again to FIG. 2, each of inside edge panels 40 and 42 has a similar construction and therefore, in the interest of simplifying this explanation, only panel 40 is described with some detail. Generally, panel 40 is an extruded member including a flat surface (not labeled but facing lateral board edge 66) and a contoured surface 208 opposite the flat surface. The contoured surface 208 is generally formed to receive a complimentary surface (not numbered) formed by an associated end cap 44. Panel 40 has a length dimension that is similar to the length of lateral edge 66 plus the height dimensions of headers 48 and 50 such that, upon assembly, panel 40 extends along the combined edge of headers 48 and 50 and edge 66. Panel 40 has a width dimension such that panel 40 extends from surface 20 at least as far as tray 27 so that tray 27 is completely located between facing panels 40 and 42 upon assembly.

Each of end caps 44 and 46 has a similar configuration and therefore only cap 44 is described here in some detail. As indicated above, a surface of cap 44 that faces panel 40 is contoured to compliment the facing surface of panel 40 so that the two generally mate when pressed together. An external surface 210 of cap 44 is formed of aluminum or wood to provide a desired appearance. In some embodiments entire member 44 may be formed of a finishing material such as wood or veneer on some type of substrate.

Referring to FIG. 2, upper header 48 has a length dimension essentially equal to the length of upper edge member 24 and includes an L-shaped member 214 and a door 216. Member 214 is generally an extruded member including first and second member 218 and 220 that form a right angle. Member 218 has a mounting edge 222 opposite the edge linked to second member 220. Door 216 is hingedly linked to the edge of second member 220 opposite the edge that first member 218 is linked to. Door 216 is generally moveable between the closed position in FIG. 2 and the open position illustrated in FIG. 3. Edge 222 has a thickness dimension (not labeled) that is similar to the dimension formed by channel 198 between extension members 194 and 196 (see again FIG. 7) so that edge 222 is receivable within channel 198 during assembly. Where the widths of member 218 and door 216 are perpendicular to the length of header 48, the width of door 216 is greater than the width of member 218 so that, when edge 222 is received within channel 198 and door 216 is closed, door 216 extends below edge member 24 and generally hides mounting components there behind.

Referring again to FIG. 2, lower header or “footer” 50 has a length dimension similar to the length of lower edge member 26 and includes a generally L-shaped member 224, first and second lower doors 225 and 226, respectively, and first and second speaker/microphone units 228 and 230, respectively. Member 224 is generally an extruded member including first and second members 232 and 234 that form a right angle. Member 232 has a mounting edge 236 opposite the edge linked to second member 234. Although not illustrated, a downward extending member extends from a backside of member 236 proximate edge 236 that is receivable within recess 178 (see also FIG. 5) for mounting header 50 to lower edge member 26. When so mounted, edge 236 is received against surface 182 for mounting thereto.

Referring still to FIG. 2, a central section of second member 234 is cut out forming an opening 238 for receiving module 54. Opening 238 divides member 234 into first and second parts (not separately labeled). Doors 225 and 226 are separately hinged to the first and second parts, respectively, for movement between the closed position illustrated in FIG. 2 and the open position illustrated in FIG. 3. When header 50 is mounted to lower edge member 26 and doors 225 and 226 are closed, doors 225 and 226 generally close to the underside of tray 27 thereby forming closed spaces for storage of system components. Speaker/microphone units 228 and 230 are mounted at opposite ends of header 50.

Referring now to FIG. 2 and also to FIG. 3, in at least one embodiment, two mounting posts 211 and 213 are provided within one of the spaces defined by lower header 50 for receiving and storing a system cable 215 which, typically, will comprise a projector or computer cable for linking projector 14 or computer 16 to module 54. In addition, member 232 forms a linkage opening 250 for passing various cables (e.g., computer, printer, projector, network connection, etc.) that are to be linked to module 54.

Referring now to FIG. 3, first and second laser position sensor units 260 and 262 are mounted in opposite upper corners of header 480 and each is juxtaposed to, when turned on, generate a beam of light that is directed across surface 20. Each unit 260 and 262 is controlled to scan its light beam through an arc that traverses the entire surface 20 during each cycle where each cycle period is a fraction of a second. When surface 20 is completely flat and units 260 and 262 are properly aligned therewith, the beams define a sensing plane represented by phantom lines 97 (three collectively labeled via numeral 97) emanating from each of units 260 and 262 that is equidistant from surface 20 at all locations. For example, in at least one embodiment the sensing plane may be 0.45 inches from surface 20 at all locations.

In addition to the beam source, each unit 260 and 262 also includes a light sensor that receives light and senses the trajectory of the sensed light. The sensor is tuned to sense light that is generated by a corresponding unit (e.g., 260) and that bounces back from a reflector on an instrument that penetrates the sensing plane. Thus, for instance, when an ink marker contacts surface 20 at location 266, a light beam along trajectory 268 bounces off the reflective tip of the marker at location 266 and is directed back to unit 260 along trajectory 270. Similarly, a beam along trajectory 272 from source 262 bounces back to unit 262 along trajectory 274.

Referring still to FIG. 3, each of units 260 and 262 is linked to a laser control module 998 via a separate cable 997 and 999, respectively and module 998 is in turn linked via cables 52 (see again FIG. 2) to module 54 and provides a real time electronic data stream of signals thereto indicating instantaneous trajectories between the units and an instrument that penetrates the sensing plane. Module 54 is programmed to use the trajectory information to identify the location of an instrument within the sensing plane via any of several well-known triangulation algorithms. Laser control module 998 is also linked to the array of acoustic sensors 251, 253 via a cable 996.

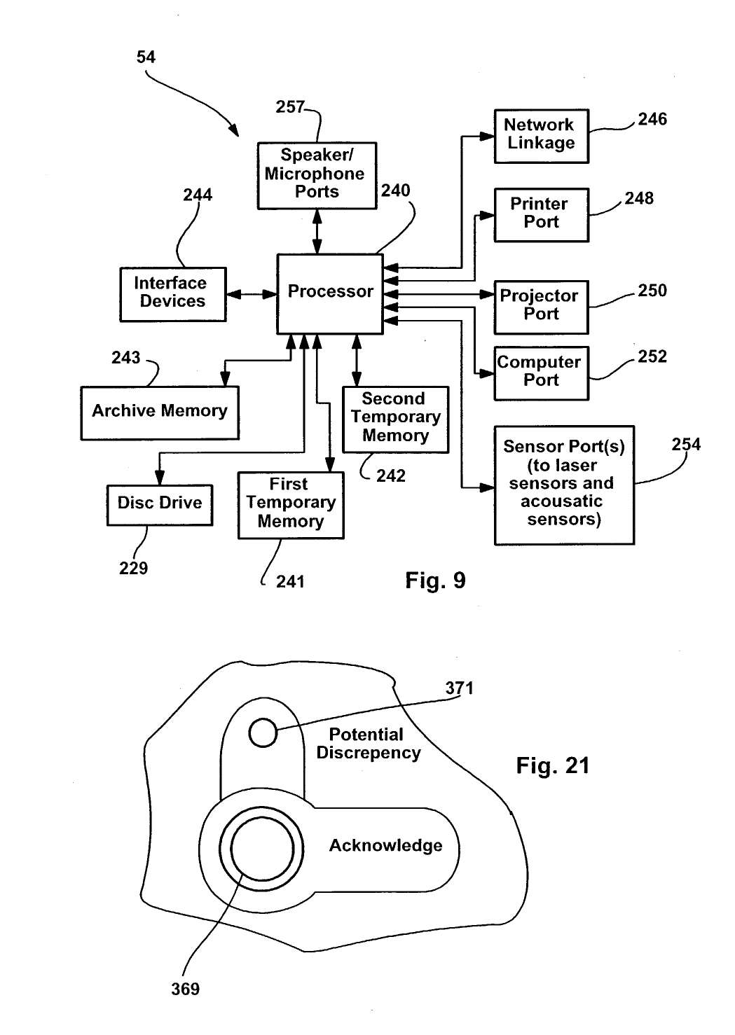

In addition to generating trajectory information regarding instrument location, in at least some embodiments, units 260 and 262 are also configured to read instrument tags within the sensing plane such as bar codes, etc., where the codes may indicate various characteristics of an associated instrument. For instance, a code on a pen instrument may indicate that the instrument is a pen, pen color, pen tip thickness, etc. In the case of an eraser, the code may indicate that the instrument is an eraser, the eraser swath, the eraser color (e.g., in the case of a virtual ink system). Other bar codes may indicate a stylus or a mouse cursor, etc. The code information is provided to module 54 which is also programmed to determine instrument characteristics. Thus, for instance, referring still to FIG. 3, if a properly bar coded red pen is used to make a circle on surface 20, a module processor (e.g., see 240 in FIG. 9) identifies the instrument as a red pen and tracks pen location to determine that a circle is formed. Processor 240 then stores an electronic version of the “written” data on surface 20 in a memory (e.g., see 241 in FIG. 9). If a coded eraser is used to remove a portion of the red circle, processor 240 senses the modification and updates the stored electronic version by either storing the eraser stroke or by removing a portion of the previous detected pen strokes from the memory.

In at least some embodiments each of units 260 and 262 includes two different beam sources where the first source is an infrared source and the second source is a visible light source. In some cases the visible light source, when activated, will generate a beam that is only visible in low light conditions (e.g., when ambient light is low and shades are drawn). In other embodiments the light gain can be increased to produce a bright laser light. Here, in at least some embodiments, the light sources are used independently so that, when one source is on, the other source is off. In normal operation, the invisible or infrared source is used to track instrument activity. The visible source is used for laser alignment purposes as described in greater detail below. In some embodiments, the visible sources are turned on when header door 216 is opened and are turned off when door 216 is closed.

Referring to FIG. 3A, components of an exemplary unit 260 are illustrated in greater detail including an IR/visible light source 803, a sensor 801, a stationary mirror 805 and a rotating mirror 807. Source 803 is capable of generating either visible or IR light beams directed along a first axis 809 toward mirror 807. The IR and visible source elements are schematically labeled via blocks 817 and 819, respectively. In some cases source 803 may provide visible and invisible beams in an interleaved fashion (visible followed by invisible followed by visible, etc.) when the visible beam is activated. Mirror 805 is rigidly mounted in front of source 803 and includes a small hole 811 aligned with the beam formed along axis 809 so that the beam passes therethrough unobstructed.

Rotating mirror 807 is a two sided mirror that rotates about an axis (not labeled) that is perpendicular to axis 809 and that axis 809 passes through so that the beam along axis 809 subtends whatever surface of mirror 807 faces source 803. As mirror 807 rotates, the beam along axis 809 reflects therefrom along an axis 813 and across the surface of board 20 within the sensing plane.

When light reflects off a bar code on the end of a pen or the like within the sensing plane, the light reflects back toward rotating mirror 807 and is directed back toward mirror 805 along trajectory 809. The reflected beam is generally wider than the initial beam from source 803 and hence does not completely pass through the hole in a mirror 805. The light that subtends the mirror 805 surface is directed thereby along a trajectory 815 toward sensor 801 so that sensor 801 senses the reflected light.

Referring again to FIG. 2, acoustic sensors 252 and 254 (e.g., tuned microphones) are mounted to a back surface of board 22 opposite surface 20 and are provided to perform two functions in at least some embodiments. First, sensors 252 and 254 are provided to sense any noise within an immediate vicinity and generate a wake-up signal that is provided to module 54 to turn the module on and activate the laser units 260 and 262. Here, a noise as slight as turning on a light switch or placing a book on a table may be sensed and cause system activation. Second, sensors 252 and 254 are provided to sense acoustic “write-effective” events, coded or not, that occur on surface 20. To this end, sensors 252 and 254 may be tuned to differentiate between room noise and the noise that occurs when contact is made with surface 20. Appropriate audio filtration is preferably employed to distinguish real board writing and/or erasing activity from any general, ambient, acoustical activity, that might vibrate a board's surface. The details of such filtration are simply a matter of designer choice with respect to different given systems. Generally speaking, however, a frequency of about 25-Kilohertz is considered to be a good mid-range frequency regarding much detected acoustical activity.

It is also possible that sufficiently sophisticated and aurally agile filtering may be employed to be able to detect and distinguish the different audible “signatures” of different write-effective devices. For example, it is entirely possible to distinguish the respective motion/contact sounds of a marking pen, of a non-marking stylus, and of eraser. With respect to embodiments that employ a display board or other kind of surface in a “computer, mouse-like” way, acoustic componentry may be included which differentiates different acoustic signatures to “control” left and right mouse clicks. Detected events may include, for instance, the beginning and continuation of writing or instrument activity via a pen, a stylus or an eraser. Additionally, acoustic sensors 251 and 253 and others (not illustrated) may be used to localize the sound of a pen, stylus or eraser to provide additional information about the location of an instrument on or in contact with the board.

Referring now to FIG. 10, an exemplary bar coded pen instrument 278 is illustrated that includes a pen shaft member 282 and a cap 280. In at least one embodiment of the invention, different bar codes or handle tags are provided at the opposite ends of shaft member 282 so that, when the end of member 282 including the marker tip 284 contacts surface 20, code 287 adjacent thereto is within the sensing plane and when the opposite end contacts surface 20, code 288 is within the sensing plane. Here, each of codes 287 and 288 will typically identify instruments having different characteristics. For example, while code 287 may indicate a red relatively thin pen, code 288 may indicate a stylus type instrument for moving a projected cursor about surface 20.

In one embodiment cap 280 includes a bar code or cap tag 286 on an external surface where cap 280 is sized to receive an end of shaft member 282 and completely cover the bar code at the received end. In FIG. 10 the marker end is receivable in cap 280. Here, cap code 286 may indicate characteristics different from code 287 which cap 280 covers upon reception. For instance, again, code 286 may indicate a stylus for moving a projected cursor.

Although not illustrated in FIG. 10, it should be appreciated that both ends of member 282 may be designed to receive a cap (e.g., 286) where the cap covers a code at the receiving tip so that the cap code effectively “replaces” the tip code during use. Also note that other embodiments are contemplated where cap 286 does not cover the tip code but simply extends the length of the combined shaft and cap assembly such that the tip code cannot be sensed by the scanning laser units 260 and 262. Thus, for instance, consistent with the example above where the sensing plane is 0.45 inches from surface 20, cap 286 may extend the length of the shaft/cap assembly so that the tip code is one inch from the end of the cap so that when the shaft/cap combination is employed, the tip code is outside the sensing plane.

Thus, a single instrument may include more than one code where each code is juxtaposed with respect to the other codes such that only one of the codes is receivable within a sensing plane at one time when the instrument is used in a normal fashion. In this case, the single instrument can be a multi-purpose instrument.

Referring now to FIG. 11, an exemplary bar coded eraser assembly 290 is illustrated which includes a handle member 292 and a replaceable eraser pad 294. Handle member 292 generally includes a molded plastic single handgrip member 296 that has a generally oblong shape and a single flat surface 293 that extends along the oblong length of the member. Opposite ends of member 292 are generally curved and form end surfaces 298 and 300 that, when flat surface 293 is parallel to surface 20 (see again FIG. 3), are generally perpendicular to surface 20. Instrument characterizing bar codes 302 and 304 are provided on ends 298 and 300, respectively, that can be sensed by units 260 and 262 when in the sensing plane so that processor 240 can track eraser movements. Importantly, the bar codes at ends 298 and 300 have angular variances such that the sensing system can determine the juxtaposition of the eraser 290 with the board surface and hence can identify different intended eraser swaths. For instance, if assembly 290 is positioned on surface 20 with its length vertically oriented (e.g., ends 298 and 300 facing up and down, respectively) and is moved from left to right a swath as wide as the length of assembly 290 would be intended whereas if assembly 290 is positioned with its length horizontally oriented (e.g., ends 298 and 300 facing laterally) and is moved from left to right a swath as wide as the width of assembly 290 would be intended. Here the system may be programmed to identify the two juxtapositions described above and any other juxtapositions therebetween and adjust effective eraser swath accordingly. In some embodiments the bar codes may be placed on eraser corners or in some other configuration that facilitates determination of angular variance.

Pad 294 is typically a felt type pad and generally has the shape of flat surface 293. A mounting surface 306 of pad 294, in at least some embodiments, is provided with a tacky glue such that pad 294 is releasably mountable to surface 293.

Referring again to FIG. 10, pen 278 is a real ink pen and is useable to produce real ink marks on surface 20 where pen 278 movements and characteristics are determined and are used to create an electronic version (e.g., in temporary memory 242) of the marks placed on surface 20. In at least some embodiments the only way to apply written information to surface 20 is to use a real ink pen. In some embodiments, instead of or in addition to using real ink pens, virtual ink pens are used to produce marks on surface 20. As the label “virtual ink” implies, a virtual ink pen does not actually apply ink to surface 20. Instead, as the electronic version of marks placed on surface 20 is generated in a temporary memory (see 241 is FIG. 9), those marks are projected via projector 14 onto surface 20 (or, indeed, elsewhere if desired). For instance, when a virtual ink red pen is moved across surface 20, the pen characteristics (e.g. red, thickness, etc.) are identified and the movements are tracked so that projector 14 can generate essentially real time virtual ink marks that trail the moving tip of the pen instrument. Similarly, when a virtual ink eraser is moved across surface 20 and over virtual ink marks, the marks are erased from temporary memory 242 and hence from the projected image. Here it should be noted that the virtual ink eraser need not take the form of a physical eraser and instead could take the form of a properly coded stylus or the like.

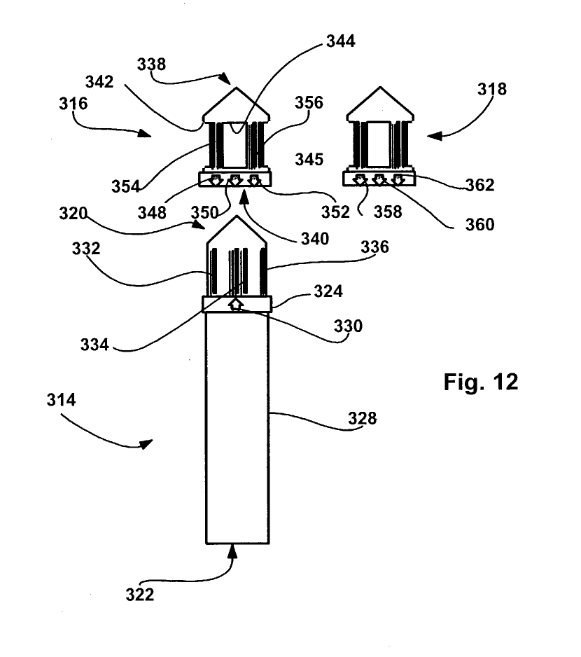

Referring now to FIG. 12, according to one inventive concept, a versatile virtual instrument assembly is provided which includes an instrument shaft member 314, a pen cap 316 and an eraser cap 318. Shaft member 314 is generally an elongated member that has first and second ends 320 and 322, respectively. A collar rib 324 extends outwardly from the surface of member 314 proximate first end 320 and, generally, divides member 314 into a tip section 326 and a holding section 328 where section 328 is generally several times longer than tip section. An alignment indicia or mark 330 is provided on the outward facing surface of rib 324. In the exemplary embodiment, mark 330 includes an arrowhead having a tip that points in the direction of first end 320.

Referring still to FIG. 12, several bar codes 332, 334, 336, etc. are provided on tip section 326 that are spaced about the circumference thereof. In one embodiment, each code (e.g., 332, 334, etc.) indicates a different instrument characteristic set. For instance, in one case, each code may indicate a different pen type (e.g., code 332 indicates blue, code 334 indicates green, etc.) As another instance, each code may indicate a different eraser swath (e.g., code 332 indicates two inches, code 334 indicates three inches.) In another embodiment a single bar code may be provided at section 326 where different sections of the code indicate different instrument characteristics. For instance, where the code length is one inch, the first half of the code may indicate a blue pen, the last half of the code may indicate a red pen, the middle half (e.g., the last part of the first half that indicates a blue pen and the beginning half of the second half that indicates a red pen) may indicate a green pen and the beginning and ending quarters of the code taken together may indicate a yellow pen. Many other combinations of code segments are contemplated.

Typically, each code (e.g., 332) is repeated at several different locations around the circumference of section 326 so that at least one code of each type is sensible via at least one of sensor units 260 and 262 at all times. Codes 332, 334, 336, etc. or code segments are provided on section 326 in specific positions with respect to mark 330, the specific positions are described below.

Pen cap 316 is generally cylindrical including a closed end tip 338 and an open end 340 for receiving first end 320 of member 314. When cap 316 is placed on end 320, entire tip section 326 is received within cap 316 and end 340 abuts a facing surface of rib 324. Thus, when cap 316 is on end 320, codes (e.g., 332) on section 326 are within cap 316. In some cases a detent or the like may be provided to hold cap 316 in a removable fashion to end 320.

Cap 316 forms several windows or openings 342, 344, etc. that are sized and positioned such that, when cap 316 is on end 320, at least some of the bar code marks on section 326 are visible therethrough. Thus, for instance, when cap 316 is in one position, the codes 332 corresponding to a blue pen may be positioned within each window, when cap 316 is in a second position, the codes 334 corresponding to a green pen may be positioned within each window, and so on. The windows may be completely open or may simply be formed of translucent plastic material through which bar codes can be read.

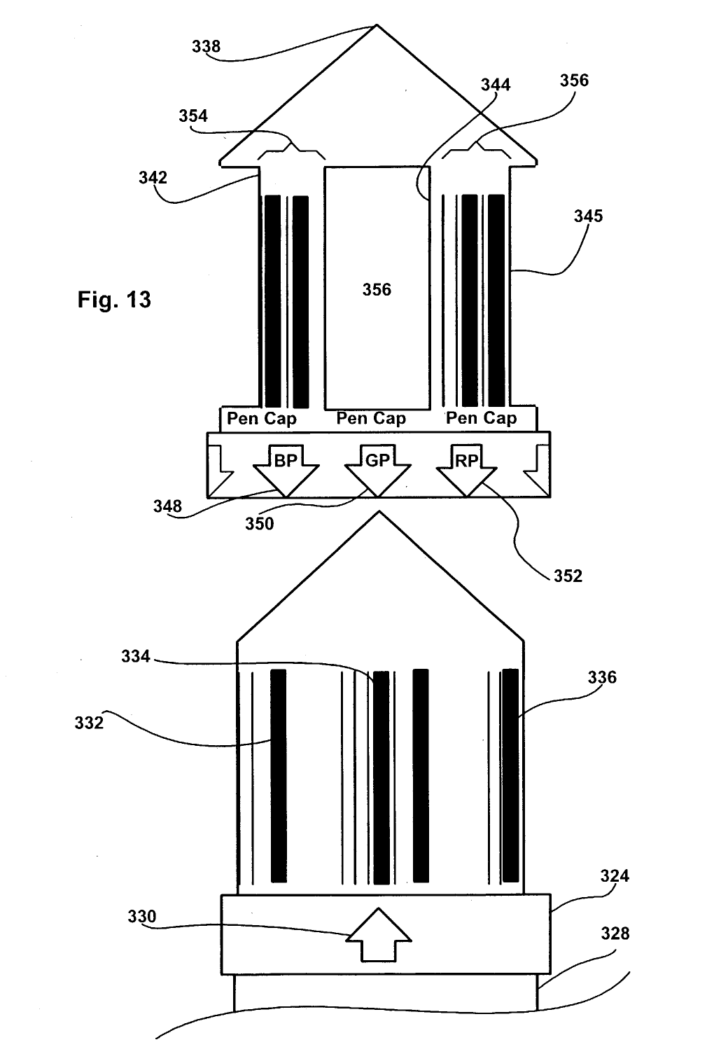

Two other features of cap 316 are of note. First, a collar rib 346 akin to rib 324 on member 314 is provided at end 340 and a series of marks 348, 350 and 352 are provided thereon. Marks 348, 350 and 352, like mark 330, are arrows but here the tips point toward second end 322 when cap 316 is on end 320 (i.e., mark arrows 348 point in a direction opposite arrow 330). Referring also to FIG. 13, an enlarged view of cap 316 and end 320 are illustrated. In FIG. 13, it can be seen that distinguishing indicia is provided on each of marks 348, 350 and 352. In FIG. 13, the “BP”, “GP” and “RP” markings indicate blue, green and red pens. Marks 348, 350, etc., are juxtaposed in specific relationship with windows 342, 344, etc. described next.

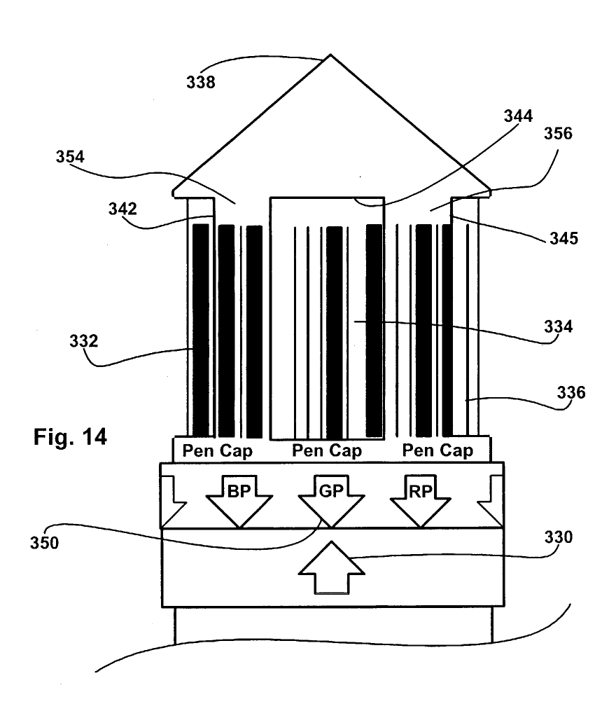

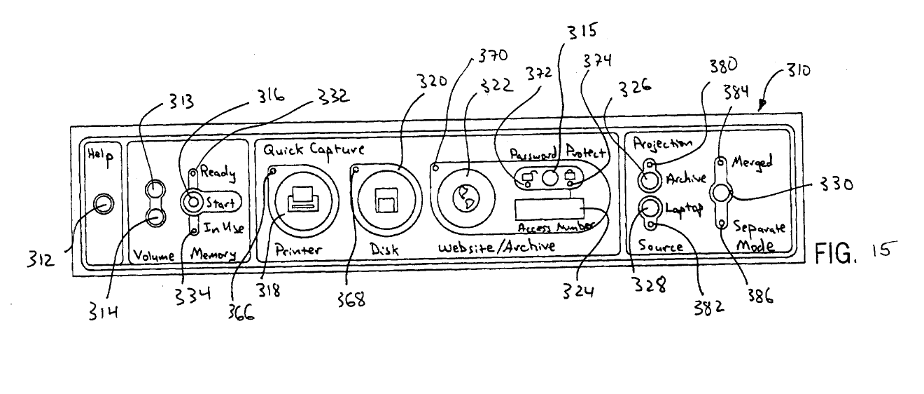

Referring still to FIG. 13 and also to FIG. 14, codes (e.g., 332) on section 326 are juxtaposed with respect to mark 330 and marks 348, 350, etc. are juxtaposed with respect to windows 342, 344, etc., such that when a specific mark 348, 350, etc. is aligned with mark 330, the codes corresponding to the indicia on the aligned mark 348, 350, etc. are located within the windows 342, 344, etc. For example, in FIG. 14, when mark 350 indicating a green pen is aligned with mark 330, the bar codes indicating a green pen (e.g., 334) are positioned in windows 342, 344, etc. Similarly, if cap 316 in FIG. 14 is rotated so that mark 348 indicating a blue pen is aligned with mark 330, the bar codes indicating a blue pen are positioned in windows 342, 344, etc.

The second additional feature of cap 316 that is of note is that bar codes 354 and 356 are provided on the external surfaces of each member that separates adjacent windows. In this embodiment it is contemplated that each inter-window code 354, 355, etc. will be identical and will indicate that cap 316 is indeed a pen cap as opposed to an eraser cap or some other type of cap. Here, as in the case of the codes on section 326, the codes 350, 352 will be positioned such that at least one of the codes is sensible via at least one of units 260, 262 when the virtual pen assembly is used to interact with surface 20.

Thus, the assembly including member 314 and pen cap 316 can be used to select a virtual pen color by rotating cap 316 on end 320 until a required color indicia is aligned with mark 330. Thereafter, when the pen is used with board 12, units 260 and 262 determine that the instrument is a pen from codes on cap 316 and thereafter determines other characteristics from codes sensed through windows 342, 344, etc.

Referring again to FIG. 12, eraser cap 318 is similar to pen cap 316 except that the inter-window codes on cap 318 indicate an eraser and the indicia on marks 358, 360 and 362 indicate some characteristic about an eraser. For instance, marks 358, 360, etc. may indicate eraser swath, eraser color (e.g., a virtual eraser may be employed to erase ink of only one color leaving ink of another color in the temporary memory 242 and projected on to surface 20) etc. Here, when cap 318 is used with shaft member 314, the codes on section 326 are used to indicate eraser characteristics that correspond to the indicia on marks 358, 360, etc. Thus, for instance, when a mark (e.g., 358) indicating a red eraser is aligned with mark 330, the bar codes indicating a red eraser are aligned with windows 342, 344, etc. and, when a mark indicating a blue eraser is aligned with mark 330, the bar codes indicating a blue eraser are aligned with windows 342, 344, etc.

Thus, it should be appreciated that a single shaft and single cap can be used to “dial up” many different virtual ink instrument types and that more than one cap can be employed with the same shaft member 314 to implement different instrument types where the meaning of codes on member 314 are dependent upon which cap is used with the shaft. In other embodiments, rotation of a cap on a shaft may change an instrument from a pen to an eraser, may alter pen thickness or both thickness and color, etc.

Referring once again to FIG. 2 and also to FIG. 9, module 54 generally includes a processor 240, first and second short term memories 241 and 242, respectively, a semi-permanent or archive memory 243, user interface devices 244, system component linkages or ports 246, 248, 250, 252, 254 and 257 and a disk drive 229 (or some other type of removable media) (see also slot 229 in FIG. 2). Processor 240 is programmed to perform various functions. One function performed by processor 240 is to “capture” various types of information displayed on surface 20 in an electronic format in one of memories 241, 242 or 243. Here, memories 241, 242 and 243 are shown as separate components to highlight the fact that different types of displayed information are stored differently and that information can be stored either temporarily or semi-permanently. Nevertheless it should be appreciated that memories 241, 242 and 243 may comprise different parts of a single memory component associated with or accessible by processor 240.

The different types of information displayable on surface 20 generally include projected information and information applied to surface 20 via ink or virtual ink. Hereinafter, unless indicated otherwise, information applied to surface 20 via ink or virtual ink will be referred to as written information to distinguish the instrument applied information from purely projected information or non-written information. As described above, when a pen is used to apply ink to surface 20, processor 240 renders an electronic version of the ink applied to surface 20 and stores the electronic version in first temporary memory 241. In addition, when non-written information is projected onto surface 20, processor 240 stores a copy of the projected information in second temporary memory 242. Thus, at times when written information is applied on surface 20 and virtual ink information is also projected on surface 20, information will be stored in both temporary memories 241 and 242. When projector 14 is not being used but written information is applied to surface 20, an electronic version of the written information is stored in memory 241 and memory 242 is blank. Similarly, when projector 14 projects virtual ink information on surface 20 but no written information is applied to surface 20, memory 242 includes an electronic version of the projected information while memory 241 is blank or clear. Where virtual pens/erasers are used to modify written information on surface 20, processor 240 senses the instrument activity in the fashion described above and alters the electronically stored written information.

In addition to storing information in memories 241 and 242, information from either or both of memories 241 and 242 can be stored on a semi-permanent basis in archive or website memory 243. The method for storing in memory 243 is described below. In at least one embodiment, memory 243 has a finite size so that the number of images stored thereon is limited. For example, in at least one embodiment, the number of images stored on memory 243 is limited to 100 and, as additional images are stored to memory 243, the “first in” (i.e., earliest stored or oldest) images are deleted. In this case, if a session attendee wants to obtain a copy of one or more images from a session, for long term storage, it is expected that the attendee will access memory 243 via server processor 240 prior to the desired images being removed (e.g., within a few days of the session) and make a copy hence the phrase “semi-permanent” archive memory.

Referring still to FIG. 9, processor 240 may be linked via network port 246 to a computer network such as a LAN, a WAN, the Internet, etc. to enable remote access to information in memories 241, 242 and/or 243. In this regard, during a whiteboard session, while information is being added/deleted from surface 20, changes to surface information is reflected in temporary memories 241 and/or 242 and hence can be broadcast via port 246. In addition, it is contemplated that, after images of displayed information are stored in archive memory 243, a remote link may be formed via network port 246 to access and/or copy any of the archived images. Moreover, it is contemplated that any image stored in memory 243 may be re-accessed via assembly 12 as described below.

Printer, computer and projector ports 248, 252 and 250 are linked to printer 18, computer 16 and projector 14 as illustrated in FIG. 1 and allow processor 240 to control each of those systems. In addition, in at least some embodiments processor 240 can be controlled by computer 16.

Referring still to FIGS. 2 and 9, speaker/microphone units 228 and 230 are linked to processor 240 via ports 257. In some embodiments sound picked up by units 228 and 230 is also storable by processor 240. In some embodiments, processor 240 is programmed to generate audible sounds and to broadcast verbal information to indicate various operating states of system 10 as well as to provide instructions regarding how to use system features as described below.

Sensor ports 254 are linked to acoustic sensors 252 and 254 as well as to laser units 260 and 262 through controller 998, receive real time electronic data stream signals therefrom that are used to perform various functions and provide signals thereto to perform other functions.

In addition to storing data to memories 241, 242 and 243, processor 240 can also store data to a disk received within disk drive 229. As illustrated in FIG. 2, drive 229 may be an integral part of module 54. In the illustrated embodiment, disk reception slot 229 is provided in a side surface of module 54 so that the slot is hidden by door 225 of the lower header when door 225 is closed.

Referring now to FIG. 15, an exemplary interface panel 310 on module 54 is illustrated. Importantly, panel 310 has a particularly intuitive and simple design and facilitates only a limited number of particularly useful functions. To this end, panel 310 includes a help button 312, plus and minus volume control buttons 313 and 314, a start button 316, a series of three “quick capture” buttons including a printer button 318, a disk button 320 and a website/archive button 322, a password protect indicator 324 and associated button 315, and a plurality of “projection” buttons including archive and laptop source buttons 326 and 328, respectively, and a mode button 330.

Panel LEDs indicate current status of the buttons or other system components associated therewith. For instance, start button 316 is associated with a “ready” LED 332 and an “in use” LED 334. When “ready” LED 332 is illuminated the temporary memory 241 is empty and, when “in use” LED 334 is illuminated, at least some written information is stored in temporary memory 241. A print LED 366 is associated with printer button 318 and indicates, generally, when printer button 318 has been selected and when printer 18 is currently printing a copy of the currently displayed information on surface 20. Disk LED 368 is associated with disk button 320 and, generally, indicates when currently displayed information on surface 20 is being stored to a disk in drive 229. A website/archive LED 370 is associated with website/archive button 322 and indicates when currently displayed information on surface 20 is being stored to archive memory 243 (see also FIG. 9). An unlocked LED 372 and a locked LED 374 are associated with password protect button 315 which is a toggle type button. Thus, one of LEDs 372 and 374 is illuminated at all times and only one of LEDs 372 and 374 is illuminated at any specific time. The states of LEDs 372 and 374 can be toggled by selecting button 315. Generally, LEDs 372 and 374 are associated with unlock and lock indicia there above (not separately labeled) where the indicia pictorially indicate an unlocked padlock and a locked padlock, respectively. An archive LED 380 is associated with archive button 326 while a laptop LED 382 is associated with laptop button 328. When either one of the archive or laptop buttons is selected, the corresponding LED is illuminated to indicate the source of currently displayed information on surface 20. Button 330, like password protect button 315, is a toggle type button and has first and second states corresponding to a merged LED 384 and a separate LED 386. The functions of buttons on panel 310 will be described below in the context of related inventive methods.

B. Mounting Whiteboard Assembly And Aligning Laser Units

Referring once again to FIG. 3, from the foregoing, it should be appreciated that, in order for units 260 and 262 to operate properly, surface 20 has to be essentially completely flat. Thus, for instance, if there is any concavity or convexity to surface 20, the distance between surface 20 and a sensing plane formed by the beams generated by units 260 and 262 will be different at different surface locations. For example, while a bar-coded pen that touches surface 20 at location 266 may result in the pen's barcode being located within the sensing plane, if that pen is moved to another location along surface 20 (e.g., the lower right-hand corner of surface 20 in FIG. 3), the barcode may instead reside between the sensing plane and surface 20 or on a side of the sensing plane opposite surface 20 such that the barcode cannot be identified. In this case, because the bar code cannot be sensed, intended information is lost.

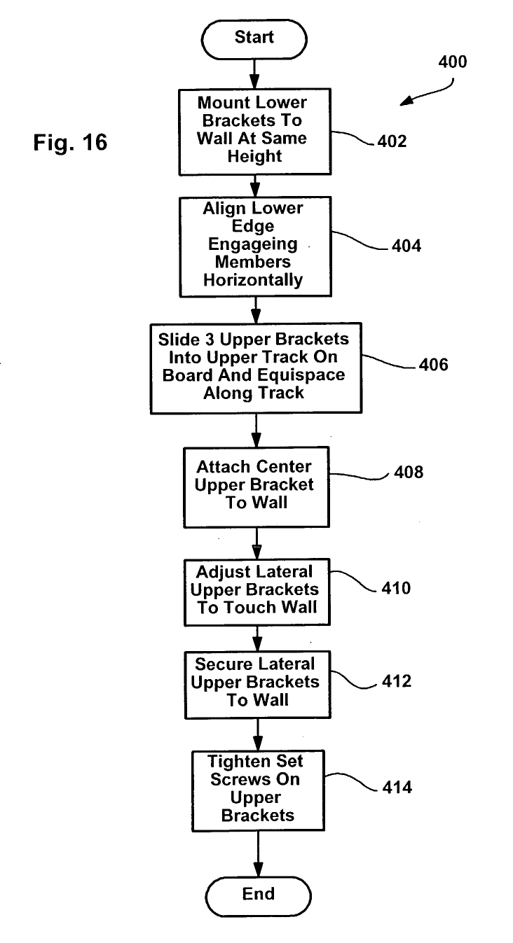

Referring now to FIGS. 2 and 4 through 8, the specially designed upper and lower bracket assemblies (e.g., 28 and 34) are employed to perform an inventive mounting method that generally ensures that an initially flat surface 20 will remain flat despite being anchored to a wall surface 85. To this end, referring also to FIG. 16, an inventive mounting method 400 is illustrated. Beginning at block 402, lower bracket assemblies 28, 30 and 32 are spaced apart along a wall surface 85 such that, subsequently, when lower edge member 26 is mounted thereto, central bracket assembly 30 will be generally positioned near the center of lower edge member 26 and lateral assemblies 28 and 32 will be positioned proximate the opposite ends of member 26 and so that, each of assemblies 28, 30 and 32 is at the same vertical height. After assemblies 28, 30 and 32 are mounted to surface 85, at block 404, each of adjustment members 72 (see FIG. 5) is adjusted so that the edge engaging members 108 that extend upwardly therefrom are aligned. This step can be performed by aligning one of adjustment members 72 such that the corresponding edge-engaging member 108 is essentially parallel with an adjacent part of surface 85, and then tightening the associated screws 76 and 78. For example, assembly 28 may be adjusted initially and the corresponding screws tightened. Next, a string is placed within the channel formed between members 110 and 108 on assembly 28 and then extended along the trajectory corresponding to the channel between members 110 and 108 in the direction of assembly 32. Each of assemblies 30 and 32 is then adjusted so that the string passes through the corresponding channel formed by corresponding members 110 and 108 on each of those assemblies. Once all of the adjustment member channels are aligned, screws 76 and 78 are tightened on each of assemblies 30 and 32. Note that at this point, despite any waviness in surface 85, all of the edge engaging members (e.g., 108) on each of assemblies 28, 30 and 32 will be completely aligned and therefore should not place any torque on a straight edge of a flat board received thereby.

Referring still to FIG. 16 and also to FIGS. 6 and 7, the next step 406 includes loosening screw 122 on each of upper bracket assemblies 34, 36 and 38 and sliding each of assemblies 34, 36 and 38 onto the end of upper edge member 24 so that the T-shaped extension 200 (see FIG. 7) is received between members 146, 168, 170, 116 and 150 and so that lower surface 192 of edge member 24 rests on upper surface 134 of base member 114. Assemblies 34, 36 and 38 are positioned along upper edge member 24 such that central assembly 36 is generally located centrally with respect to member 24 and so that each of lateral assemblies 34 and 38 is proximate an opposite end of member 24.

At block 408, center upper bracket assembly 36 is mounted to wall surface 85 generally vertically above central lower bracket assembly 30. At block 410, lateral upper bracket assemblies 34 and 38 are adjusted via adjustment screws 118 (see again FIG. 7) until the coplanar surfaces formed by first and fifth members 134 and 132 just touch the adjacent wall surface 85. Next, at block 412, the lateral upper brackets are secured to the wall surface 85. Additional tweaks can be made with adjustment screws 118 until the board is absolutely flat. At block 414, tightening screws 120 are tightened to lock the upper bracket assemblies in their specific configurations.

Thus, it should be appreciated that the bracket assemblies described above, when used in the described method, can be used to ridigly secure board member 22 to an uneven wall surface without placing torque on board 22 and hence without compromising the flatness of surface 20. Here, the adjustability of members 72 and 116 enable “flat” mounting on an uneven surface 85. In a more general sense, this aspect of the invention covers any method whereby one or more bracket assemblies are used to support a rigid whiteboard to an uneven surface such that the distance between a location on the board and an adjacent part of the uneven surface is fixed. Thereafter, an adjustable bracket assembly is secured to the location on the board and is adjusted until a mounting surface (e.g., the co-planar surface formed by members 124 and 132 in FIG. 7) of the bracket assembly is flush with the adjacent part of the uneven surface. Next the adjusted assembly is secured to the uneven wall surface.

After assemblies 34, 36, 38, 28, 30, and 32 have been adjusted and locked to secure the components in the manner described above, the other components illustrated in FIG. 2 may be secured or attached in any of several different manners to the upper and lower edge members 24 and 26, respectively, and to the lateral board edges 66 and 68. For example, referring again to FIGS. 2 and 7, upper header 48 can be attached to upper edge member 24 by placing lower edge 222 of member 218 in the channel 198 formed by members 196 and 194. Next a plurality of screws (not illustrated) can be driven through members 196, 218 and 194 to secure header 48. Referring to FIGS. 2 and 5, lower header 50 may also be mounted to the bottom end of edge member 26 via a plurality of screws. First and second lateral edge members 40 and 42 can be secured to adjacent edges 66 and 68 via a plurality of screws and then finishing members 44 and 46 can be secured to lateral edge members 40 and 42 via a plurality of screws.

Referring again to FIGS. 2 and 3, cable 52 can next be linked to laser control unit 998 and unit 998 can then be linked to laser sensor units 260 and 262 via cables 997 and 999 and to acoustic sensors 251 and 253 via cable 996 and each of module 54 and units 260 and 262 can be mounted as illustrated in FIG. 3. To this end, the plurality of screws (not labeled) are used to mount unit 54 within opening 238 in lower header 50 while a plurality of screws 91 (three associated with unit 260 labeled collectively by numeral 91) are used to mount each of units 260 and 262 in their respective upper header corners. In this regard, each of screws 91 in at least one embodiment, includes a spring between the unit (e.g., 260) and the surface of the header member to which the unit is to be mounted with the screw passing through the spring and received in a suitable threaded aperture. Thus, generally, the springs push the associated unit outward while the screws 91 force the unit inward against the springs and together the screws and springs can be used to alter the angle of the unit with respect to surface 20.

After the whiteboard components are assembled as described above, even if surface 20 is essentially completely flat, if laser units 260 and 262 are not properly aligned therewith so that the sensing plane (represented by lines 97) defined by units 260 and 262 is essentially parallel with surface 20, the system will not operate properly to sense all barcodes on instruments used with assembly 12. According to another aspect of the present invention, laser units 260 and 262 can be used to perform a method for rendering the sensing plane essentially parallel to flat surface 20. To this end, in at least one embodiment of the present invention, with laser units 260 and 262 activated, when door 216 is opened, instead of scanning surface 20 with infrared laser beams, each of units 260 and 262 generates a visible light laser beam and uses that laser beam to scan across surface 20. Because the beam generated by units 260 and 262 is visible, each of the beams forms a line of light on the surfaces 39, 40 and 42. In this regard see FIG. 28 which illustrates a lower right-hand cover of assembly 12 formed by surfaces 20, 39 and the internal surface of member 42 (see also FIG. 1). An exemplary light line 59 is shown in phantom that is generated on surface 39.

When a unit 260 or 262 is properly aligned with surface 20 so that the sensing plane is essentially completely parallel thereto at all points, the distance D3 between the line of light generated on surface 39 and surface 20 at all locations should be identical and should be equal to the distance between surface 20 and the point (emanating point) on the corresponding unit 260 or 262 from which the light emanates. Thus, for example, where the distance between surface 20 and the emanating point on unit 260 is 0.45 inches, light line 59 on measuring surface 39 should be 0.45 inches from surface 20 at all locations along the light line. Thus, each of the units 260 and 262 can be adjusted such that the distances described above are identical to ensure that the sensing plane is essentially parallel to surface 20. As best seen in FIG. 3, screws 91 can be used to adjust unit 260 and similar screws can be used to adjust unit 262.

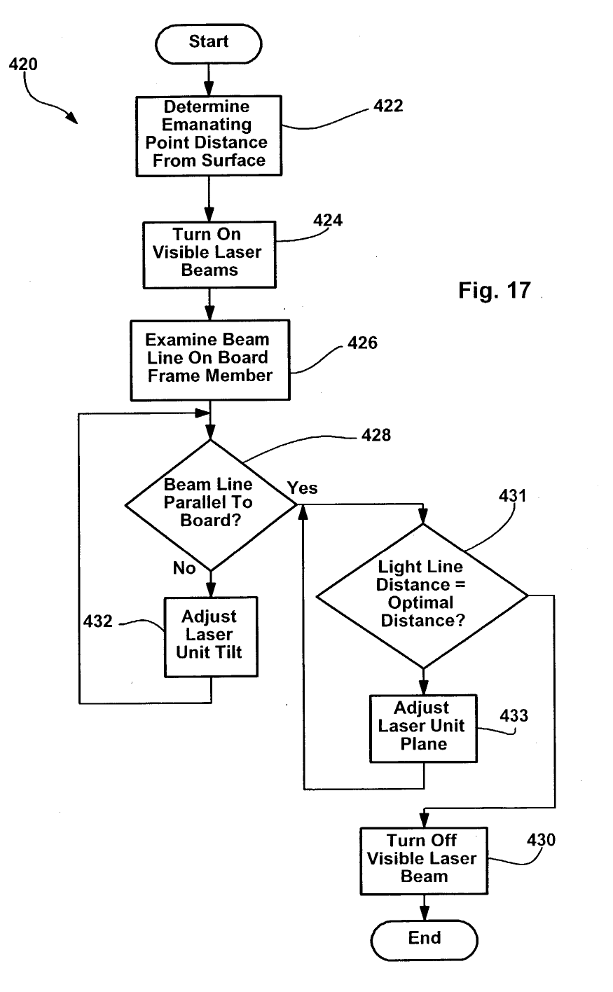

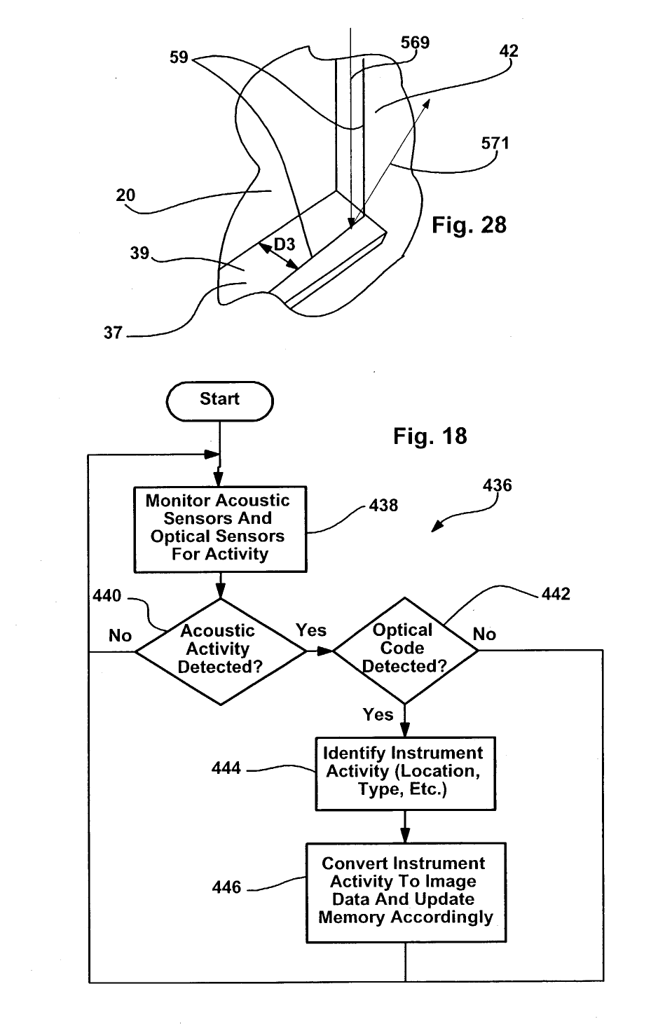

Referring now to FIG. 17, an exemplary laser aligning method 420 consistent with the discussion above is illustrated. Beginning at block 424, each of units 260 and 262 is controlled to generate a visible laser beam which scans across surface 20 and generates a light line or beam line on surface 39 facing units 260 and 262. Continuing, at block 426, the installer examines the beam line 59 on surface 39 and if the distance between source 20 and beam line 59 is identical along the entire beam line 59 for each of units 260 and 262 at block 428, the installer ends the aligning process. However, at block 428, where the distance between surface 20 and beam line 59 is not equal along the entire beam line, at block 432, the installer adjusts the tilt of laser units 260 and 262 (e.g., via screws 91) and the process loops back up to block 428. Next, at block 431 the distance between line 59 and the optimal distance 0.45″ are compared and, if the distances differ, at block 433, the installer adjusts the height of the laser units by turning all three adjustment screws 91 on each laser unit 260 and 262. This adjusting process is repeated until, at block 431, the distances are identical at which point the visible beams are turned off at block 430.

It should be appreciated that, while the aligning method is described as using surface 39, other surfaces may be employed to provide a similar effect. For instance, a simple flat member may be held against surface 20 and light line 59 to surface 20 measurements taken thereon.

C. Software-Related Methods

It has been recognized that, in the case of laser-sensing systems where a bar code sensing plane is separated from a writing surface (e.g., 0.45 inches), a coded instrument may be positioned and indeed moved with respect to surface 20 such that the instrument bar code is sensed within the sensing plane despite the fact that the instrument does not actually contact surface 20. This phenomenon is a common occurrence at the beginning and ending of a mark where a person using a marker may move the tip of the marker adjacent surface 20 prior to placing the tip on the surface or subsequent thereto. In these cases, the electronic version of a mark may include tail ends at the beginning and end of the mark.

Referring again to FIG. 3, according to one aspect of the invention, acoustic sensors 252 and 254 are used to determine when an instrument contacts surface 20. Referring also to FIG. 9, in some embodiments, processor 240 is programmed to record marks in the electronic version of an image only while an instrument is in contact with surface 20. Thus, for instance, in some cases, after units 260 and 262 provide position/instrument information to processor 240, processor 240 monitors acoustic sensors 252 and 254 to determine if an instrument touches surface 20 and only affects changes to the stored image when contact is made with surface 20 and signals from units 260 and 262 indicate instrument presence.

Referring now to FIG. 18, a method 436 consistent with the comments above wherein both acoustic sensors 251 and 253 and laser sensors 260 and 262 are used to determine when and what type of instrument activity occurs is illustrated. Referring also to FIGS. 3 and 9, with processor 240 activated, processor 240 monitors signals from each of acoustic sensors 251 and 253 and laser units 260 and 262 at block 438 to determine if any of the sensors is sensing activity. Here, as described above, when any type of instrument penetrates the sensing plane, units 260 and 262 sense activity and provide corresponding real time signals to processor 240. In addition, whenever any instrument touches surface 20, at least one of acoustic sensors 251 and 253 senses the contact and provides corresponding signals to processor 240 indicating that contact has occurred. At block 440, if acoustic activity is not detected, processor 240 control loops back up to block 438 where monitoring for activity continues. If, however, acoustic activity is detected at block 440, control passes to block 442 where processor 240 determines whether or not an optical code has been detected within the sensing plane by at least one of units 260 and 262. Where no optical code has been detected, control passes from block 242 back up to block 438 where the monitoring process is continued.

Referring again to block 442, where an optical code is detected, control passes to block 444 where processor 240 identifies the exact type of instrument activity including the location at which the contact was made, the type of instrument, instrument characteristics, etc. At block 446, processor 240 converts the identified instrument activity to electronic data and updates the electronic version of the written information in memory 241. After block 446, control again passes back up to block 438, where monitoring is continued.

In addition to performing the functions above (e.g., confirming surface contact and activating the system 10), acoustic sensors 251 and 253 may also, where spatially separated, be able to provide additional information for confirming the location of activity on surface 20. Thus, the system processor 240 may be programmed to use acoustic signals to determine the general region on surface 20 at which activity occurs.

It has been observed that the combined acoustic-laser sensor system described above works extremely well to reduce the instances during which unintended activity is captured and recorded by processor 240. Nevertheless, it should be appreciated that other sensor combinations including laser sensors and some other sensor type for detecting contact may provide similar functionality. For instance, in another embodiment, laser sensors may be combined with a touch sensitive pad/surface 20 to sense instrument activity. Here, the touch sensitivity pad can be of a relatively inexpensive design as the pad need not be able to determine contact location but rather that contact occurred.

Under certain circumstances, a system user may interact with surface 20 in a way that will cause the electronic version of written information stored in memory 241 to be different than the information displayed on surface 20. For example, assume a system user uses a suitably bar-coded real ink pen instrument to provide written information on surface 20. In this case, processor 240 stores an electronic version of the written information provided on surface 20 in memory 241 (see again FIG. 9). If, after information has been provided on surface 20, the user uses a rag or some other non-bar-coded instrument to erase some of the information on surface 20, because processor 240 cannot determine the type of instrument used (i.e., the rag or other instrument is not bar-coded), processor 240 cannot sense that information has been erased from surface 20 and therefore does not update the electronic version of written information in temporary memory 241.

Under the circumstances described above, it is possible that written information could remain in memory 241 despite the fact that a non-bar-coded instrument (e.g., a rag) has been used to completely clear surface 20. Here, unknowingly, a system user may apply additional written information on surface 20 which is recorded in memory 241 over the other information that already exists in memory 241. Thereafter, if the user instructs processor 240 (e.g. by selecting website/archive button 332) to store written information currently displayed on surface 20 to archive memory 243, processor 240 will write the written information from temporary memory 241 into archive memory 243. Thus, unknown to the system user, the combined previously erased written information and most recently provided written information on surface 20 is stored to memory 243 as opposed to only the current information on surface 20.

According to one other aspect of the present invention, referring to FIG. 15, start button 316 and associated LEDs 332 and 334 are provided which, together, facilitate two functions. First, LEDs 332 and 334 are provided to indicate to a system user when temporary memory 241 is clear and when at least some written information is stored in memory 241. To this end, when temporary memory 241 is completely blank, LED 332 is illuminated to indicate that assembly 12 is ready to receive new information. When LED 334 is illuminated, LED 334 indicates that memory 241 includes at least some information. Thus, after a system user uses a non-bar coded instrument to erase all of the information on surface 20, despite the fact that there is no information on surface 20, in-use LED 334 will remain illuminated to indicate that there is a discrepancy between the written information in memory 241 and the information on surface 20. On the other hand, if a system user uses a bar-coded eraser to remove all of the written information on surface 20, all of the written information in temporary memory 241 should be removed, and in that case, ready LED 332 is illuminated and LED 334 is deactivated.

Unfortunately, in the case where a non-bar coded instrument is used to erase all information on surface 20, it becomes difficult for a system user to identify the locations on surface 20 corresponding to the written information that remains in temporary memory 241. Here, to completely clear the memory 241 using a bar-coded eraser, the system user would have to methodically start in one location on surface 20 and move the eraser around in a “blind” fashion until memory 241 is cleared. To avoid this problem, according to one aspect of the invention, start button 316 can be activated to automatically clear all of memory 241.

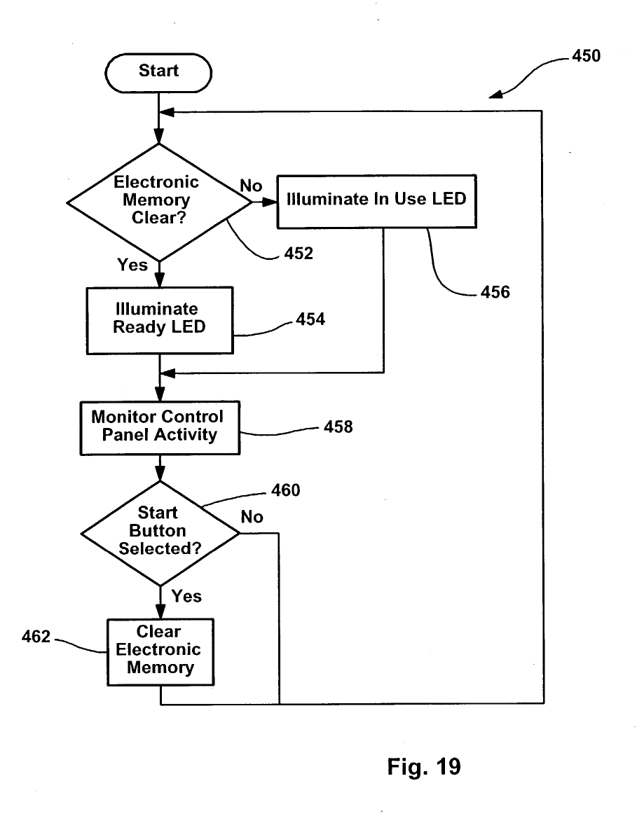

Referring now to FIG. 19, a method 450 for indicating the status of temporary memory 241 and for clearing memory 241 via start button 316 is illustrated. Referring also FIGS. 9 and 15, at block 452, processor 240 monitors electronic memory 241. Where memory 241 is clear, control passes to block 456 where ready LED 332 is illuminated. Where memory 241 is not clear at block 452, control passes to block 454 where in use LED 334 is illuminated. After each of blocks 454 and 456, control passes to block 458. At block 458, processor 240 monitors control panel 310 (see again FIG. 15). At block 460, where start button 316 is activated, control passes to block 462 where electronic memory 241 is cleared. After block 462, control passes back up to block 452 where the loop is repeated. Referring again to block 460, where start button 316 is not activated, control loops back to block 452 where the illustrated steps are repeated.

In addition to the circumstances described above that result in infidelity between the information on surface 20 and in memory 241, other circumstances may have similar consequences. For example, a system user may use a non-bar-coded pen to add information to surface 20 such that information on surface 20 is different than written information in temporary memory 241. Moreover, a user may use a non-bar-coded instrument such as a rag to erase a portion of the written information on surface 20 such that the written information in memory 241 is different than the information on surface 20.

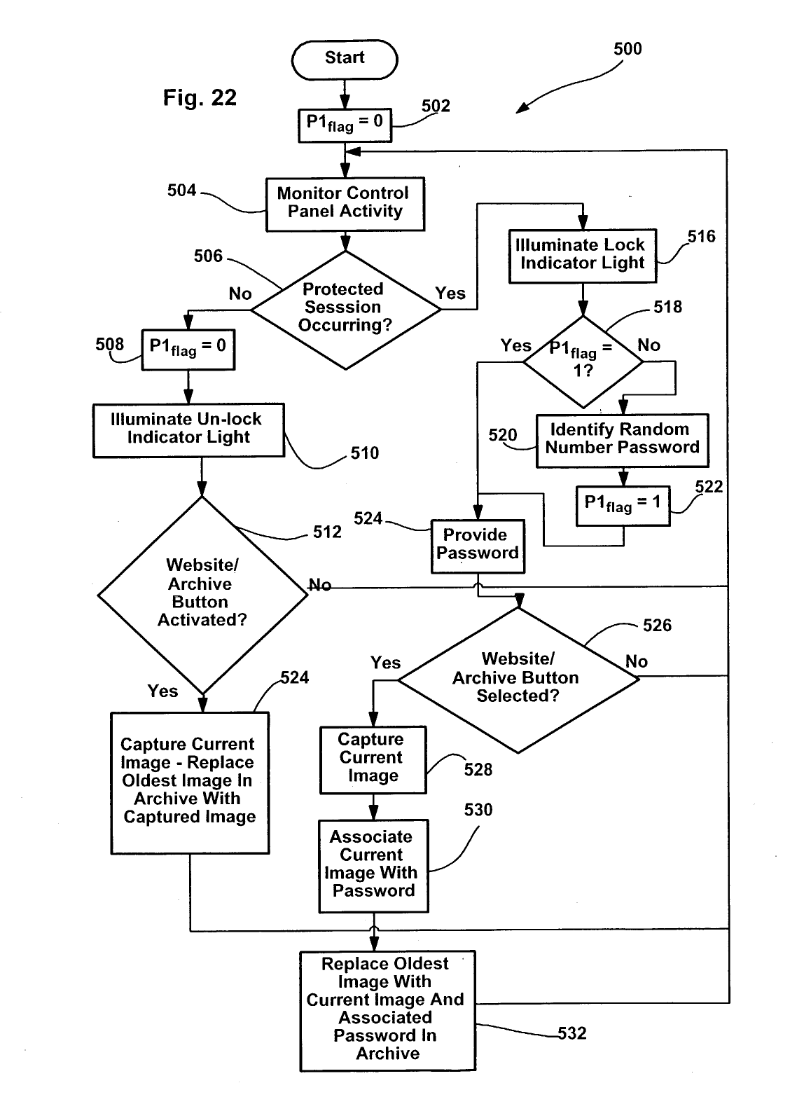

According to at least one additional embodiment in the invention, referring to FIG. 21, an additional “acknowledge” button 369 and an associated warning indicator LED 371 may be provided that can be used to indicate when a potential discrepancy like the discrepancies previously described has occurred. To this end, whenever acoustic instrument activity on surface 20 is detected but no optical code is detected, there is a chance that a discrepancy exists between the displayed written information and the stored written information. Thus, any time acoustic activity corresponding to contact with surface 20 (as opposed to general room noise) is detected and no code is detected, processor 240 illuminates LED 371 to indicate a potential discrepancy. Once illuminated, LED 371 remains illuminated until acknowledge button 369 is selected (e.g., the system user affirmatively acknowledges that surface memory infidelity may exist).

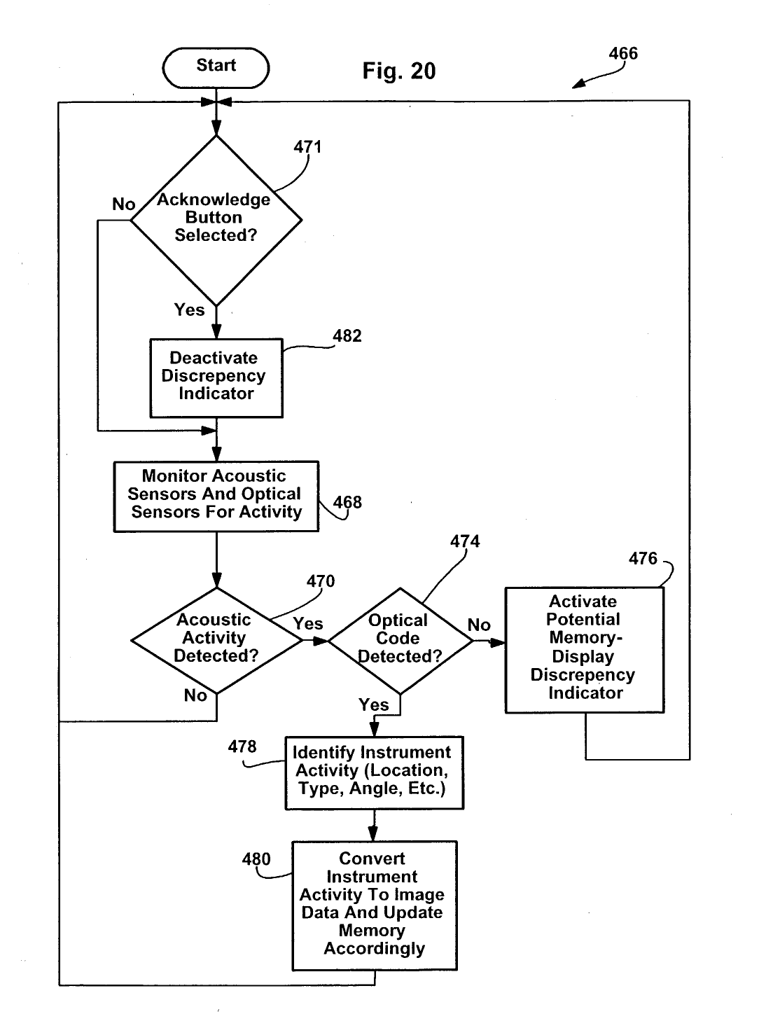

Referring to FIG. 20, an exemplary method 466 for identifying and reporting a discrepancy is illustrated. Blocks 471 and 482 will be described below. Referring also to FIGS. 3 and 9, at block 468, processor 240 monitors signals from both laser units 260 and 262 and acoustic sensors 251 and 253. At block 470, processor 240 determines whether or not acoustic activity has been detected. Where no acoustic activity has been detected, control passes back up to block 468. At block 470, once acoustic activity has been detected, control passes to block 474 where processor 240 determines whether or not an optical code has been detected. Where no optical code is detected at block 474, control passes to block 476 where processor 240 activates the memory-display discrepancy LED 371. Thus, when a non-bar-coded eraser, pen, or other instrument contacts surface 20 and is sensed by acoustic sensors 251 and 253 at block 470 but no optical code is detected at block 474, the potential for a memory-display discrepancy is sensed and LED 371 is activated. After block 476 control loops back up to block 471. At decision block 471, processor 240 monitors button 369 for selection. Where button 369 is not selected, control passes back to block 468 and LED 371 remains illuminated. Where button 369 is selected to acknowledge potential surface-memory infidelity, control passes to block 482 where LED 371 is deactivated. After block 482 control passes to block 468.

Referring again to block 474, if an optical code is detected, control passes to block 478 where instrument activity is identified. At block 480 instrument activity is converted to electronic written information and used to update memory 241. After block 480, control passes to block 471 where the loop is repeated.

According to yet another aspect of the present invention, it has been recognized that, in at least some cases, a system user may want to store images of the information (written and/or projected) currently displayed on surface 20 in a secure fashion so that, where the user and perhaps others may want to subsequently access the images, at least some level of security can be provided to keep unintended viewers from accessing the images. To this end, referring again to FIG. 15, according to at least some embodiments of the present invention, password protect button 315 can be used to generate a begin subset command or a begin restrict command to indicate when information displayed on surface 20 should be protected and to indicate when the information should be stored in an unprotected fashion. When displayed information that is to be stored in archive memory 243 is not to be protected, LED 372 that corresponds to the unlocked padlock indicia there above is illuminated. Similarly, when displayed information to be stored to memory 243 is to be protected, LED 374 corresponding to the locked padlock indicia there above is illuminated. Button 315 is selectable to switch the states of LEDs 372 and 374 and thereby to indicate to both a system user and processor 240 whether or not information archived thereafter should be password protected or not. Additionally, when button 315 is selected to illuminate LED 374, processor 240 provides a random password or access number via readout 324. In at least some embodiments, the access number provided in readout 324 is a random four-digit number. Alternatively, the password may be provided audibly so that the added expense of readout 324 can be avoided. Moreover, in some embodiments a system user may be required to provide a preferred password via interaction with surface 20 or via a linked computer 16.

While LED 374 is illuminated, any time website/archive button 322 is selected, an image of the information displayed on surface 20 is stored in semi-permanent memory 243. Thus, where both projected information and written information (e.g., information from each of memories 242 and 241, respectively) are displayed on surface 20, when button 322 is selected, the information is combined and an image of the combined information is stored in memory 243.

Until button 315 is selected a second time to generate an end subset or end restrict command, LED 374 remains illuminated and each time button 322 is selected to store displayed information, the information is stored to the file or image set associated with the most recently generated password. Thus, while LED 374 remains activated, if button 322 is selected seven different times for seven different sets of information displayed on surface 20, each of the seven sets of information is stored as a separate image in a file associated with the most recent password in memory 243. In at least some embodiments, processor 240 continues to provide the access number via readout 324 until button 315 is selected a second time. Once button 315 is selected a second time, LED 374 is deactivated and LED 372 is illuminated after which time, until button 315 is again activated, any information stored by selecting button 322 is stored in archive memory 243 as unprotected (e.g., can be accessed without requiring an access number or password). In at least some other systems processor 240 may be programmed to clear the password from readout 324 after a period (e.g., 2 minutes) or after a period of inactivity (i.e., no acoustic, writing or button selection activity). Hereinafter the portion of a whiteboard session that occurs between the time button 315 is selected to obtain a password via readout 324 and the time button 315 is next selected to indicate that the next archived information should not be password protected will be referred to as a “protected session” the file of images associated therewith will be referred to as a “session file” or image subset and a password will be referred to as a session password or a subset password.

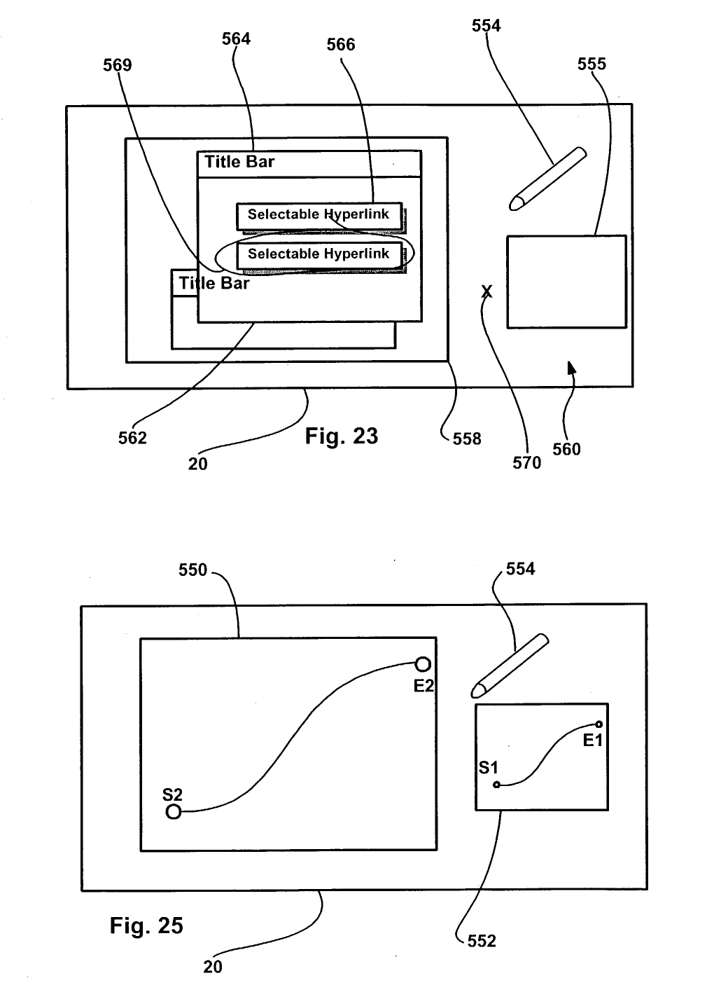

Referring now to FIG. 22, a method 500 for facilitating the password protect functions described above is illustrated. Referring also to FIGS. 9 and 15, at block 502 processor 240 sets a flag P1_{flag} equal to zero. Flag P1_{flag} is a flag used to indicate when a password has already been assigned for a current protected session. When flag P1_{flag} is equal to zero, a password has not been assigned and, w hen flag P1_{flag} is equal to on e, a password has been assigned.

Continuing, at block 504, processor 240 monitors control panel 310 activity. At block 506, processor 240 determines whether or not the password protect feature has been activated (e.g., whether or not password protect button 315 has been selected). Where the password protect feature has not been activated, control passes to block 508 where flag P1_{flag} is again set equal to zero. At block 510, processor 240 illuminates the unlocked indicator LED 372. Next, at block 512, processor 240 determines whether or not website/archive button 322 has been selected. When archive button 322 has not been activated, control passes back up to block 504 where the loop is repeated.

Referring again to block 512, when archive button 322 has been activated, control passes to block 514 where processor 240 captures the information currently displayed on surface 20 by writing information from one or both of temporary memories 241 and 242 to archive memory 243. This is accomplished by replacing the oldest image in memory 243 with the captured image. After block 514, control passes back up to block 504 where the loop is repeated.

Referring once again to block 506 in FIG. 22, where the password protect feature has been activated, control passes to block 516. At block 516, processor 240 illuminates lock LED 374 and control passes to decision block 518. At block 518, processor 240 determines whether or not flag P1_{flag} is equal to one. Where flag P1_{flag} is not equal to one (i.e., is equal to zero), a random or password is generated by processor 240 and is presented via readout 324. At this point or at any time during the protected session, observers can write down or otherwise note the password to enable subsequent access. Continuing, at block 522, flag P1_{flag} is set equal to one to indicate that a random number has been assigned corresponding to the current password protect session. After block 522, control passes to block 524 where the password is provided.

Referring once again to block 518, where flag P1_{flag} is equal to one and hence a random number for the current protected session has been assigned, control passes to block 524 where the password is provided via readout 324. After block 524, control passes to block 526 where processor 240 determines whether or not website/archive button 322 has been selected. Where button 322 has not been selected, control passes back up to block 504 and the loop is repeated. At block 526, where archive button 322 has been selected, control passes to block 528 where the currently displayed information on surface 20 is captured by processor 240. At block 530, the captured information is associated with the current password and at block 532 the captured image and password are stored in semi-permanent memory 243. After block 532, control again passes back up to block 504. Thus, eventually, when password protect button 315 is selected a second time to end a protected session, at block 506, control passes to block 508 where flag P1_{flag} is again set equal to zero.

Referring again to FIG. 15, source buttons 326 and 328 are useable to select the source of images projected onto surface 20. In this regard, when archive button 326 is selected and associated LED 380 is illuminated, the projection source is archive memory 243 (see again FIG. 9) via processor 240 and when laptop button 328 is selected and LED 382 is illuminated, the projection source is a computer 16 linked to processor 240 so that whatever is displayed on the computer screen shows up on surface 20. Here, one additional way to access images in archive 243 is to select laptop computer 16 as the projection source and link computer 16 to processor 240 via a network link to obtain an image from source 243.

Referring once again to FIGS. 1 and 3, when a system user employs system 10 to project images on surface corresponding to software running on computer 16, often the user wants to be able to interact with the software to facilitate application features. For instance, a user may display an Internet browser image on surface 20 where the image includes hyperlinks to other Internet pages. Here, the user may want to be able to select hyperlink text to access additional related information. One way to select links is to use a mouse controlled cursor on the computer screen to select a link. Unfortunately, this action typically requires the system user to leave a position near board assembly 12 to access and control the computer.

According to one other aspect of the invention, a bar coded stylus type instrument is provided to allow a system user to, in effect, move a cursor on the screen of a computer 16 linked to processor 240 via instrument activity on surface 20. According to one aspect, the stylus can be used on a projected image to move a cursor in an absolute fashion on surface 20. For instance, the user may contact the stylus to surface 20 on hyperlink text thereby causing a cursor on the computer screen to likewise select the hyperlink text. As another example, where the displayed image includes various windows where each window has a title bar and is associated with a different software application running on computer 16, the stylus may be contacted to one of the title bars and dragged along surface 20 to move the corresponding window on the computer screen and on surface 20. Thus, in at least one embodiment, the stylus is useable as an absolute position cursor controller.

While the absolute position cursor control system described above is advantageous, it has been recognized that such a system has at least one shortcoming. Specifically, to use the system described above, the user has to be positioned between projector 14 and surface 20 and therefore casts a shadow on surface 20 in which no information can be displayed. In addition, the user's presence in front of surface 20 obstructs the views of the audience.

According to another aspect of the invention, system 10 can be placed in a mode of operation where surface 20 is divided into at least two areas including a “projection area” and at least one “control area”. In this case, stylus activity in the control area is sensed by processor 240 which projects a cursor onto the projection area that moves on the projection area in a relative fashion.

Referring now to FIG. 23, surface 20 is divided into a projection area 558 and a control area 560. In FIG. 23, system 10 is used to project a large-scale image of a “current” display screen of computer 16 (see FIG. 1). The aspect ratio of the projected image on the computer screen display is essentially the same as the aspect ratio of the computer display screen itself. In the illustrated projected image, an application window 562 is projected which includes a title bar 564 and several selectable icons 566 (only one numbered) (other selectable icons may also be included in window 562) that are selectable to cause the associated application to perform some function (e.g., a hyperlink, a print function, etc.).

With the computer display screen projected in projection area 558, if a stylus is used to make contact with surface 20 in control area 560 outside projection area 558 (e.g., at the location labeled 570) a cursor on the display screen of computer 16 becomes active but does not initially change its position on the computer screen. In other words, there is not a proportional relationship between the position of the stylus on surface 20 of the whiteboard and the position of the cursor (at this point in time) on the display screen of the computer. Note that the aspect ratio of the display surface of the whiteboard is actually quite different from that of the computer display screen. Accordingly it would not normally be appropriate to cause the action which has just been described to produce a positionally proportional displacement of the cursor on the computer screen just by the simple act of touching the stylus to a point outside the projection area on surface 20.

However, while the stylus is maintaining contact with surface 20, in at least some embodiments of the present invention, motion of the stylus within control area 560 produces proportionally related and pictorially similar motion of the cursor on the computer screen and hence on the projected image in area 558. While this motional relationship is in fact somewhat proportional, the positional relationship of the point of contact of the stylus on surface 20 and that of the cursor on the display screen of computer 16 are not coordinately proportionate and are not locked to each other. Thus, movement of the stylus in control area 560 operates in a similar fashion to movement of a mouse on a mouse pad in a conventional computer setting.

In either of the merged or separate modes described above, processor 240 may be programmed to recognize specific stylus activity as being related to conventional mouse actions. For instance, a single stylus tap on surface 20 may be recognized as a mouse click activity, a rapid double tap may be recognized s a double click, holding a stylus down for one second and lifting may be recognized as a right click, as indicated above, stylus movement after clicking may be recognized as a dragging activity, etc.

In at least some embodiments of the invention there are two different selectable modes of operation including a “merged mode” and a “separate mode”. Referring again to FIG. 23, when in the merged mode, processor 240 performs absolute positioning within projection space 558 and performs relative positioning in all space on surface 20 outside projection space 558. In addition, when the merged mode is selected, any ink information and projected information on surface 20 is merged into a single image when captured (e.g., stored, printed, etc.). Here switching between relative and absolute positioning when an instrument is moved from outside to inside area 558 and vice versa is automatic.

When in the separate mode, processor 240 performs relative positioning of a cursor or the like in area 558 regardless of where the instrument is used to contact the surface 20 thus, even stylus movement within space 558 results in relative movement of a cursor within space 558. Here when the separate mode is selected, any ink information and projected information on surface 20 is captured separately for storage and printing. While captured separately, the information is still correlated so that it can subsequently be viewed together. Here, projected information can be captured separately by using processor 240 to intercept the video going to the projector.

Referring again to FIG. 15, panel 310 includes mode button 330 which is provided in at least some applications to enable a system user to select between either the merged mode of operation where stylus location on surface 20 controls the absolute position of a projected cursor inside the projected image and the relative position outside the projected image and the separate mode of operation where stylus location controls cursor position everywhere on surface 20 in a relative fashion. Button 330 is a toggle button such that selection thereof changes the current mode to the other mode. LEDs 384 and 386 indicate which of the merged and separate modes is currently active.

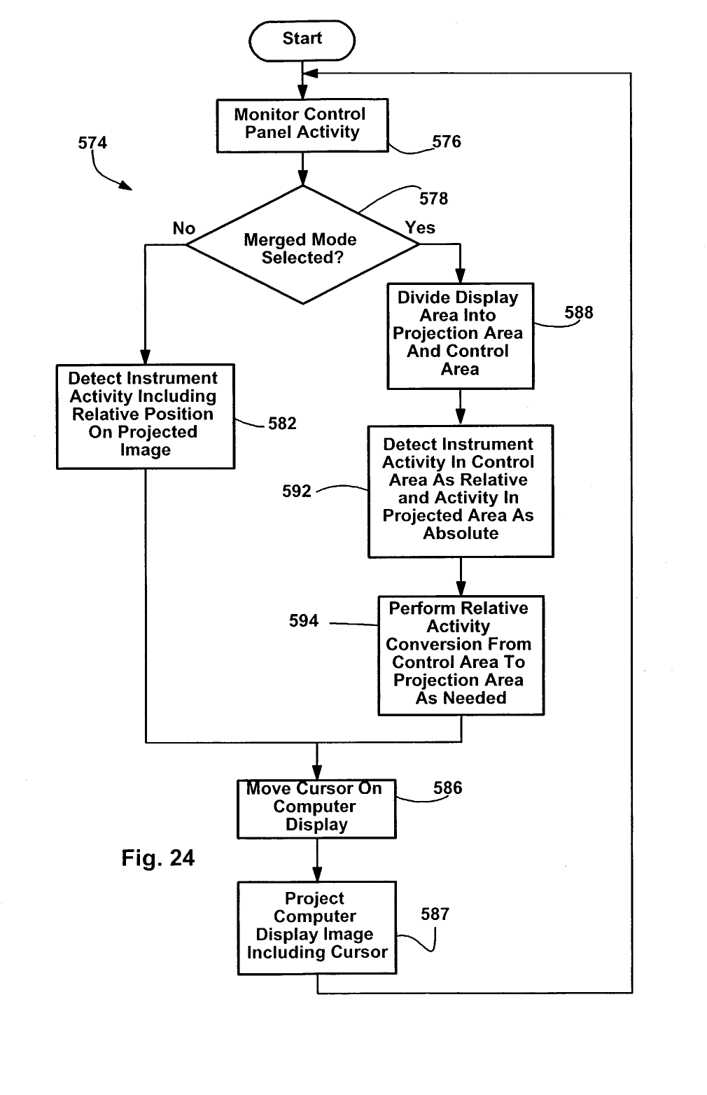

Referring now to FIG. 24, an exemplary method 574 for facilitating the merged and separate modes of operation is illustrated. Referring also to FIGS. 9 and 15, at block 576, processor 240 monitors control panel 310 activity. At block 578, processor 240 determines the current mode setting (e.g., merged or separate). Where the merged mode is active, control passes to block 580 where processor 240 divides surface 20 into a projection area and a control area (see again 558 and 560 in FIG. 23). Next, at block 592, processor 240 detects instrument activity in control area 560 as relative and instrument activity in projection area 558 as absolute. Continuing, at block 594, processor 240 performs relative activity conversion from the control area to the projection area as needed. At block 586, processor 240 causes computer 16 to alter the cursor location on the computer display to reflect the relative movement of the stylus. At block 587 controller 240 causes the projector to project the computer image including the newly positioned cursor on surface 20. After block 587, control loops back up to block 576 where the process described above is repeated. Again, here, when the process loops through step 587 a next time, cursor movement on the computer display is reflected in the image projected on surface 20.

Referring still to FIG. 24, at decision block 578, where the separate mode is active control passes to block 582. At block 582, processor 240 detects relative stylus activity at all locations on surface 20. At block 586, processor 240 cooperates with computer 16 linked thereto to move the mouse type cursor on the computer screen to the position corresponding to the relative position of the stylus on surface 20. At block 587 controller 240 causes the projector to project the computer image including the newly positioned cursor on surface 20. Next, control loops back up to block 576 where the process is repeated. Note that the next time through step 580 when the computer-displayed image is projected onto surface 20, the new cursor position on the computer display is projected as part of the projected image. The process of FIG. 24 is extremely fast and therefore a real time cursor movement affect occurs.

In addition, although not illustrated, in at least some embodiments, control areas like area 552 may be provided on either side of projection area 550 so that, regardless of which side of area 550 a user is on, the user can quickly access a control area to affect the projected cursor position.

Referring again to FIG. 23, one other way in which processor 240 (see again FIG. 9) can be used to move a mouse type cursor about a projection area 558 is by defining a control area 555 that has a shape similar to that of the projection area 558 and placing a projected cursor in area 558 in the same relative location to area 558 that the stylus has with respect to the control area 555. Thus, for instance, if the stylus is used to select the upper right-hand corner of control area 555, the cursor (not illustrated) would be projected at the upper right hand corner of projection area 558.

In addition to being able to control a mouse type cursor in either merged or separate fashions, in some embodiments a pen-coded instrument may be used to place written information (e.g., circle a figure or a number) in projection area 558 in either a merged or separate fashion. When an image corresponding to a computer displayed image is projected onto surface 20, a pen can be used to provide written information within the projection area as described above. Thus, for instance, a system user may place a mark 569 around one of the hyperlink phrases as illustrated in FIG. 23 to highlight or otherwise annotate some part of the projected image. If the pen is properly coded (e.g., bar coded), pen activity is sensed and stored in memory 241.

Referring now to FIG. 25, surface 20 is illustrated where surface 20 has been divided into a relatively large projection area 555 and a smaller similarly shaped rectilinear control area 552. A pen 554 is illustrated which is used within area 552 to form a curved line by placing the pen tip at a start point S1 and moving the tip to form the curve to an end point E1. As the pen tip is moved between points S1 and E1, referring once again to FIG. 9, processor 240 identifies the pen activity including pen type, color, thickness, etc., proportionally scales the movements to a larger relative size corresponding to the dimensions of projection area 550 and, essentially in real time, controls projector 14 to project the curve illustrated in area 550 starting at start point S2 and ending at end point E2. Thus, a system user can stand in front of control area 552 where the user does not obstruct either a direct line of sight from projector 14 to projection area 550 or the views of an audience and can modify written information within area 550.

Referring yet again to FIG. 25, while the divided surface 20 concept described above is described in the context of a virtual ink pen, it should be appreciated that, in at least some embodiments of the invention, a real ink pen may be used to provide information in control area 552 thereby causing virtual projected information to be projected in space 550. Thus, for example, when the curve illustrated in space 552 is formed with a real ink pen, the system 10 would generate the projected curve illustrated in space 550 which may aid visibility.

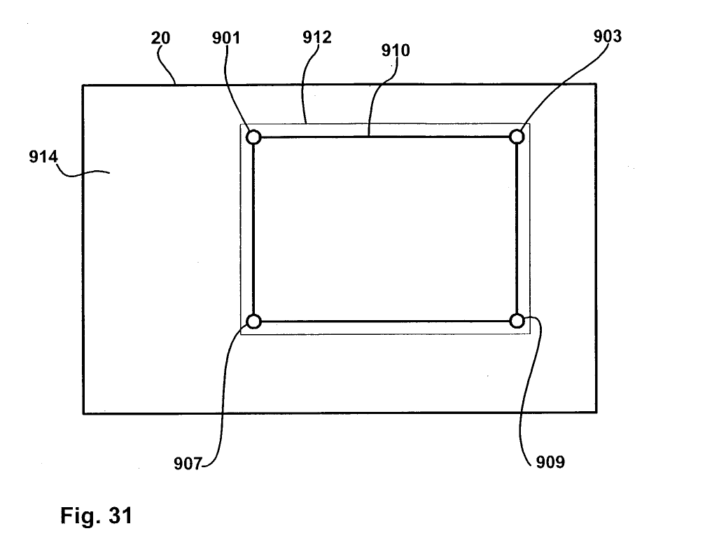

According to another aspect of the invention a system user may be required, in at least some embodiment, to help calibrate the system 10 to enable the system to distinguish between the projection and control areas and so that cursor location relative to projection information in the projection area can be determined. To this end, according to at least one calibration method, if the system has not been previously calibrated, processor 240 may run a calibration routine including, referring to FIG. 31, projecting alignment marks 901, 903, 907 and 909 at the four corners of a projected image along with, in some embodiments, instructions (not illustrated) instructing a user to use a stylus of some type to select the four marks. When the four marks are selected, the selected locations on screen 20 are correlated with the corners of the projected image and all activities that occur within the associated projection area 910 are scaled accordingly. By default space outside area 910 is designated a control area 914.

Referring still to FIG. 31, in at least some embodiments, when a projection area 910 is designated during calibration, a buffer zone 912 or area that includes a border (e.g., 103 inches wide) about the projection area is identified by processor 240 where absolute cursor positioning is supported despite the fact that the buffer area resides outside the projected area. In this case, for instance, when system 10 is in the merged mode, any cursor activity within buffer zone 912 causes absolute cursor positioning therein so that, when a user uses a stylus to designate a position near the edge of projection are 910, the cursor control does not inadvertently toggle between absolute and relative positioning.

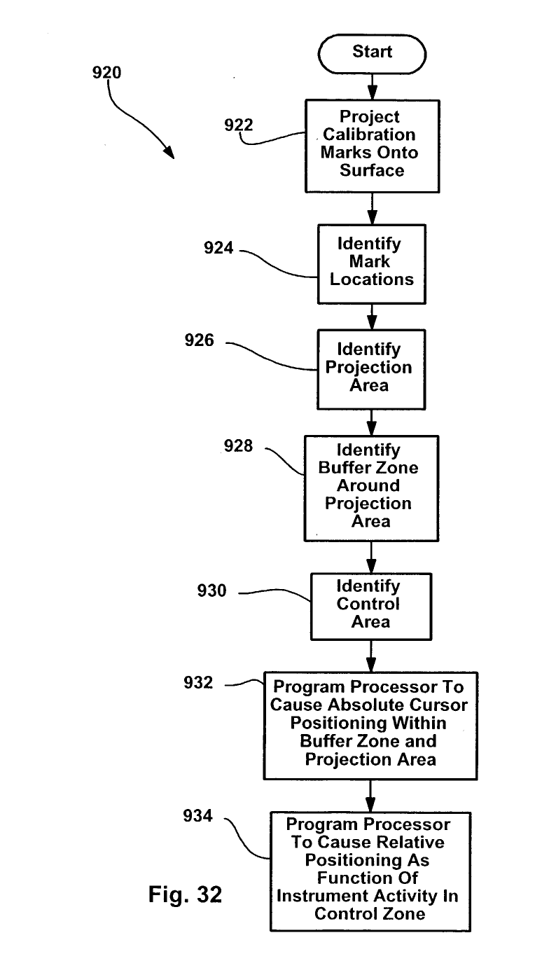

Referring now to FIG. 32, a calibration method 920 according to one aspect of the present invention is illustrated. Referring also to FIGS. 9 and 31, at block 922 processor 240 begins a calibration process by projecting marks 901, 903, 907 and 909 onto surface 20. At block 924 a system user uses a stylus to physically identify the locations of the four projected marks. At block 926 processor 240 identifies the projected area 910 associated with the selected locations. At block 928 processor 240 identifies the buffer zone 912 about area 910 and identifies the control area 914 at block 930. At block 932 processor 240 configures to cause absolute cursor positioning within the buffer zone and the projection area and at block 934 processor 240 configures to cause relative cursor positioning in zone 910 as a function of instrument activity within control zone 934 when the system is in the merged mode.

In at least one embodiment of the invention, to access archived images, a computer 16 (see again FIG. 1) is required. To display an image, a user may use laptop (e.g., 16) or another computer (e.g., a computer in another physical location and on a linked network) to access the system website operated by server processor 240. Thereafter, processor 240 causes thumbnail icons corresponding to each stored image and/or session file to be displayed on the computer screen. In some embodiments the icons corresponding to protected session files appear as locked pad-lock icons. The user can select any of the icons via the computer. When an unlocked icon is selected, processor 240 provides the corresponding image to computer 16 for display. When a locked icon corresponding to a protected session file is selected, computer 16 provides a field for entering the password and may provide suitable instructions for entering the password. If a password is received and is correct, processor 240 provides the first image in the session file to computer 16 and computer 16 displays the selected image.

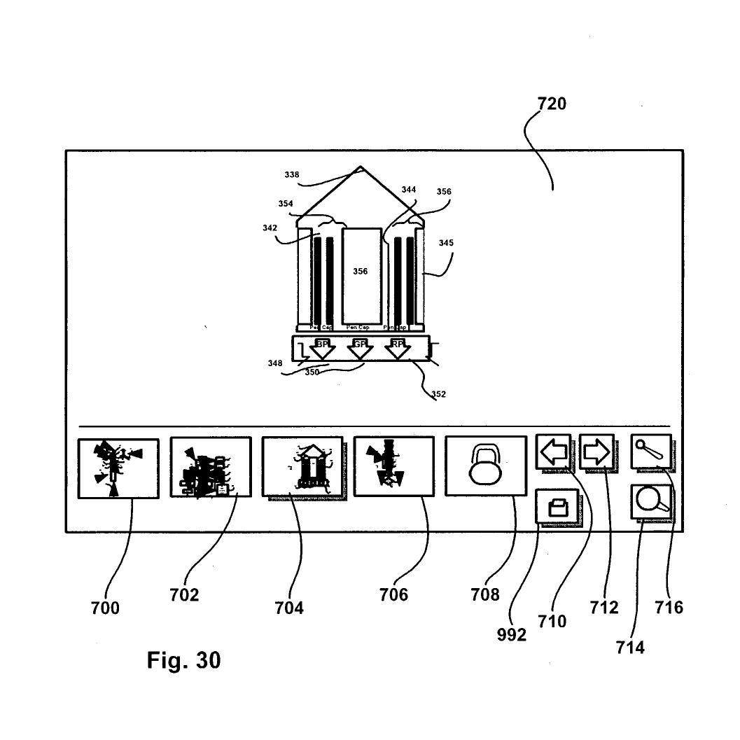

One other way to access and review archived images is to use a laptop 16 that is linked to processor 240 for projecting computer displayed images onto surface 240. In this case, with laptop 16 linked to module 240, laptop button 328 is selected and LED 382 is illuminated to indicate that the projection source is computer 16. Here, the process of accessing archived images is essentially identical to the process described. The only difference here is that the computer-displayed information is projected onto surface 20 and hence, when a projected image is viewed via the computer screen, the image is also viewable via surface 20.

Where a user wants to view unprotected images, in at least some embodiments, a computer 16 is not required. Instead, referring again to FIG. 15 and also to FIG. 30, when archive button 326 is selected, built-in software in processor 240 provides on-screen (i.e., on surface 20) tools that enable the user to scroll, select and zoom in and out on captured images using a stylus as a mouse. Here, generally, the software may provide thumbnail sketches 700, 702, 704, 706 of the unprotected images and pad-lock icons 708 (only one shown) for the protected images along with scrolling arrows icons 710 and 712, zooming icons 714 and 716 and a print icon 992. A stylus can then be used to select any of the thumbnail icons to display the corresponding image in a large display area 720 or to select one of the tool icons to alter display of an image or to cause a print function to occur.

When a pad lock icon 708 is selected, in some embodiments, processor 240 will issue a message indicating that a computer (e.g., 16 in FIG. 1) is required to access the associated session file. To enable a user to access protected images in a session file without requiring an additional interface (e.g., computer 16), in some embodiments, after archive button 326 is selected and after a locked icon is selected, processor 240 may be programmed to project a password field onto the surface 20 along with a virtual keypad including numbers (and/or letters) and an enter button. Thereafter when a suitable password is entered, processor 240 may be programmed to enable access to the corresponding session file.

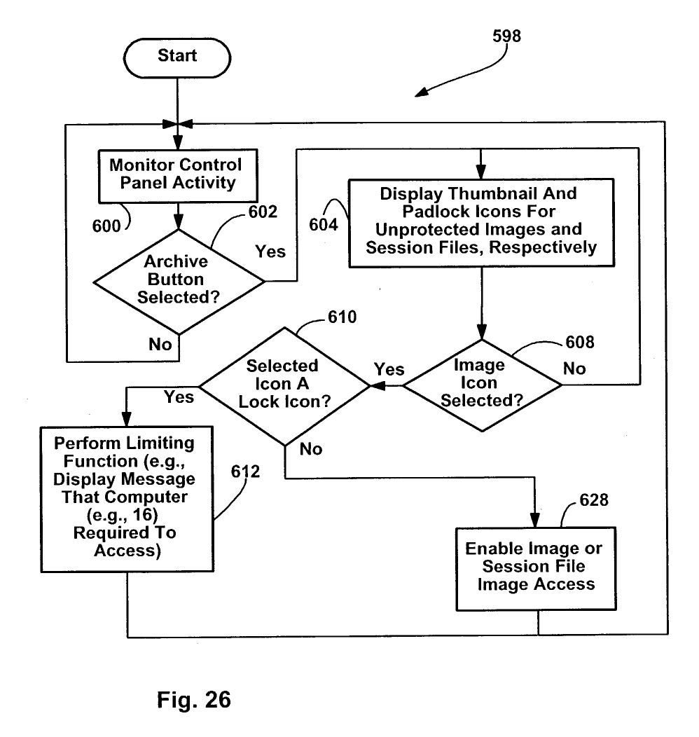

Referring now to FIG. 26, one method 598 for accessing unprotected archived images is illustrated which is consistent with the discussion above. Referring also to FIGS. 1, 9 and 15, at block 600, processor 240 monitors control panel activity. At decision block 602, processor 240 determines whether or not archive button 326 has been selected thereby indicating that at least one archived image is to be accessed and displayed. When button 326 is selected, archive LED 380 is illuminated. If archive button 326 has not been selected, control loops back up to block 600 where the loop including block 600 and 602 is repeated. If, at block 602, archive button 326 has been selected, control passes to block 604 where processor 240 displays a screen shot similar to the image illustrated in FIG. 30 including thumbnail icons and padlock icons.

Continuing, at block 608, processor 240 determines whether or not an image icon has been selected. When no image icon has been selected, control passes back up to block 604. Where an image has been selected, control passes to block 610 where processor 240 determine whether or not the selected icon is a locked icon. Where the selected icon is not a locked icon, control passes to block 628 where processor 240 enables access to the image associated with the selected thumbnail icon.

Referring again to block 610, if the selected icon is a locked icon control passes to block 612 where processor 240 performs some access limiting function. For example, processor 240 may provide a message via projector 14 indicating that a computer 16 is required for entering a password to access the protected session file.

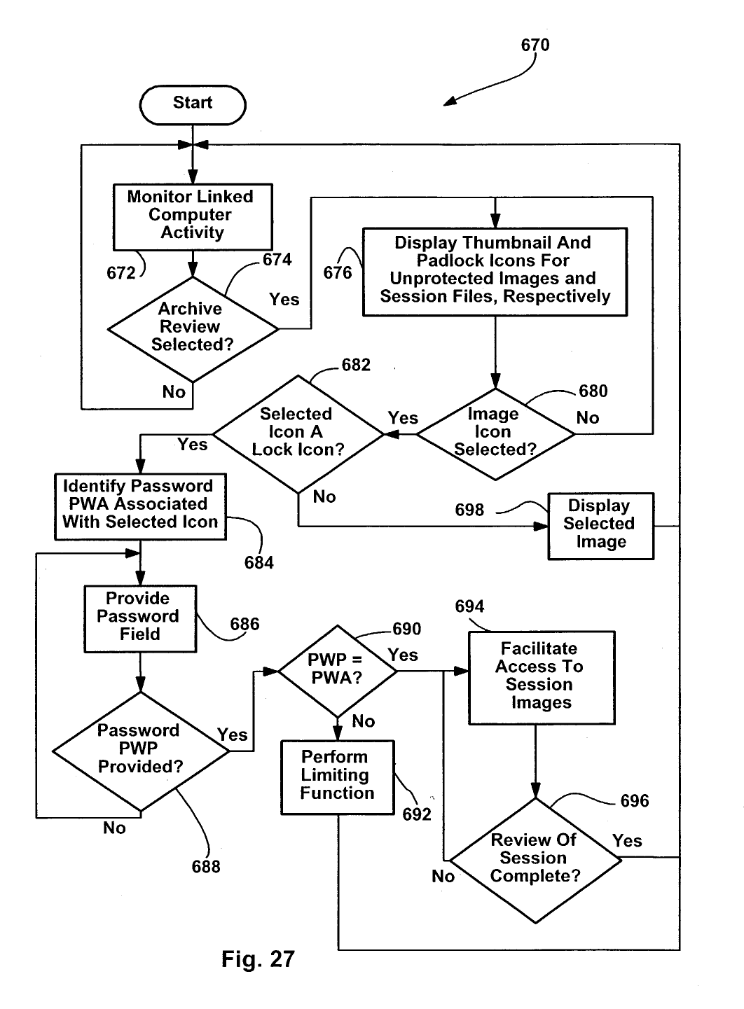

Referring now to FIG. 27, a method 670 for accessing either protected or unprotected archived images via a computer (e.g., laptop 16) or via processor 240 software is illustrated. Referring also to FIGS. 1, 9 and 15, at block 672, processor 240 monitors its network link for computer activity. At block 674, processor 240 determines whether or not an archive review function has been selected via a computer linked thereto or via archive button 374. At blocks 676 and 678, in a manner similar to the manner described above with respect to block 604, processor 240 provides thumbnail icons for each of the unprotected images and each of the protected session files.

Continuing, at block 680, processor 240 determines whether or not an image icon has been selected via the linked computer or via stylus selection on surface 20. Where no image icon has been selected, control passes back up to block 672 where the process is repeated. At decision block 680, where an image icon has been selected, control passes to block 682 where processor 240 determines whether or not the icon selected is an unprotected image icon or a protected session file icon. Where the selected icon corresponds to an unprotected image, control passes to block 698 where the image is displayed via the computer. As described, if the computer is linked to processor 240 to provide images thereto and if laptop button 328 (see again FIG. 15) is selected, the image displayed on the computer screen will also be projected onto surface 24 for observation. Where no computer is linked to processor 240, processor 240 may directly cause the projector to project the unprotected image.

Referring again to block 682, if the selected icon corresponds to a protected session file, control passes to block 684 and processor 240 identifies a password PWA associated with a selected icon. Continuing, at block 686, processor 240 causes the linked computer to provide a password field and, perhaps instructions for using the field to enter a password. In the alternative, where no computer is linked to processor 240, processor 240 may provide the password field directly on surface 20 via projector 14. At block 688, processor 240 monitors the password field for a provided password PWP. Where no password is protected, processor 240 moves back through blocks 686 and 688. Once a password PWP is provided, control passes to block 690 where processor 240 compares the provided password PWP to the associated password PWA. Where the provided password PWP is not identical to the associated PWA, control passes to block 692 where a limiting functions is performed. For example, a limiting function may include providing a message via the computer screen that the password was incorrectly entered. After block 692, control passes back up to block 672.

Referring again to block 690, where the provided password PWP is identical to the associated password PWA, control passes to block 694 where processor 240 facilitates access to the session images. For example, facilitating access may include providing another list of image icons, a separate image icon corresponding to each one of the images in the protected session file, and then allowing the system user to select one of those images for observation. As another instance, the first image in the protected session file may initially be displayed on the computer screen along with some form of interactive tools enabling the system user to scroll through the other images (e.g., a selectable next image icon). At block 696, processor 240 monitors computer activity to determine whether or not the system user wished to end the review session. Until an indication that this session should be ended is received, control loops back through block 694 and 696. Once the user ends the session review, control passes from block 696 back up to block 672 where the method described above is repeated.

While great effort has been made to configure a simplified whiteboard system 10 that includes an intuitive interface and that can be used in an intuitive fashion, it is contemplated that system users may nevertheless find operation of at least some of the features of system 10 to be confusing. To help users take full advantage of the features of system 10, in at least some embodiment of the invention, a help function associated with help or information button 312 (see again FIG. 15) is provided. To this end, generally, when help button 312 is selected followed by selection of any of the other buttons on panel 310, an audible help feature is activated whereby processor 240 controls speaker/microphone units 228 and 230 to announce instructions associated with the second selected button. For example, if a system user does not understand the function associated with web site/archive button 322 on panel 310, the user can select help button 312 followed by web site/archive button 322 to cause processor 240 to announce verbal instructions regarding the affect of selecting web site/archive button 322. For instances, when the sequence including help button 312 and button 322 is selected, the instructions announced may begin

“You can capture an image of the information displayed on the board surface and stored as a file on a built-in archive and web server for later access. To capture an image of the board and save it on the board's archive and web server, first, when you are ready to capture the image, press the web site/archive button. Continue your presentation. The web site/archive LED will flash green until he image file is saved. The captured image is added to the board's built-in archive and . . . ”.

Similarly, to obtain verbal instructions regarding any of the other buttons on panel 310, the help button 312 is selected followed by the button for which information is required.

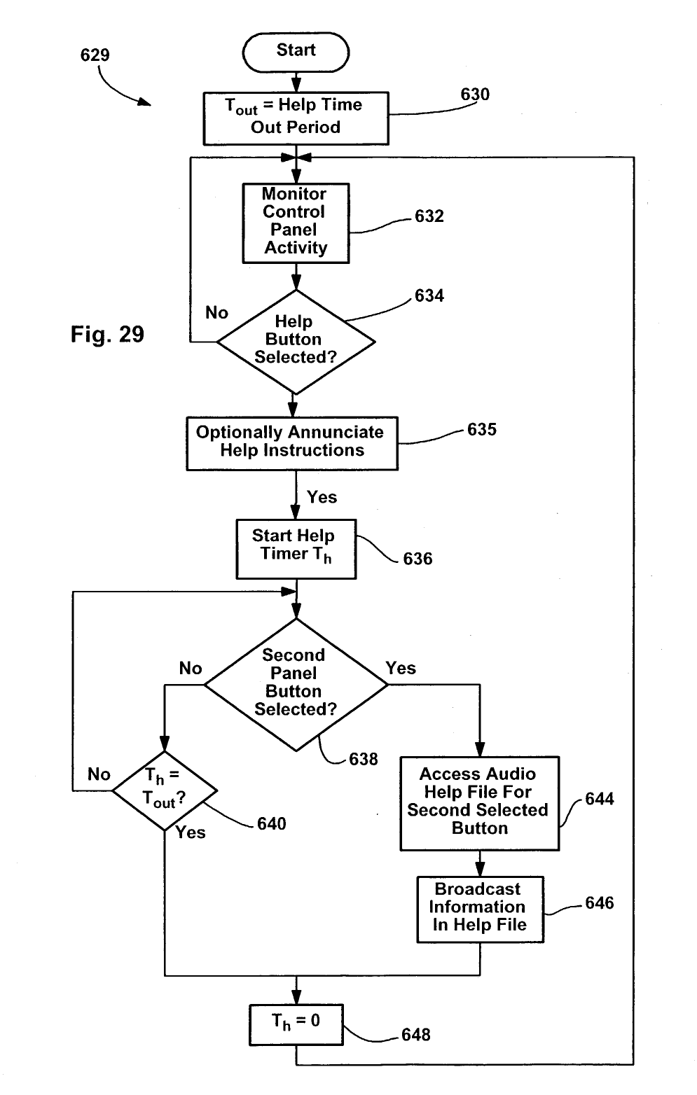

Referring now to FIG. 29, a method 630 for implementing the help function described above is illustrated. Referring also to FIGS. 3, 9 and 15, at block 632, a help time value Tₒᵤₜ is set by processor 240. For example, the help time period may be 10 seconds. In this case, after help button 312 is selected, one of the other panel buttons must be selected within 10 seconds or the help function is deactivated. At block 632, processor 240 monitors control panel 310 for activity. At block 634, processor 240 determines whether or not help button 312 has been selected. Where help button has not been selected, an optional message may be annunciated audibly giving verbal instructions to press another button for help. Thereafter, control passes back up to block 632. After the help button 312 is selected, control may pass to block 635 where audible help instructions may optionally be provided after which control passes to block 636 where processor 240 starts a help timer having an initial value Tₕ of 0. At block 638, processor 240 determines whether or not a second panel button has been selected. Where no second panel button has been selected, control passes to block 640 where the timer value Tₕ is compared to the time out period Tₒᵤₜ. If the timer value Tₕ is less than the time out period Tₒᵤₜ, control passes back up to block 638 and the loop is repeated. If timer value Tₕ is equal to the time out period Tₒᵤₜ, control passes to block 642 where timer value Tₕ is again set equal to zero. After block 642, control passes back up to block 632.

Referring once again to block 638, if a second panel button is selected, control passes to block 644 where processor 240 accesses an audio help file for the second selected button. At block 646, processor 240 broadcasts the information audibly that is in the help file. After block 646, control passes to block 642 where the timer value Tₕ is again set equal to zero. Once again after block 642, control passes back up to block 632 where the process is repeated.

While some embodiments may only include an audible help function, other embodiments may instead or in addition include some type of projected help function that is selectable in a fashion similar to that described above. For instance, in one case, when a user selects help button 312 followed by archive icon 322, processor 240 may cause instructions related thereto to be projected onto surface 20.

It should be understood that the methods and apparatuses described above are only exemplary and do not limit the scope of the invention, and that various modifications could be made by those skilled in the art that would fall under the scope of the invention. For example, while the system described above includes a front projecting projector 14, other systems are contemplated where the information “projected” onto surface 20 is provided in some other fashion such as with a rear projector or using other types of recently developed flat panel technology. In addition, at least some embodiments may include a feature for generating session file type image groupings that include unprotected images or a combination of protected and unprotected images. Here, as above, a button like password protect button 315 (see again FIG. 15) may be provided to indicate the beginning and end of the images to be included in the file. Moreover, in some embodiments it is contemplated that a user may be able to provide a password for association with a session file (e.g., via an on-surface key pad and associated field).

Furthermore, while many features are described above, at least one embodiment of the invention is meant to be used only with bar coded real ink pens and not with virtual ink pens so that the system projector does not project virtual ink markings onto surface 20. Here, it has been recognized that this restriction results in a relatively more intuitive system that most system users are far more comfortable using because the interacting paradigm employed is most similar to conventional writing and marking concepts.

Moreover, while the term “whiteboard” is used herein, it should be appreciated that the term should not be used in a limiting sense and that many of the concepts described herein can and are intended to be used with various types of display surfaces including but not limited to rear projecting units, front projecting units, flat panel display screens, etc. Thus, the term “projector” is also used broadly to include any type of display driver. The phrase “display surface” is used herein synonymously with the broadest concept of a whiteboard surface.

To apprise the public of the scope of this invention, the following claims are made:

What is claimed is:

1. A method for use with a display surface and an archive memory, the display surface having a surface for displaying images, the method for grouping presented images together for storage in the archive memory and comprising the steps of:
a) providing an interface for receiving commands from a display surface user;
b) monitoring for a begin subset command indicating that subsequently archived images are to be grouped together in an image subset;
c) after a begin subset command is received:
i) monitoring for each of an archive command indicating that a presented image is to be archived and an end subset command indicating that no additional images are to be added to the image subset;
ii) when an archive command is received, archiving the presented image as part of the image subset;
iii) when an end subset command is received, skipping to step (b); and
iv) repeating steps (i) through (iii).

2. The method of claim 1 wherein the step of monitoring for a begin subset command includes monitoring for each of a begin subset command and an archive command and, wherein, when an archive command is received prior to receiving a begin subset command, the method includes the step of archiving the presented image as an image separate form other images.

3. The method of claim 1 also for restricting access to image subsets and further comprising the steps of, when a begin subset command is received, assigning a subset password for the image subset subsequently archived and restricting access to the subset images to users that provide the subset password.

4. The method of claim 3 wherein the step of assigning a subset password includes automatically and randomly assigning a subset password.

5. The method of claim 4 further including the step of, after assigning a subset password, presenting the subset password via the interface until an end subset command is received.

6. The method of claim 5 wherein the step of presenting the subset password includes visually displaying the subset password.

7. The method of claim 5 wherein the step of presenting the subset password includes audibly providing the subset password.

8. The method of claim 3 wherein the step of monitoring for a begin subset command includes monitoring for each of a begin subset command and an archive command and, wherein, when an archive command is received prior to receiving a begin subset command, the method includes the step of archiving the presented image as a separate un-restricted image.

9. The method of claim 8 further including the steps of, after images are archived, providing a review interface for a user to access the archived images including separate selectable icons for each archived image, the selectable icons including an un-restricted icon for each un-restricted archived image and a restricted icon for each restricted image.

10. The method of claim 9 further including the steps of, when an unrestricted icon is selected, presenting the corresponding image and, when a restricted icon is selected that is associated with a specific image subset, monitoring for the password associated with the specific image subset and, when the associated password is received, presenting at least one of the images form the image subset.

11. The of method claim 10 further including the steps of, after presenting an image from the specific image subset, monitoring for a next selected icon and, if the next selected icon corresponds to an image in the specific subset, presenting the corresponding image.

12. The method of claim 3 further including the step of, after assigning a subset password, presenting the subset password via the interface until an end subset command is received.

13. The method of claim 3 wherein the step of monitoring for a begin subset command includes providing a protect button on the interface indicating a restricting function and, when the restricting function is turned off, determining when the protect button is selected.

14. The method of claim 13 wherein the step of monitoring for an end subset command includes, when the restricting function is turned on, determining when the protect button is selected.

15. The method of claim 14 wherein the step of monitoring for an archive indication includes providing an archive button on the interface indicating an archive function and determining when the archive button is activated.

16. The method of claim 3 wherein the step of assigning a subset password includes receiving the subset password via the interface from a system user.

17. A method for use with a display surface and an archive memory, the display surface having a surface for displaying images, the method for grouping at least some presented images together in subsets for storage in the archive memory and for restricting access to at least some of the image subsets, the method comprising the steps of:
a) providing an interface for receiving commands from a display surface user;
b) monitoring for a begin restrict command indicating that subsequently archived images are to be grouped together in an image subset and that access to the subset images is to be restricted;
c) after a begin restrict command is received:
i) assigning a subset password for the image subset to be subsequently archived;
ii) monitoring for each of an archive command indicating that a presented image is to be archived and an end restrict command indicating that no additional images are to be added to the image subset;
iii) when an archive command is received, archiving the presented image as part of the image subset;
iv) when an end restrict command is received, restricting access to the subset images to users that provide the subset password and skipping to step (b); and
v) repeating steps i through iv.

18. The method of claim 17 wherein the step of monitoring for a begin subset command includes monitoring for each of a begin subset command and an archive command and, wherein, when an archive command is received prior to receiving a begin subset command, the method including the step of archiving the presented image as a separate unrestricted image.

19. The method of claim 18 wherein the step of assigning a subset password includes automatically and randomly assigning a subset password.

20. The method of claim 19 further including the step of, after assigning a subset password, visually displaying the subset password via the interface until an end subset command is received.

21. The method of claim 17 wherein the step of archiving the presented image as part of the subset includes archiving the presented image as a separate image and restricting access to the separate image to users that provide the subset password.

22. The method of claim 17 wherein the step of monitoring for a begin subset command includes providing a protect button on the interface indicating a restricting function and, when the restricting function is turned off, determining when the protect button is activated and wherein the step of monitoring for an end subset command includes, when the restricting function is turned on, determining when the protect button is activated.

23. The method of claim 22 wherein the step of monitoring for an archive indication includes providing an archive button on the interface indicating an archive function and determining when the archive button is activated.

24. An apparatus for grouping images together for storage in an archive memory, the apparatus comprising:
a display surface having a surface for presenting images;
a memory device;
an interface;
a processor linked to the interface and the memory device, the processor performing the steps of:
a) monitoring the interface for a begin subset command indicating that subsequently archived images are to be grouped together in an image subset;
b) after a begin subset command is received:
i) monitoring the interface for each of an archive command indicating that a presented image is to be archived and an end subset command indicating that no additional images are to be added to the image subset;
ii) when an archive command is received, archiving the presented image as part of the image subset;
iii) when an end subset command is received, skipping to step (a); and
iv) repeating steps i through iii.

25. The apparatus of claim 24 wherein the processor monitors for a begin subset command by monitoring the interface for each of a begin subset command and an archive command and, wherein, when an archive command is received prior to receiving a begin subset command, the processor archiving the presented image as a separate image.

26. The apparatus of claim 24 also for restricting access to image subsets, the processor further performing the steps of, when a begin subset command is received, assigning a subset password for the image subset subsequently archived and restricting access to the subset images to users that provide the subset password.

27. The apparatus of claim 26 wherein the processor automatically and randomly assigns the subset password.

28. The apparatus of claim 27 wherein the interface includes a visual display and wherein, after assigning a subset password, the processor presents the subset password via the display until a subsequent end subset command is received.

29. The apparatus of claim 26 wherein the processor archives the presented image as part of the subset by archiving the presented image as a separate image and restricting access to the separate image to users that provide the subset password.

30. The apparatus of claim 29 wherein while monitoring for a begin subset command, the processor also monitors for an archive command and, wherein, when an archive command is received prior to receiving a begin subset command, the processor archives the presented image as a separate un-restricted image.

31. The apparatus of claim 26 wherein the interface includes a protect button and the processor monitors for a begin subset command by, when the restricting function is turned off, determining when the protect button is activated.

32. The apparatus of claim 31 wherein processor monitors for an end subset command by, when the restricting function is turned on, determining when the protect button is activated.

33. The apparatus of claim 24 wherein the interface includes an archive button and the processor monitors for an archive command by determining when the archive button is activated.

34. An apparatus for grouping at least some presented images together in subsets for storage in an archive memory and for restricting access to at least some of the image subsets, the apparatus comprising:
a display surface having a surface for presenting images;
a memory device;
an interface;
a processor linked to the interface and the memory device, the processor performing the steps of:
a) monitoring for a begin restrict command indicating that subsequently archived images are to be grouped together in an image subset and that access to the subset images is to be restricted;
b) after a begin restrict command is received:
i) assigning a subset password for the image subset to be subsequently archived;
ii) monitoring for each of an archive command indicating that a presented image is to be archived and an end restrict command indicating that no additional images are to be added to the image subset;
iii) when an archive command is received, archiving the presented image as part of the image subset in the memory device;
iv) when an end restrict command is received, restricting access to the subset images to users that provide the subset password and skipping to step (a); and
v) repeating steps i through iv.

35. The apparatus of claim 34 wherein the processor simultaneously monitors for a begin subset command and an archive command and, wherein, when an archive command is received prior to receiving a begin subset command, the processor archives the presented image as a separate un-restricted image.

36. The apparatus of claim 35 wherein the interface includes a visual display, processor automatically and randomly assigns a subset password when a begin subset command is received and wherein, after assigning a subset password, the processor displays the password via the display until an end subset command is received.

37. The apparatus of claim 34 wherein the processor archives the presented image as part of the subset by archiving the presented image as a separate image and restricting access to the separate image to users that provide the subset password.

38. A method for use with a display surface and at least one instrument for interacting with the display surface, the at least one instrument useable to at least one of identify a location on the surface and alter an image on the surface via contact therewith, the method for determining when and where the instrument contacts the display surface, the method comprising the steps of:
using a first sensor to determine the location of the instrument within a sensing plane proximate and spaced apart from the surface;
using a second sensor to determine when the instrument contacts the surface; and
when an instrument is located within the sensing plane and contacts the surface, identifying that the instrument contacts the surface and the location of the instrument relative to the surface.

39. The method of claim 38 wherein, when the instrument location proximate the surface is altered while the instrument is in contact with the surface, the interaction causes an acoustic signal and, wherein, the step of using a second sensor includes providing an acoustic sensor and using the acoustic sensor to detect the acoustic signal.

40. The method of claim 39 wherein the step of using a first sensor to determine the location of the instrument within a sensing plane includes providing an optical laser assembly that senses instrument location within the sensing plane.

41. The method of claim 40 wherein the instrument includes at least one coded tag positioned such that, when the instrument contacts the surface, at least a section of the tag is located within the sensing plane and, wherein, the step of sensing the location of the instrument within the sensing plane includes the step of determining the location of the tag within the plane.

42. The method of claim 39 wherein the display surface is a writing surface and the display surface further includes a rear surface opposite the writing surface and, wherein, the step of providing an acoustic sensor includes mounting the acoustic sensor to the rear surface.

43. The method of claim 39 wherein the sensors are linked to a processor that deactivates several processor functions and enters a power saving mode when unused for a period, the method also for activating the processor when sound occurs near the board and further including the steps of, using the acoustic sensors to sense sound near the board and activating the processor.

44. The method of claim 38 wherein the step of using a second sensor includes using a touch-sensitive sensor to determine when the instrument contacts the surface.

45. The method of claim 38 also for use with a memory device linked to the display surface for storing display surface images wherein the instrument is for altering an image on the surface and, wherein, the method further includes the step of, after identifying that the instrument contacts the surface and the location of the instrument relative to the surface, altering the image information in the memory device as a function of the sensed location of the instrument during contact with the surface.

46. The method of claim 45 wherein the instrument is a pen and wherein the step of altering the image information includes storing information corresponding to a mark at the instrument location during contact.

47. The method of claim 39 further including the step of using the acoustic sensor to confirm instrument location.

48. An apparatus for creating and storing images, the apparatus for use with at least one instrument, the apparatus comprising:
a display surface;
a first sensor for determining the location of the instrument within a sensing plane proximate and spaced apart from the surface;
a second sensor for determining when the instrument contacts the surface; and
a processor linked to each of the first and second sensors and running a program to, when an instrument is located within the sensing plane and contacts the surface, identify that the instrument contacts the surface and the location of the instrument relative to the surface.

49. A method for use with an electronic display surface and an instrument for interacting with the display surface, the display surface having a display area, the method for moving a cursor icon about at least a portion of the display area and comprising the steps of:
identifying first and second areas within the display area having first and second area surfaces, respectively;
sensing the instrument location on the first area surface; and
projecting a cursor icon on the second area surface as a function of the instrument location on the first area surface.

50. The method of claim 49 wherein the first and second areas are distinct.

51. The method of claim 50 wherein the step of identifying the second area includes the step of providing a border to distinguish the second area from other areas on the display surface.

52. The method of claim 49 wherein the step of identifying the first and second areas includes identifying a first area that is smaller than the second area.

53. The method of claim 52 wherein the step of identifying the first and second areas further includes identifying an area along an edge of the display area as the first area.

54. The method of claim 49 wherein the shape of the first area is similar to the shape of the second area and the first area is smaller than the second area.

55. The method of claim 54 wherein the step of projecting a cursor icon on the second area surface as a function of the instrument location on the first area surface includes projecting the cursor icon at a location such that the position of the cursor icon relative to the second area is identical to the position of the instrument relative to the first area.

56. The method of claim 55 wherein, when the instrument contacts the first area surface and is moved on the first area surface, the cursor icon is moved on the second area surface.

57. The method of claim 49 wherein, when the instrument contacts the first area surface and is moved on the first area surface along a first direction, the cursor icon is moved on the second area surface along a second direction where the second direction is identical to the first direction.

58. The method of claim 49 wherein the first area surface includes a plurality of first area surfaces useable to control activity on the second area surface.

59. The method of claim 49 wherein the first area surface is a section of the second area surface.

60. The method of claim 49 wherein the step of identifying first and second areas includes projecting a border indicating the second area onto the display surface.

61. The method of claim 60 further including identifying a buffer area that includes the second area and a border around the second area and, wherein, the method further includes the step of sensing instrument location within the buffer area and the second area and projecting the cursor onto the surface at the absolute position of the instrument location when the instrument contacts the surface in one of the buffer area and the second area.

62. The method of claim 61 wherein the step of projecting a cursor icon on the second area surface as a function of the instrument location on the first area surface includes projecting the cursor icon at a location such that the position of the cursor icon relative to the second area is identical to the position of the instrument relative to the first area.

63. The method of claim 49 wherein the first area includes every part of the display surface except the second area.

64. The method of claim 63 wherein the step of projecting a cursor icon in the second area as a function of the instrument location on the first area includes identifying movement of the instrument on the first area and causing relative movement of the cursor on the second area.

65. The method of claim 64 also including the steps of sensing instrument location on the second area surface and projecting a cursor icon on the second area surface as a function of the location of the instrument on the second area surface.

66. The method of claim 65 wherein the step of projecting a cursor icon on the second area surface as a function of the location of the instrument on the second area surface includes projecting the cursor at the absolute position of the instrument on the second area surface.

67. A method for use with an electronic display surface and an instrument for interacting with the display surface, the display surface having a display area, the method for moving a cursor icon about at least a portion of the display area and comprising the steps of:
identifying first and second areas within the display area having first and second area surfaces, respectively;
when the instrument is placed in contact with a location on the first area surface:
a) sensing the instrument location on the first area surface;
b) projecting a cursor icon on the second area surface as a function of the instrument location on the first area surface; and
when the instrument is placed in contact with a location on the second area surface:
a) sensing the instrument location on the second area surface; and
b) projecting a cursor icon on the second area surface at the location of the instrument on the second area surface.

68. A method for providing information regarding a feature on an electronic display surface, the display surface including several function buttons, the method comprising the steps of:
a) providing an information button;
b) monitoring the information button for activation;
c) after the information button has been activated, monitoring the feature buttons for activation; and
d) when one of the feature buttons is activated after the information button is activated, providing information regarding the feature corresponding to the activated feature button.

69. The method of claim 68 also including the steps of, when the information button is activated, starting a timer, comparing the timer value to a time out period, if the timer value exceeds the timeout period prior to activation of a feature button, skipping to step (b).

70. The method of claim 69 wherein the information button may be controlled to alter appearance and, wherein, the method further includes the step of altering the appearance of the information button when the timer is started.

71. The method of claim 68 wherein the step of providing information includes the step of audibly providing information.

72. The method of claim 68 wherein the step of providing information includes the step of visually providing information.

73. An apparatus for use with an electronic whiteboard, the whiteboard including a display surface and a sensor assembly for sensing the location of, and type of, tag within a sensing plane proximate the display surface, the apparatus including:
an instrument having first and second ends, a first tag disposed at the first end such that, when the first end contacts the display surface, at least a portion of the first tag is within the sensing plane; and
a cap member having first and second cap ends and forming an external surface there between, the second cap end forming an opening for receiving the first instrument end such that the cap covers the instrument tag when the first instrument end is received within the opening, a first cap tag disposed at the first end of the cap member such that, when the first end of the cap member contacts the display surface, the first cap tag is within the sensing plane.

74. The apparatus of claim 73 wherein the first instrument tag and the first cap tag indicate different instruments and wherein each of the tags indicates one of a stylus, an eraser, and a pen.

75. The apparatus of claim 74 wherein the opening formed at the second end of the cap member is such that when the first instrument end is received therein the cap completely covers the instrument tag.

76. An apparatus for use with an electronic display surface, the apparatus for identifying a visual effect to be generated via an instrument on the display surface, the apparatus comprising:
a sensor assembly for sensing the location of and type of tag within a sensing plane proximate the display surface;
an instrument comprising:
a handle member having first and second handle ends, at least first and second optically readable handle tags disposed at the first handle end; and
a cap member having first and second cap ends, an external surface between the first and second cap ends and forming an opening at the second cap end for receiving the first handle end, the cap member also forming a window proximate the first end of the cap member between the external surface and a channel formed by the opening, the window formed relative to the first end of the cap member such that at least a portion of the window is within the sensing plane when the first end of the cap member contacts the surface, when the first handle end is received in the opening, the handle tags are within the opening and each is separately alignable with the window such that the tag is sensible through the opening, the cap member rotatable about the first handle end to separately expose each of the first and second handle tags within the sensing plane, each of the handle tags indicating different instrument characteristics.

77. The apparatus of claim 76 further including a third handle tag disposed at the first end of the handle member, the cap member rotatable about the first end of the handle member to separately expose the third handle tag through the window, the third tag indicating instrument characteristics different than the instrument characteristics indicated by the first and second tags.

78. The apparatus of claim 76 further including a cap tag disposed on the external surface and at the first end of the cap member such that the cap tag is within the sensing plane when the first end of the cap member contacts the display surface and, wherein, the cap tag indicates additional information about instrument type, the sensor assembly sensing the cap tag and at least one of the handle tags when the first end of the instrument is received in the cap opening and the first end of the cap member contacts the display surface.

79. The apparatus of claim 78 wherein the cap tag indicates instrument type and the handle tags indicate additional characteristics of the instrument type.

80. The apparatus of claim 79 wherein the cap tag indicates one of a stylus, a pen and an eraser and, wherein, when the cap tag indicates a pen, the handle tags indicates at least one of pen width and pen color and, when the cap tag indicates an eraser, the handle tags indicate at least one of different eraser widths and colors.

81. The apparatus of claim 76 wherein the tag window is an opening.

82. The apparatus of claim 76 wherein one of an external surface of the handle and the cap member external surface includes characteristic markings indicating instrument characteristics associated with the handle tags and the other of the handle member external surface and the cap member external surface includes an alignment mark and, wherein, the characteristic marking and alignment mark are juxtaposed such that, when the first end of the handle member is received in the cap member opening and the first handle tag is aligned with the tag window, the alignment mark is aligned with the characteristic marking indicating characteristics associated with the first handle tag and, when the first end of the handle member is received in the cap member opening and the second handle tag is aligned with the tag window, the alignment mark is aligned with the characteristic marking indicating characteristics associated with the second handle tag.

83. An assembly for use with a display surface, the assembly comprising:
a sensor assembly for sensing an instrument interacting with the display surface;
a memory device;
a processor linked to the sensor assembly and the memory device, the processor receiving information from the sensor assembly regarding instrument activity with respect to the display surface and generating image data as a function thereof, the processor storing the image data as an image in the memory device as the image is created on the display surface; and
a clear button linked to the processor, the clear button for clearing the image data stored in the memory device.

84. The apparatus of claim 83 wherein the sensor is for determining the location of, and type of, tag within a sensing plane proximate the display surface and wherein each instrument includes a tag disposed proximate a portion of the instrument used to interact with the display surface and that resides within the sensing plane when the instrument contacts the display surface.

85. The apparatus of claim 84 further including a pen instrument including an ink dispenser at a first end and a pen tag disposed proximate the first end.

86. The apparatus of claim 83 further including a memory indicator, the memory indicator indicating when any image data is stored in the memory device.

87. The apparatus of claim 86 wherein the memory indicator is a light that is illuminated when any image data is stored in the memory device.

88. The apparatus of claim 83 further including a warning indicator and, wherein, the sensor assembly is also capable of sensing any object present within the sensing plane, when an un-tagged object is sensed within the sensing plane, the processor activating the warning indicator.

89. The apparatus of claim 88 wherein the warning indicator remains activated until affirmatively deactivated by an assembly user.

90. The apparatus of claim 85 also including an eraser instrument including an ink erasing surface and an eraser tag disposed proximate the eraser surface such that the eraser tag resides in the sensing plane when the eraser surface contacts the display surface.

91. An assembly for use with a display surface, the assembly comprising:
a sensor assembly for sensing an instrument interacting with the display surface;
a memory device;
a warning indicator; and
a processor linked to the sensor assembly and the memory device, the processor receiving information from the sensor assembly regarding objects present within the sensing plane, the processor generating image data as a function of instrument activity on the display surface, the processor storing the image data as an image in the memory device as information is altered on the display surface, when an un-tagged object is sensed within the sensing plane, the processor activating the warning indicator.

92. The apparatus of claim 91 wherein the sensor is for determining the location of, and type of, tag within a sensing plane proximate the display surface and wherein each instrument includes a tag disposed proximate a portion of the instrument used to interact with the display surface and that resides within the sensing plane when the instrument contacts the display surface.

93. The apparatus of claim 92 further including a pen instrument including an ink dispenser at a first end and a pen tag disposed proximate the first end.

94. The apparatus of claim 91 wherein the warning indicator is a light and is illuminated by the processor when an un-tagged object is sensed within the sensing plane.

95. The apparatus of claim 91 wherein the warning indicator remains activated until affirmatively deactivated by an assembly user.

96. A method for use with a display surface and a laser unit, the display surface having a display edge, the laser unit generating a laser beam that emanates from an emanating point within a sensing plane and sensing objects within the sensing plane, the method for aligning the laser unit so that the sensing plane is parallel to the display surface, the method comprising the steps of:
mounting the laser unit proximate the display surface such that the emanating point is spaced from the display surface a known distance and so that a beam generated by the laser unit is directed generally parallel to the display surface;
causing the laser unit to generate a visible light beam;
providing a measuring surface at different locations along the display surface where the measuring surface is subtended by the beam;
rotating the beam through an arc about the source point and within the sensing plane such that the beam forms a light line on the measuring surface;
measuring the distance between the light line and the display surface along the measuring surface; and
where the measured distance and the known distance are different, adjusting the laser unit to minimize the difference.

97. The method of claim 96 wherein the step of providing a measuring surface includes providing an edge member along at least a portion of the display edge that forms an edge surface that extends from the display surface, the step of mounting the laser unit including mounting the unit proximate a display edge generally opposite the edge surface and the step of measuring including measuring the distance at different locations along the length of the edge surface.

98. The method of claim 97 wherein the step of mounting includes mounting the sensor proximate a first corner of the display surface.

99. The method of claim 98 for use with two laser position sensors wherein the process is repeated for each of the two sensors.

100. The method of claim 99 wherein the step of mounting the second laser position sensor includes mounting the second sensor proximate a second corner of the display surface.

101. An apparatus for use with a display surface having a circumferential edge, the apparatus for determining the locations of instruments within a sensing plane proximate the display surface and also for determining if the display surface is flat, the apparatus comprising:
a first laser source positioned proximate a first edge of the display surface, the first source generating a first laser beam, directing the first beam across the display surface and rotating the first beam such that the first beam periodically traverses across at least a portion of the display surface, the first source capable of operating in first or second states, in the first state the first source generating an invisible laser beam and in the second state, the first source generating a visible laser beam;
at least a first sensor mounted to an edge of the display surface for sensing the invisible laser beam from the first source that reflect from objects within the sensing plane; and
a selector for selecting one of the first and second states of source operation.

102. The apparatus of claim 101 further including a second laser source positioned proximate a second edge of the display surface, the second edge opposite the first edge, the second source generating a second laser beam, directing the second beam across the display surface and rotating the second beam such that the second beam periodically traverses across at least a portion of the display surface, the second source capable of operating in first or second states, in the first state the second source generating an invisible laser beam and in the second state, the second source generating a visible laser beam.

103. The apparatus of claim 102 wherein the first and second sources are located at first and second corners of the display surface and are controlled to rotate their respective beams through arcs across substantially the entire display surface area.

104. The apparatus of claim 102 wherein the first sensor is mounted to the first source and the apparatus includes a second sensor mounted to the second source.

105. An apparatus for providing a flat surface adjacent an uneven surface, the apparatus comprising:
a rectilinear board having upper, lower and first and second lateral edges and forming a flat surface there between;
first and second bracket assemblies, the second bracket assembly rigidly coupled to at least one of the board edges and mountable to the uneven surface to rigidly secure the board to the uneven surface such that a first location on one of the board edges is a first distance from the uneven surface, the first bracket assembly including a base member and an adjustment member, the base member forming a mounting surface for mounting to the uneven surface, the adjustment member including an edge engaging member, the adjustment member slidably coupled to the base member for movement generally perpendicular to the mounting surface so that an extend dimension between the mounting surface and the engaging member is adjustable, the first bracket engaging member coupled to the board edge at the first location;
wherein, the first bracket base member and adjustment member are adjustable so that the mounting surface and the engaging member form an extended dimension that is identical to the first distance and the mounting surface contacts the uneven surface.

106. The apparatus of claim 105 wherein, when the second bracket assembly is rigidly coupled to at least one of the board edges and is mounted to the uneven surface to rigidly secure the board to the uneven surface, a second location on one of the board edges is a second distance from the uneven surface, the apparatus further including at least a third bracket assembly including a base member and an adjustment member, the third bracket assembly base member forming a mounting surface for mounting to the uneven surface, the third bracket assembly adjustment member including an edge engaging member, the third bracket assembly adjustment member slidably coupled to the third bracket assembly base member for movement generally perpendicular to the mounting surface so that an extend dimension between the mounting surface and the engaging member is adjustable, the third bracket engaging member coupled to the board edge at the second location wherein, the third bracket base member and adjustment member are adjustable so that the mounting surface and the engaging member form an extended dimension that is identical to the second distance and the mounting surface contacts the uneven surface.

107. The method of claim 106 wherein the first bracket assembly is secured to an upper edge of the board at a central location along the edge, the first and second locations are on opposite sides of the central location along the upper edge and the first, central and second locations are generally equi-spaced along the upper edge of the board.

108. The apparatus of claim 107 wherein the first, second and third bracket assemblies are upper bracket assemblies and the apparatus further includes at least a first lower bracket assembly secured to a bottom edge of the board and mountable to the uneven surface.

109. The apparatus of claim 108 wherein the first lower bracket assembly also includes a base member forming a mounting surface for contacting the uneven surface and an adjustment member including an edge engaging member for linking to a board edge and, wherein, the first lower bracket assembly is adjustable to alter the distance between the mounting surface and edge engaging member thereof.

110. The apparatus of claim 109 further including second and third lower bracket assemblies that each include a base member forming a mounting surface for contacting the uneven surface and an adjustment member including an edge engaging member for linking to a board edge and, wherein, the second lower bracket assembly is linked at a central location along the lower edge of the board and the first and third lower brackets are linked on opposite sides of the second lower bracket along the lower edge of the board and, wherein, each of the lower brackets is adjusted so that the associated mounting surface contacts an adjacent section of the uneven surface.

111. A method for use with a rectilinear board and an uneven surface, the board having upper, lower and first and second lateral edges and forming a flat surface therebetween, the method for mounting the board to the uneven surface so that the flat surface remains substantially flat, the method comprising the steps of:
providing at least first and second bracket assemblies, the first assembly including a base member forming a mounting surface and an adjustment member forming an edge engaging member;
attaching the first bracket assembly via the edge engaging member at a first location along the board edge;
securing the board via the second bracket assembly to the uneven surface so that a first location along the board edge is a first distance from the uneven surface;
adjusting the first bracket assembly so that the mounting surface contacts an adjacent section of the uneven surface; and
securing the mounting surface to the uneven surface.

112. An electronic board assembly for archiving images, the board assembly comprising:
a display surface;
a web server dedicated to the board system, the server including an archive memory device for storing board images accessible via the server; and
an interface device linkable to the web server to access images stored therein.

113. The assembly of claim 112 wherein the interface also provides a store component useable to indicate that information on the display surface should be stored by the web server in the archive memory device.

114. The apparatus of claim 113 wherein the interface also provides an archive source component useable to indicate intent to access an archived image.

115. The assembly of claim 114 wherein the interface further includes a projector for projecting archived images onto the display surface and, wherein, the processor provides video output of an accessed image to the projector.

116. The assembly of claim 112 wherein the interface device is a computer linkable to the server via a network.

117. An electronic board assembly comprising:
a display surface;
a system processor including an archive memory device for storing board images and an external computer linkage for linking to a computer;
a projector linked to the processor and positioned to project images onto the display surface; and
an interface linked to the processor for identifying the source of images to project onto the display surface, the interface including an archive source component for indicating that an archived image is to be projected and a computer source component for indicating that an image generated by a computer linked to the linkage is to be projected;
wherein, when the archive source component is selected, the processor projects an archived image onto the display surface and when the computer source component is selected, the processor projects an image generated by a computer linked to the linkage on the display surface.

118. A method for capturing both projected and applied information displayed on a board surface, the method comprising the steps of:
dividing the surface into first and second areas wherein the second area is smaller than the first area;
projecting an image onto the second area;
sensing information applied via an instrument to either of the first and second areas; and
when a save command is received, storing the projected and applied information in an archive memory device.

119. The method of claim 118 wherein the step of storing includes storing the projected and applied information as a single merged image for subsequent access.

120. The method of claim 118 wherein the step of storing includes storing the projected and applied information as separate correlated images for subsequent access.

121. The method of claim 118 wherein the processor includes an interface that enables a system user to select one of a merged and a separate mode of operation and, wherein, the step of storing the projected and applied information includes identifying which of the merged and separate modes is selected and, where the merged mode is selected, storing the projected and applied information as a single merged image and, where the separate mode is selected, storing the projected and applied information as separate and correlated images.

122. A method for calibrating an electronic display board system wherein the system includes a processor, a display surface and a display driver linked to the processor and that provides images onto a portion of the display surface, the method comprising the steps of:
providing marks onto the display surface that indicate an image location;
sensing mark locations on the surface;
identifying the area associated with the marks as a second area and other area on the surface as a first area; and
causing the driver to provide a cursor within the second area as a function of instrument activity that occurs in the first area.

123. The method of claim 122 wherein the step of causing includes moving the cursor within the second area in a relative fashion with respect to movement of the cursor within the first area.

124. The method of claim 123 further including the step of causing the driver to provide a cursor within the second area as a function of instrument activity within the first area.

125. The method of claim 124 wherein the step of causing the driver to provide a cursor within the second area as a function of instrument activity within the second area includes providing a cursor at the absolute position of the instrument activity in the second area.
